(19) United States
(12) Patent Application Publication
(10) Pub. No.: US 2016/0075060 A1
(43) Pub. Date: Mar. 17, 2016

(54) INJECTION MOLDING OF ARTICLES WITH INCORPORATED INSERTS

(71) Applicant: HUSKY INJECTION MOLDING SYSTEM LTD., Bolton (CA)

(72) Inventor: CHRISTOPHE HALTER, Selange (BE)

(21) Appl. No.: 14/888,878

(22) PCT Filed: May 2, 2014
(86) PCT No.: PCT/CA2014/050422

§ 371 Date: Nov. 3, 2015

Related U.S. Application Data
(60) Provisional application No. 61/830,336, filed on Jun. 3, 2013.

(51) Int. Cl. B29C 45/14

(52) U.S. Cl. CPC B29C 45/14016; B29C 45/14008; B29C 45/1418; B29C 45/14262; B29K 2023/12

(57) ABSTRACT

Disclosed herein, amongst other things, is In accordance with an aspect disclosed herein, there is provided a method (1200) of molding a molded article (190, 290, 390, 490, 590) in a mold (120, 220, 320, 420, 520). The method broadly includes disposing (1202) an insert (140, 240, 340, 440, 540) between a first mold stack portion (124, 224, 324, 424, 524) and a second mold stack portion (128, 228, 328, 428, 528), the first and second mold stack portions being in a spaced relation (S, S1, S2, S3, S4). Next, the method includes positioning (1204) a shuttle (132, 232, 332, 432, 532) to align a shuttle aperture (170, 270, 371, 471, 571) defined in the shuttle with the first and second mold stack portions. Next, the method includes advancing (1206) at least one of the first and second mold stack portions towards the other of the first and second mold stack portions into a molding configuration to define a molding cavity (144, 244, 344, 444, 594) therebetween with the insert at least partially enclosed within the molding cavity, the first and second mold stack portions, when in the molding configuration, being substantially accommodated within the shuttle aperture. Next, the method includes injecting (1208) molding material (155, 255, 355, 455, 555) into the molding cavity through the first or second mold stack portion to mold the molded article incorporating the insert. Next, the method includes separating (1210) the first and second mold stack portions into the spaced relation to open the molding cavity. Next,

### TECHNICAL FIELD

Non-Limiting embodiments disclosed herein generally relate to injection molding, and in particular to the injection molding of articles with incorporated inserts.

### BACKGROUND

It may be desired for a molded article, such as a plastic closure for a beverage container for example, to incorporate an insert. An insert is an item that is placed within a molding cavity of an injection mold before the article is injection molded, such that the item becomes incorporated with the article upon injection of the molding material. The insert becomes incorporated with the article by becoming integrally formed with the article. For example, the insert may be embedded within the article or may become integrally formed with a surface of the article.

Incorporation of various types of inserts may be desired. One type of insert may be a label. For example, it may be desired for the label to become integrally formed with an exterior surface of the article so as to be readily visible to a consumer. Another type of insert may a barrier material, such as a foil or film, that is either impermeable to oxygen or contains a reagent for scavenging oxygen for example. It may be desired for a such barrier material to become integrally formed with an article, such as a closure for a container for instance, e.g. to reduce likelihood of oxidation of container contents, such as a beverage, or to limit the escape of a gas, such as carbon dioxide for example (as may be used in carbonated beverages), from a closed container. Incorporation of other types of inserts may be desired for other reasons. For example, incorporation of a circuit such as a radio-frequency identification (RFID) circuit for facilitating inventory taking or the tracking of a product may be of interest.

### SUMMARY

In accordance with an aspect disclosed herein, there is provided a method of molding a molded article in a mold. The method broadly includes disposing an insert between a first mold stack portion and a second mold stack portion, the first and second mold stack portions being in a spaced relation. Next, the method includes positioning a shuttle to align a shuttle aperture defined in the shuttle with the first and second mold stack portions. Next, the method includes advancing at least one of the first and second mold stack portions towards the other of the first and second mold stack portions into a molding configuration to define a molding cavity therebetween with the insert at least partially enclosed within the molding cavity, the first and second mold stack portions, when in the molding configuration, being substantially accommodated within the shuttle aperture. Next, the method includes injecting molding material into the molding cavity through the first or second mold stack portion to mold the molded article incorporating the insert. Next, the method includes separating the first and second mold stack portions into the spaced relation to open the molding cavity. Next, the method includes ejecting, within the shuttle aperture, from the first or second mold stack portion, the molded article incorporating the insert. The method concludes, or repeats, with moving the shuttle to align the shuttle aperture with a transfer structure for transfer of the molded article incorporating the insert.

In accordance with another aspect disclosed herein, there is provided an injection mold. The mold includes a first mold stack portion and a second mold stack portion, at least one of the first and second mold stack portions being movable relative to the other along a mold-stroke axis, between a spaced configuration in which the first and second mold stack portions are in a spaced relation and a molding configuration in which the first and second mold stack portions define a molding cavity therebetween. The mold further includes a mechanism for disposing an insert between the first and second mold stack portions when in the spaced configuration, so that the insert will become at least partially enclosed within the molding cavity when the first and second mold stack portions attain the molding configuration. The mold may also include a shuttle movable along a shuttling axis that is generally perpendicular to the mold-stroke axis, the shuttle comprising a shuttle aperture that alternately substantially accommodates the first and second mold stack portions, in the molding configuration, with the insert enclosed within the molding cavity, and the molded article incorporating the insert, upon withdrawal of the first and second mold stack portions from the shuttle aperture.

In accordance with yet another aspect disclosed herein, there is provided a non-transitory machine-readable medium storing instructions that, upon execution by a controller, cause the controller to operate an injection molding system in accordance with a method to mold an article incorporating an insert. The method commences with disposing the insert between a first mold stack portion of the injection molding system and a second mold stack portion of the injection molding system, the first and second mold stack portions being in a spaced relation. Next, the method includes positioning a shuttle of the injection molding system to align a shuttle aperture defined in the shuttle with the first and second mold stack portions. Next, the method includes advancing at least one of the first and second mold stack portions towards the other of the first and second mold stack portions into a molding configuration to define a molding cavity therebetween with the insert at least partially enclosed within the molding cavity, the first and second mold stack portions, when in the molding configuration, being substantially accommodated within the shuttle aperture. Next, the method includes injecting molding material into the molding cavity through the first or second mold stack portion to mold the molded article incorporating the insert. Next, the method includes separating the first and second mold stack portions into the spaced relation to open the molding cavity. Next, the method includes ejecting, within the shuttle aperture, from the first or second mold stack portion, the molded article incorporating the insert. The method then ends, or repeats, with moving the shuttle to align the shuttle aperture with a transfer structure for transfer of the molded article incorporating the insert.

These and other aspects and features of non-limiting embodiments will now become apparent to those skilled in the art upon review of the following description of specific non-limiting embodiments in conjunction with the accompanying drawings.

### DESCRIPTION OF THE DRAWINGS

The non-limiting embodiments will be more fully appreciated by reference to the accompanying drawings, in which:

FIGS. 1-11 are schematic representations of an example embodiment of an injection molding system during various stages of operation of a molding cycle;

FIG. 12 is a flowchart illustrating operation of the injection molding systems illustrated in FIGS. 1-11 as well as in FIGS. 13-26, 27-38, 39-52 and 53-67;

FIGS. 13-26 are schematic representations of an alternative embodiment of an injection molding system during various stages of operation of a molding cycle; and

FIGS. 27-38 are schematic representations of a further alternative embodiment of an injection molding system during various stages of operation of a molding cycle;

FIGS. 39-52 are schematic representations of yet another alternative embodiment of an injection molding system during various stages of operation of a molding cycle; and

FIGS. 53-67 are schematic representations of yet another alternative embodiment of an injection molding system during various stages of operation of a molding cycle.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

Reference will now be made in detail to various non-limiting embodiment(s) of an injection mold and a method of molding a molded article having an insert. It should be understood that other non-limiting embodiment(s), modifications and equivalents will be evident to one of ordinary skill in the art in view of the non-limiting embodiment(s) disclosed herein and that these variants should be considered to be within scope of the appended claims.

Furthermore, it will be recognized by one of ordinary skill in the art that certain structural and operational details of the non-limiting embodiment(s) discussed hereafter may be modified or omitted (i.e. non-essential) altogether. In other instances, well known methods, procedures, and components have not been described in detail.

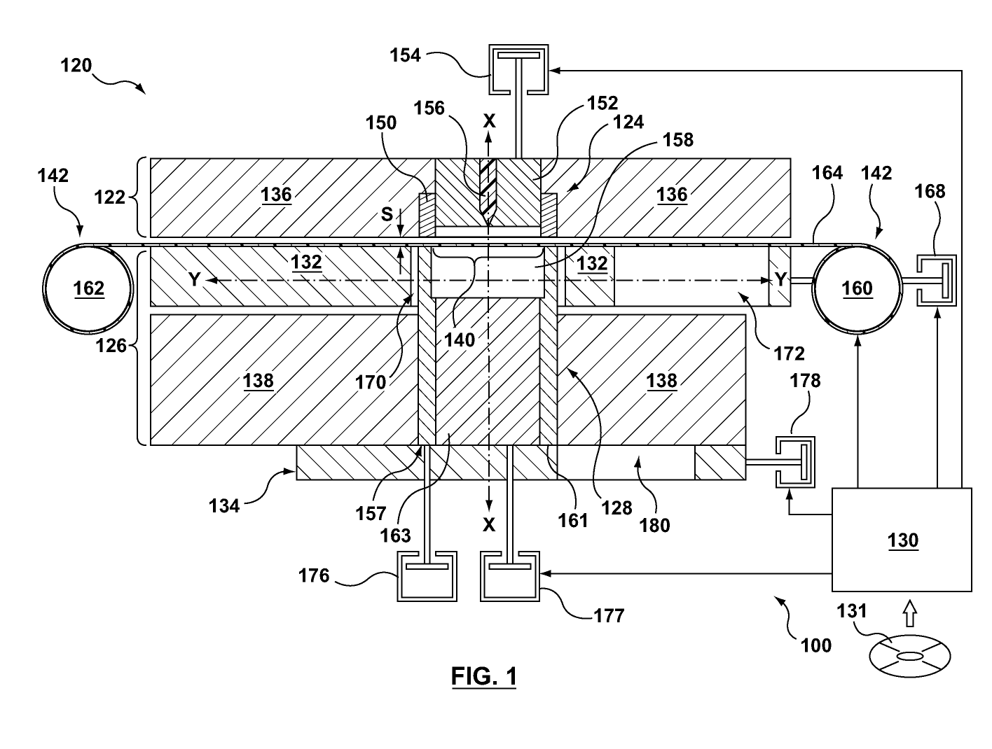

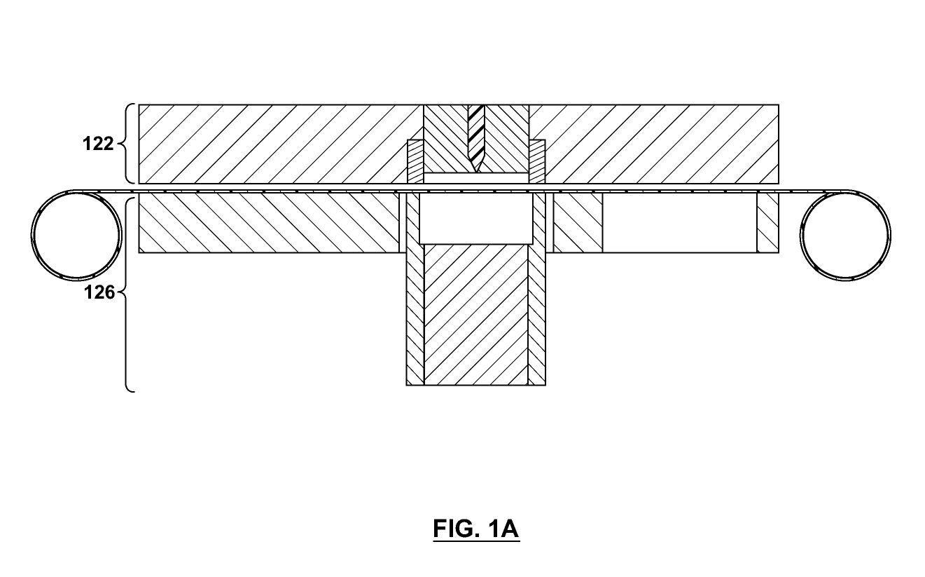

FIG. 1 illustrates a schematic representation of a non-limiting example injection molding system 100. The system 100 may be used for injection molding of articles with incorporated inserts. The articles may for example be closures for containers, which may be molded from a material such as, for example, Polypropylene. The inserts may for example be labels, circuits (e.g. RFID tags), sheets of a barrier material (e.g. a foil or film) that is impermeable to oxygen or containing a reagent for scavenging oxygen, or other types of inserts. The system 100 may be used to create molded articles in which the insert is integrally formed with the article, such as by being embedded within the article or being integrally formed with an interior and/or exterior surface of an article. The system 100 comprises an injection mold 120 and a controller 130.

The injection mold 120 includes a first mold half 122 comprising a first mold stack portion 124, a second mold half 126 comprising a second mold stack portion 128 and a shuttle 132, and an in-mold shutter 134. In FIG. 1, most of the illustrated components, such as the first and second mold stack portions 124 and 128, and in mold-shutter are shown in cross-section, while other components, such as the controller 130, are illustrated schematically.

The first and second mold halves 122 and 126 generally constitute the main components of the physical injection mold structure surrounding the mold stack portions 124 and 128, the latter being the components that are actually used to define the molding cavity. The first mold half 122 comprises a first mold shoe 136, and the second mold half 126 comprises a second mold shoe 138. A mold shoe is a framework of a mold with which components of a mold stack are associated. Each shoe is usually provided by one or more plates of a durable high strength material such as steel that is able to withstand the tremendous compressive clamping force that is applied during molding. The plates within the shoe are often configured to be moveable relative to one another, along an axis of the mold, for sake of providing relative movement of the components of the mold stack that are associated therewith. These relative movements of the plates within the shoe may for example be made with the mold in an open configuration, e.g. for the sake of ejecting molded articles from the various mold stacks. Because the first mold half 122 is used to introduce molding material in the present embodiment, which molding material may be hot material such as, for example, melted Polypropylene, the first mold half 122 may be referred to as the “hot half” of the mold. Conversely, the second mold half 126, which merely receives molding material, may be referred to as the “cold half” of the mold.

The mold halves 122 and 126 are movable, along mold-stroke axis X of FIG. 1, between two configurations.

The first configuration is a mold-open configuration. In this configuration, the first and second mold halves 122 and 126 are separated from one another so as to render the first and second mold stack portions 124 and 128 accessible from outside the injection mold. The mold-open configuration might for example be used in a start-up phase of operation, when manual intervention by a molding system operator may be required to clear short shots (i.e. partially molded articles), flash (i.e. molding material that has seeped outside the molding cavity), or the like. An example of one possible mold-open configuration of the mold 120 (with various features from FIG. 1 being omitted for clarity) is shown in FIG. 1A.

The second configuration, which is represented in FIG. 1, is a mold-closed configuration. In the mold-closed configuration, the mold halves 122 and 126 are substantially adjacent to one another, so that the injection mold 120 can be used for injection molding articles incorporating inserts in the manner described below. Moreover, through use of the shuttle 132, as will also be described below, the mold halves 122 and 126 may remain substantially in the mold-closed configuration while completed (molded) articles with incorporated inserts are ejected from the injection mold 120 to a transfer structure (with the possibility that, in some embodiments, there may be a minute stroke, e.g. of about 0.5 mm in one example, that may be provided by retraction of a clamp piston—hydraulic clamp, as illustrated hereinafter in respect of another embodiment). This may promote energy efficiency, because the mold halves need not reciprocate between the mold-closed configuration and the mold-open configuration in order to eject each completed molded article. This may in turn promote a greater throughput, i.e. reduced cycle time, e.g. because the portions of the injection mold 120 that must be made to move in order to mold and eject an article with an incorporated insert may be relatively small in relation to the size of the mold halves 122 and 126, such that movement of those smaller portions may be done comparatively quickly in relation to movement of the larger mold halves.

The first and second mold stack portions 124 and 128 are sub-components of the injection mold 120 that move relative to one another, within the mold halves 122 and 126, to alternately create a molding cavity for the article to be molded and thereafter eject the molded article for transfer from the injection mold 120. The relative movement of the first and second mold stack portions 124 and 128 of FIG. 1 is along the mold-stroke axis X. In the illustrated embodiment, each of the mold stack portions 124 and 128 moves along the mold-stroke axis X during a molding cycle. This is not necessarily true for all embodiments. For example, in some embodiments, relative movement between the first and second mold stack portions 124 and 128 may be achieved through movement of only the first mold stack portion 124 in relation to the second mold stack portion 128, or alternatively through movement of only the second mold stack portion 128 in relation to the first mold stack portion 124. That is to say, it is possible that one of the first and second mold stack portions may remain stationary in some embodiments.

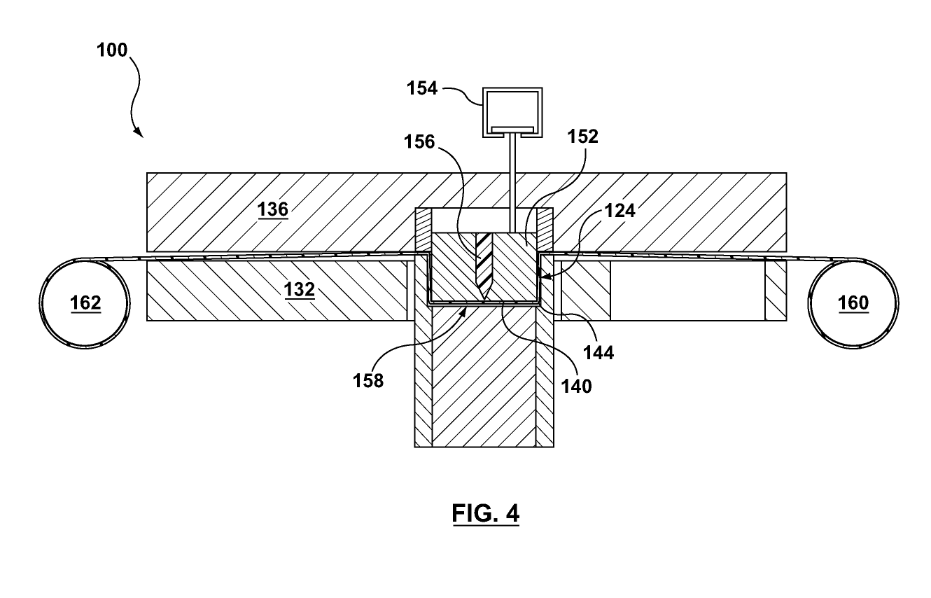

In the present embodiment, the movement of the first and second mold stack portions 124, 128 relative to one another, along mold-stroke axis X, is between a spaced configuration and a molding configuration. In the spaced configuration, the first and second mold stack portions 124 and 128 are in a spaced relation, which is represented in FIG. 1 by the separation denoted S between them. The separation S permits an insert 140 to be disposed between the first and second mold stack portions 124 and 128, by an insert feeder mechanism 142 (described below), for subsequent enclosure of the insert 140 within a molding cavity 144 (see FIG. 4) later in the molding cycle. In the molding configuration, the first and second mold stack portions 124 and 128 cooperate to define a molding cavity 144 therebetween having a generally U-shape in cross section (see FIG. 4).

As illustrated in FIG. 1, the first stack portion 124 comprises an outer core 150 and inner core 152. The inner core 152 may alternatively be referred to simply as the “core.” As will be appreciated, the lower surface of inner core 152 of FIG. 1 defines an interior surface of the article molded within the molding cavity 144. The outer core 150 is mounted in fixed relation to the first mold shoe 136, whereas the inner core 152 is slidable within the outer core 150. Reciprocating sliding movement of the inner core 152 within the outer core 150 is achieved by way of an actuator 154 (such as, for example, a hydraulic actuator, a pneumatic actuator, an electro-mechanical actuator, or the like), under control of controller 130.

The inner core 152 has a nozzle 156 for injecting molding material into the molding cavity 144 (FIG. 4). In the present embodiment, the nozzle 156 is within the inner core 152; this arrangement facilitates incorporation of the insert 140 with an exterior surface of the molded article. This is not necessarily true of all embodiments. That is, in some embodiments, the nozzle may alternatively be situated within the mold stack portion that comprises the cavity rather than the core. Moreover, in some embodiments it may not be desired for the insert 140 to be incorporated with the exterior surface of the molded article. For example, it may instead be desired for the insert 140 to either be incorporated with the interior surface of the article or embedded within the article, or perhaps a combination of these.

The second stack portion 128 of the embodiment shown in FIG. 1 comprises a cylindrical mold insert 157 defining a mold cavity 158. The term “mold insert” reflects the fact that the component 157 may be removable from the second mold shoe 138 in favor of a different mold insert, to support reconfiguration of the injection mold 120 for molding different types of articles. In the present embodiment, the mold cavity 158 of mold insert 157 will define an exterior surface of the article to be molded, which is a container closure in the present example. In particular, the mold insert 157 comprises a tubular portion 161 that defines the exterior surface of the skirt portion of the container closure and a cylindrical portion 163 that defines the exterior surface of the top of the container closure. In the present embodiment, the cylindrical portion 163 is slidable within the tubular portion 161. This sliding may facilitate ejection of a molded article from the cavity 158, as will be described. By virtue of that fact, the cylindrical portion 163 may alternatively be referred to as ejector portion 163.

The shuttle 132 of the present embodiment is slideably disposed between the first and second mold shoes 136 and 138 of the first second and second mold halves 122 and 126 respectively. The shuttle 132 is movable along a shuttling axis Y that is generally perpendicular to mold-stroke axis X in the illustrated embodiment. Reciprocating motion of the shuttle 132 along shuttling axis Y in the present embodiment, as will be described subsequently, is facilitated by actuator 168, which may for example be a hydraulic actuator, a pneumatic actuator, an electro-mechanical actuator, or the like, under control of controller 130.

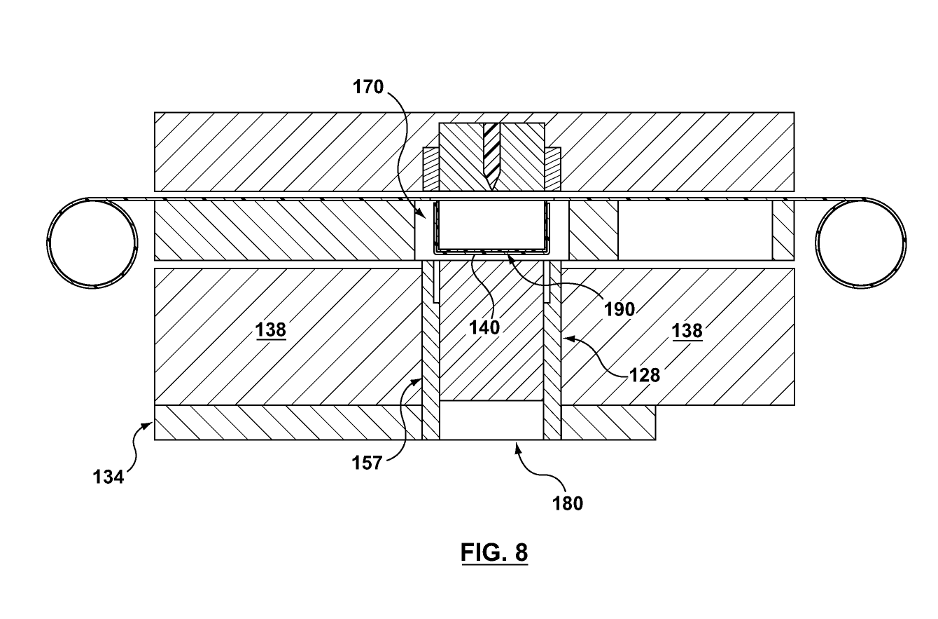

The shuttle 132 has first and second apertures 170 and 172 respectively. In FIG. 1, the first aperture 170 is aligned (vertically in FIG. 1) with the first and second mold stack portions 124 and 128. In a subsequent cycle, the other aperture 172 will become so aligned. This sequence is then repeated in subsequent cycles. During operation of the system 100, the aperture 170 will alternately substantially accommodate: (a) the first and second mold stack portions 124 and 128, when the portions 124 and 128 are in the molding configuration—see e.g. FIG. 4; and (b) the molded article incorporating the insert 140, upon withdrawal of the first and second mold stack portions 124 and 128 from the aperture 170, for shuttling and transfer of the molded article 190 out of the injection mold 120, as shown in FIGS. 8-10 for example.

Reciprocating movement of the second mold stack portion 128, and in particular of mold insert 157, along the mold-stroke axis X, is achieved in the present embodiment by way of actuators 176 and 177 (such as, for example, hydraulic actuators, pneumatic actuators, electro-mechanical actuators, or the like), under control of controller 130. Actuator 176 controls the movement of the tubular portion 161 of the mold insert 157, and actuator 177 separately controls the movement of the ejector portion 163 of the mold insert 157. The two portions 161 and 163 are typically moved together except when the molded article is being ejected, although this is not required.

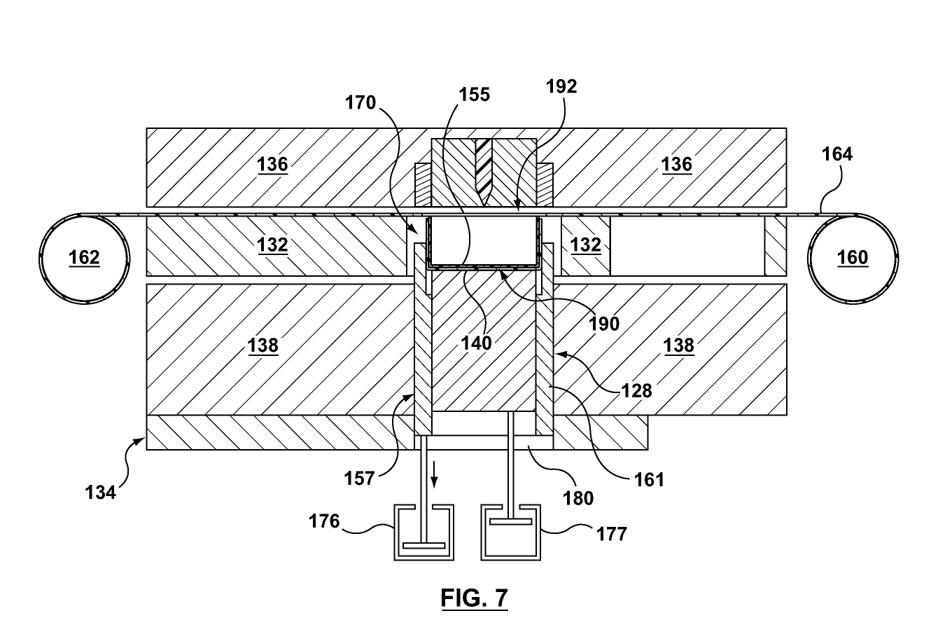

The in-mold shutter 134 (or simply “shutter” 134) facilitates positioning of the first and second mold stack portions 124 and 128 in either the spaced configuration, as shown in FIG. 1 for example, or the molding configuration, as shown in FIG. 4 for example, without requiring the mold halves 122 and 126 to be moved from the mold-closed configuration that is represented, e.g., in FIG. 1. The shutter is reciprocable in a direction that is substantially parallel to the shuttling axis Y, between a shut position (as shown in FIG. 1) and an open position (as shown in FIG. 7 for example). Reciprocating movement of the shutter 134 may be achieved by way of an actuator 178 (such as, for example, a hydraulic actuator, a pneumatic actuator, an electro-mechanical actuator, or the like), under control of controller 130.

When the in-mold shutter 134 is in the shut position, as shown in FIG. 1, the shutter 134 blocks movement of the second mold stack portion 128 in a direction away from the first mold half 122 (i.e. downwardly in FIG. 1). This prevents the upper portion of the second mold stack portion 128, comprising the mold cavity 158, from being withdrawn from within the shuttle aperture 170.

Conversely, when the shutter 134 is in the open position, as shown in FIG. 7 for example, a shutter aperture 180 in the shutter 134 becomes aligned with the lower portion of the second mold stack portion 128. When this alignment is achieved, the lower end of mold insert 157 is movable in a direction away from the first mold half 122 (i.e. downwardly in FIG. 1), e.g. through actuation by actuator 176 under control of controller 130.

In this way, the shutter 134 facilitates the alternating relative positioning of the first and second mold stack portions 124 and 128 in the spaced configuration and the molding configuration, without requiring the first and second mold halves 122 and 126 to be adjusted from their mold-closed configuration.

Referring again to FIG. 1, the insert feeder mechanism 142 of the present embodiment comprises a supply reel 160 and a take-up reel 162 under control of controller 130. The reels 160 and 162 are operable advance a ribbon 164 comprising the insert 140 between the first and second mold stack portions 124 and 128. In particular, the mechanism 142 turns the reels 160 and 162 to dispose a portion of the ribbon 164, which portion will comprise the insert 140, between the first and second mold stack portions 124 and 128. The insert may then be severed (e.g. punched) from the ribbon 164, into the molding cavity 144, for incorporation into the molded article, in the manner described below. When the first and second mold stack portions 124 and 128 are separated into spaced relation S for ejection of molded article, the mechanism 142 advances the ribbon 164 to align a new insert 140 between the first and second mold stack portion 124 and 128 for use in the subsequent molding cycle, with the cutout portion of ribbon 164 from the severing of the previous insert 140 being conveyed towards the take-up reel 162.

The controller 130 is a programmable logic controller or other form of processor that controls operation of the injection molding system 100 as described herein. The controller 130 may send control signals to one or more of actuators 154, 168, 176 and 178 of FIG. 1 to effect movement of the inner core 152, the shuttle 132, the mold insert 157, and the shutter 134, respectively, and/or to control the feeder mechanism 142 used to supply inserts 140 for incorporation into molded articles, as described herein. In some embodiments, operation of the controller 130 may be governed by instructions, which may be loaded from a non-transitory machine-readable medium 131, that, upon execution by the controller 130, cause the controller 130 to control the operation the injection molding system 100 as described herein. The machine-readable medium 131 may be an optical disk or magnetic storage medium for example.

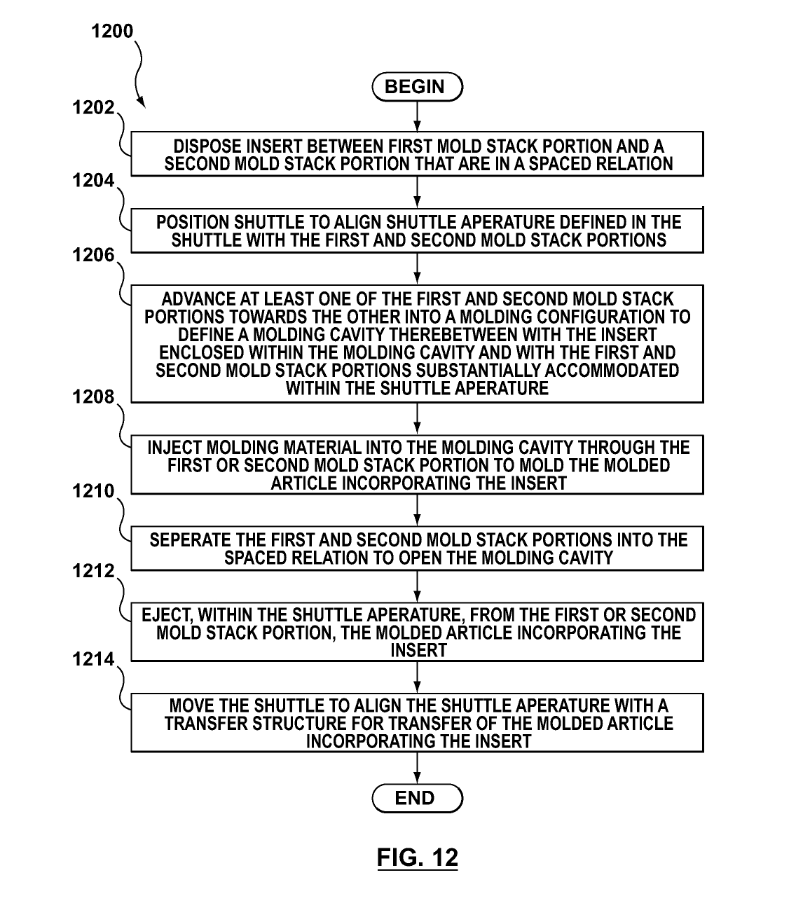

Example operation 1200 of the injection molding system 100 is illustrated in FIG. 12 in conjunction with FIGS. 1 to 11. It should be appreciated that, in FIGS. 1 to 11, various component or subcomponents of the injection molding system 100 may be omitted for brevity or clarity.

Initially, the injection molding system 100 is configured as shown in FIG. 1, with the first and second mold stack portions 124 and 128 being in the spaced configuration, i.e. are in a spaced relation, separated by a space S.

An insert 140 is disposed between first mold stack portion 124 and a second mold stack portion 128 (FIG. 12, 1202). Disposing of the insert 140 may be achieved by sending a suitable control signal to the supply reel 160 and/or take-up reel 162 to cause the insert 140 to be advanced to a position between the first and second mold stack portions 124 and 128 and stopped there. It will be appreciated that the insert 140 may be integrally formed with ribbon 164.

The shuttle 132 is positioned along the shuttling axis Y to cause the first shuttle aperture 170 to align with the first and second mold stack portions 124 and 128 (FIG. 12, 1204). In FIG. 1, this alignment is already achieved from the previous molding cycle.

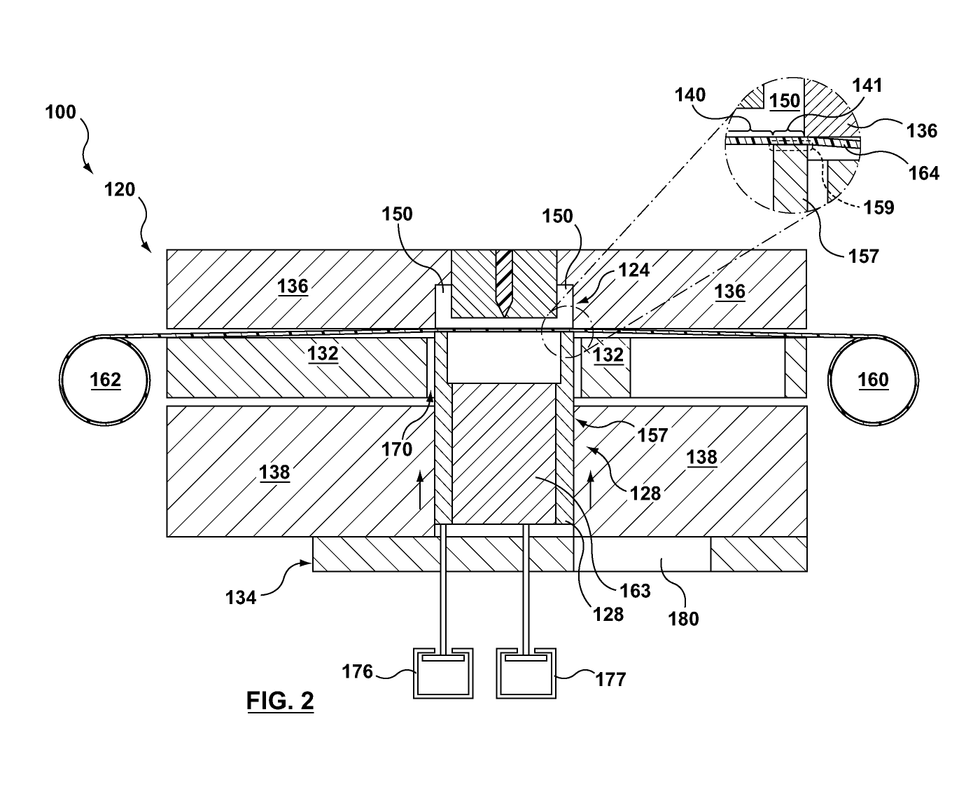

Next, at least one of the first and second mold stack portions 124, 128 is moved towards the other of the first and second mold stack portions 124, 128 into a molding configuration to define a molding cavity 144 therebetween, with the insert 140 enclosed within the molding cavity 144 and with the first and second mold stack portions 124 and 128 substantially accommodated within the shuttle aperture 170 (FIG. 12, 1206). In the present embodiment, operation 1206 occurs in stages, as shown in FIGS. 2-4.

Referring to FIG. 2, the mold insert 157 comprising the second mold stack portions 128 is initially advanced through shuttle aperture 170 towards the outer core 150 of the first mold stack portion 124, until a peripheral border 141 of the insert 140 becomes pinched between the outer core 150 and the periphery 159 of the mold insert 157. This is shown in the enlarged portion of FIG. 2 for example. Advancement of the mold insert 157 in this manner may be actuated by actuators 176 and 177, under control of controller 130, which may drive portions 161 and 163 of the mold insert 157 in unison. It will be appreciated that, at this stage, the peripheral border 141 surrounding the insert 140 is still integral with the insert 140 in the present embodiment. Moreover, at this stage both of the insert 140 and the border 141 surrounding the insert remain integrally formed with the ribbon 164 in the present embodiment. As will be appreciated, this is not necessarily true of all embodiments.

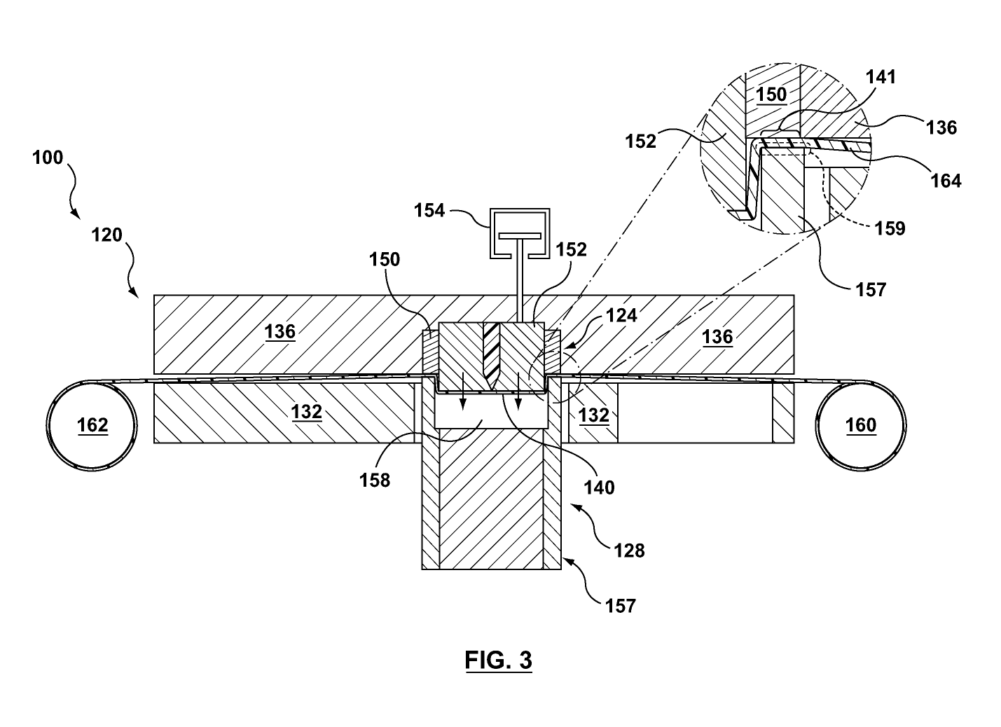

Turning to FIG. 3, with the peripheral border 141 of the insert 140 remaining pinched between the outer core 150 and the periphery 159 of the mold insert 157, the inner core 152 is advanced towards the cavity 158 of mold insert 157. In the present embodiment, the inner core 152 slides within the outer core 150 (downwardly in FIG. 3) towards the mold insert 157. The leading end of the inner core 152 impacts upon the insert 140 (ribbon 164) and begins stretching the insert 140 into the cavity 158 of the mold insert 157.

Referring to FIG. 4, the first mold stack portion 124, and in particular, the inner core 152, advances to a limit and stops there, resulting in the formation of a molding cavity 144 between the first and second mold stack portions 124 and 128. This configuration is referred to as the molding configuration of the first and second mold stack portions 124 and 128. The insert 140, having been stretched about the leading end and sides of inner core 152, is substantially enclosed within the molding cavity 144. In essence, the molding cavity 144 is a negative shape defining the article to be molded (e.g. for an open article such as a container closure, the molding cavity 144 will define both the interior surface and the exterior surface of the article). This is in contrast to mold cavity 158, which defines only an exterior portion of the article to be molded. Throughout the present description, the term “molding cavity” (i.e. the gerund form “molding”) refers the former while the term “mold cavity” refers to the latter.

The cross-sectional shape of the example molding cavity 144 in FIG. 4 is generally U-shaped, consistent with the fact that the article is a closure for a container in this example. The shape of the molding cavity 144 may vary in other embodiments, depending upon the article being molded.

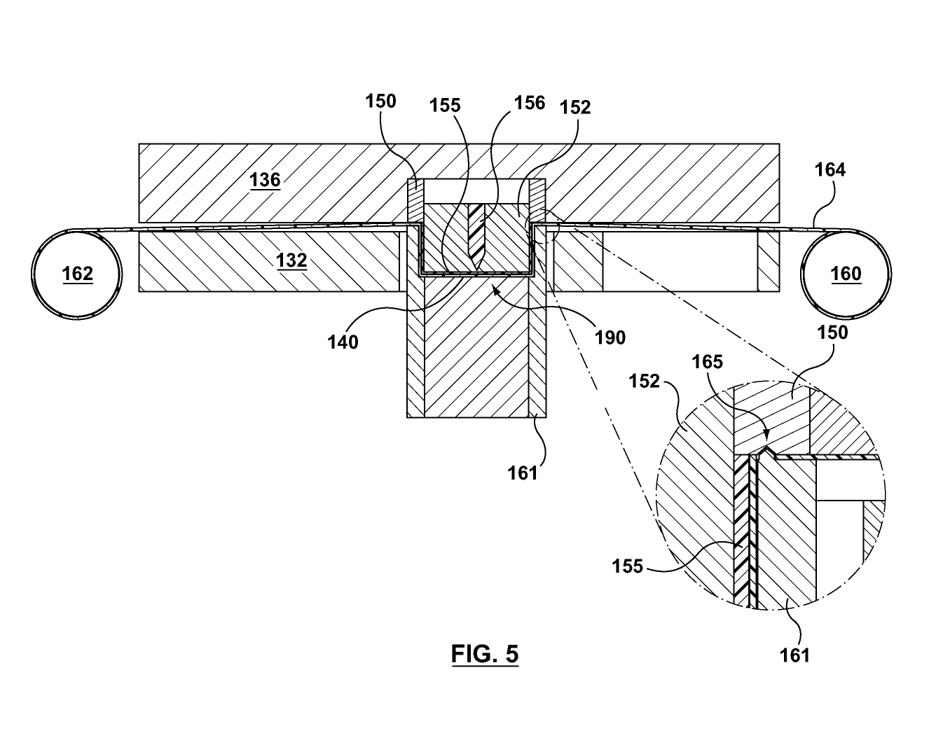

Referring to FIG. 5, at this stage, the insert 140 is severed from the ribbon 164. Severing may be achieved by a cutting edge 165 that may be defined between the mating faces of the tubular portion 161 of the mold insert 157 and the outer core 150, e.g. as shown in the enlarged view of FIG. 5 for example. Thereafter, with mold 120 clamped, molding material 155, such as, for example, melted Polypropylene, is injected into the molding cavity via nozzle 156 of first mold stack portion 124. This results in the molding of an article 190 incorporating the insert 140 (FIG. 12, 1208). In the illustrated example, the insert 140 becomes integrally formed with the exterior surface of the article 190, because the molding material is injected from the inner core 152 that defines the interior surface of the article 190. In alternative embodiments, the injection could be performed from the mold insert 157 (cavity) side of the molding cavity 144, if it is desired for the insert 140 to become integrally formed with the interior surface of the article 190 for example. Alternatively, in other embodiments, the insert may be fully embedded within the article by injecting material on both sides of the inset, e.g. through both the core and the cavity, to sandwich the insert between two layers of the injected material.

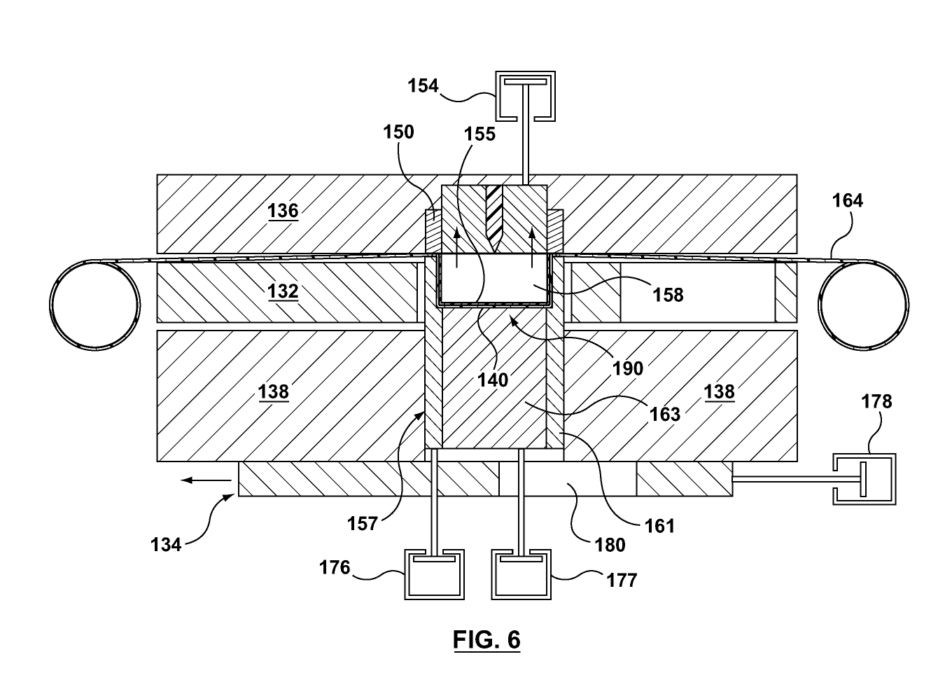

Referring to FIG. 6, the inner core 152 is retracted from the shuttle aperture 170, and more particularly from the cavity 158 of mold insert 157 that is accommodated within shuttle aperture 170, and is returned to its original starting position, as originally shown in FIG. 1. Although not shown in FIG. 6, the first and second mold stack portions 124 and 128 become separated into the spaced relation, with separation S between them, as also originally shown in FIG. 1 (FIG. 12, 1210). In the result, the molding cavity 144 is opened. When the periphery 159 of the mold insert 157 moves away from the outer core 150, the peripheral border 141 of the insert 140 is released, i.e. is no longer pinched. Meanwhile, actuator 178 commences movement of in-mold shutter 134 from the shut position to the open position (to the left in FIG. 1), in order to facilitate retraction of the mold insert 157 from the shuttle aperture 170 as well as ejection of the article 190 from the cavity 158 of the mold insert 157. When retraction of the mold insert 157 from the shuttle aperture 170 is commenced, the tubular portion 161 and the ejector portion 163 of the mold insert 157 may initially be retracted in unison, e.g. through coordinated or simultaneous actuation of the portions 161 and 163 by respective actuators 176 and 177, under control of controller 130.

Turning to FIG. 7, it can be seen that the in-mold shutter 134 has attained the open position, such that the shutter aperture 180 has become aligned with the lower portion of the second mold stack portion 128 (i.e. of mold insert 157). This allows the lower end of mold insert 157 to be retracted into the aperture 180 in a direction away from the first mold half 122 (i.e. downwardly in FIG. 1), through actuation by actuator 176 under control of controller 130. This in turn causes the upper portion of the mold insert 157 (i.e. of the second mold stack portion 128) to be retracted from the shuttle aperture 170 of shuttle 132. A cutout 192 in the ribbon 164, in the shape of the insert 140, is shown in FIG. 7.

As second mold stack portion 128 retracts, the molded article 190 incorporating insert 140 is ejected, within the shuttle aperture 170, from the second mold stack portion 128 (FIG. 12, 1212), and in particular, from the cavity 158. In the illustrated embodiment, ejection of the molded article 190 is facilitated by relative motion between the tubular portion 161 and the ejector portion 163 of the mold insert 157. In particular, the surrounding tubular portion 161 is withdrawn relative to the inner cylindrical part 163, which remains substantially stationary (although there may be a small retraction of the ejector portion 163 relative to the aperture 170 in some embodiments, as shown in FIG. 7). The relative motion causes the molded article 190 to be stripped from the tubular portion 161 and to be left within the aperture 170 of the shuttle 132. In some embodiments, ejection may be performed from the first mold stack portion 124 rather than from the second mold stack portion 128.

FIG. 8 illustrates complete withdrawal of the second mold stack portion 128 from the shuttle aperture 170, with the lower portion of the mold stack portion 128 being received fully within aperture 180 of shutter 134. The molded article 190 and incorporated insert 140 are ejected within shuttle aperture 170. More specifically, the second mold stack portion 128 is withdrawn from the shuttle aperture 170 without removing the molded article 190 incorporating the insert 140 from the shuttle aperture 170.

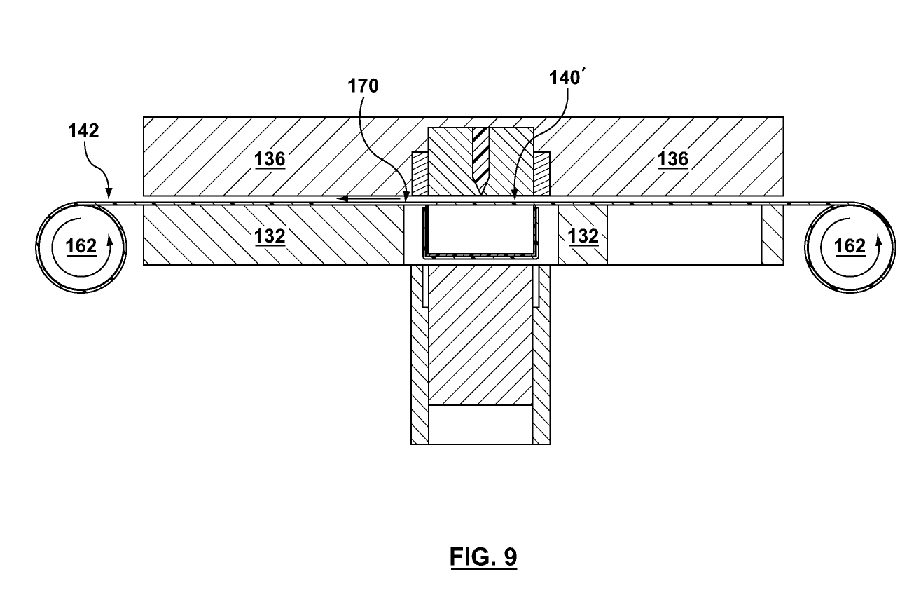

Referring to FIG. 9, the insert feeder mechanism 142 advances the ribbon 164 to provide a new insert 140′ for use in the subsequent molding cycle, while at the same time causing cutout 192, which resulted from the punching of the previous insert 140, to be conveyed towards the take-up reel 162.

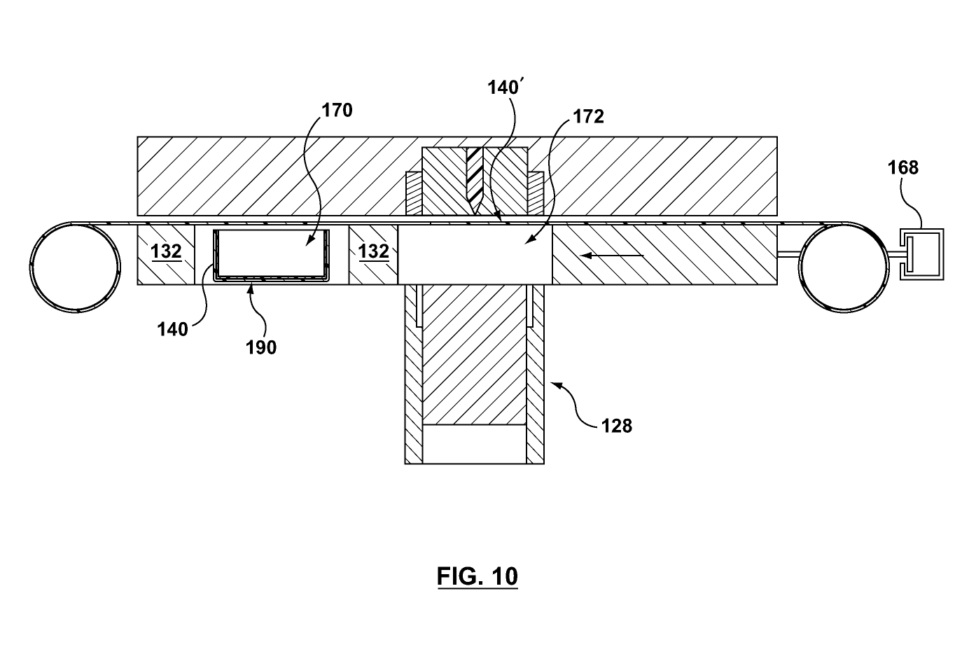

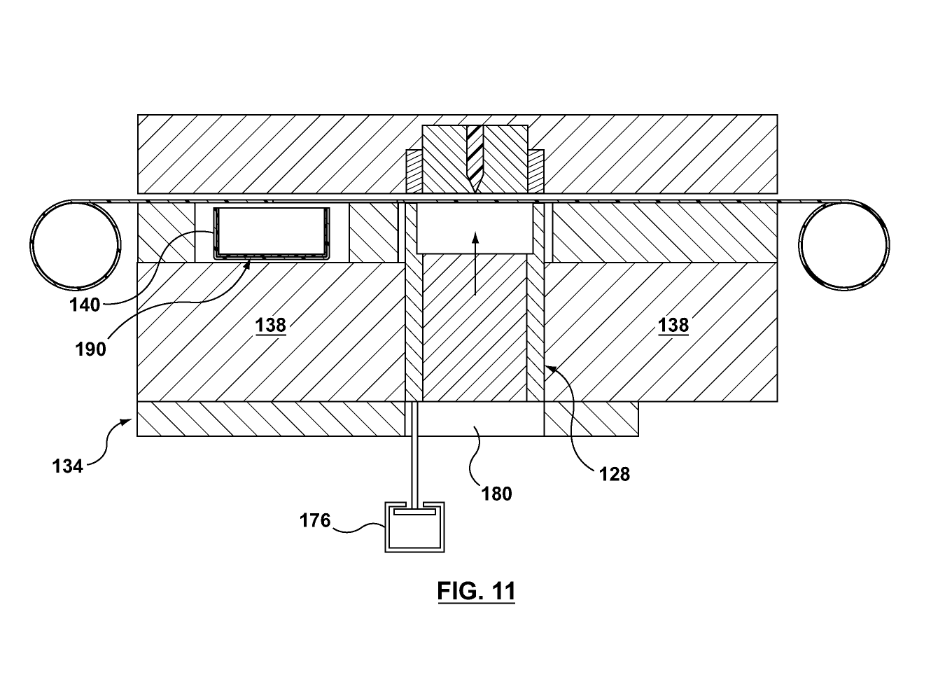

Referring to FIG. 10, the shuttle 132 is then moved by actuator 168 so as to align the first shuttle aperture 170 with a transfer structure (not expressly illustrated) for transfer of the molded article 190 incorporating the insert 140 from the injection molding system 100 (FIG. 12, 1214). This results in alignment of the second shuttle aperture 172 with the first and second mold stack portions 124 and 128. This permits the second mold stack portion 128 to be moved by actuator 176 towards the first mold shoe 136 until it is substantially accommodated within in the second shuttle aperture 172, in preparation for a subsequent molding cycle, as shown in FIG. 11. The in-mold shutter will then be adjusted from the open position of FIG. 11 to the shut position of FIG. 11. Meanwhile, the molded article 190 may be transferred from the first shuttle aperture 170 and out of the injection molding system 100. Operation 1200 is thus concluded.

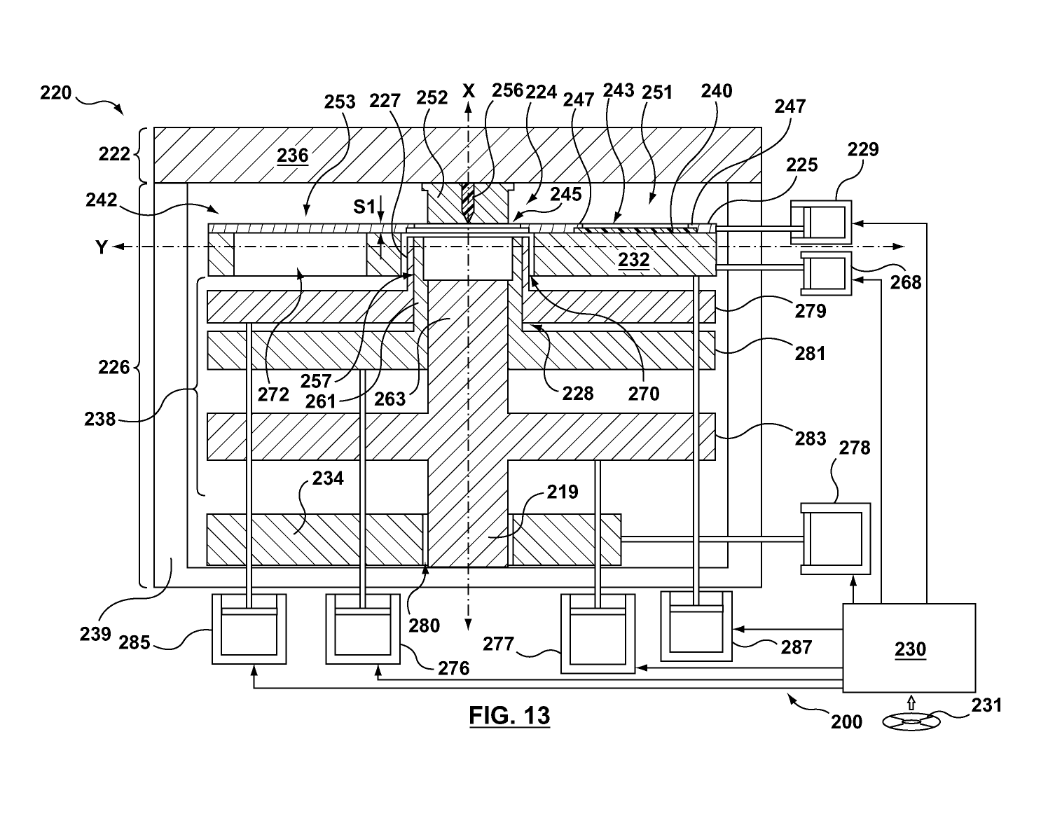

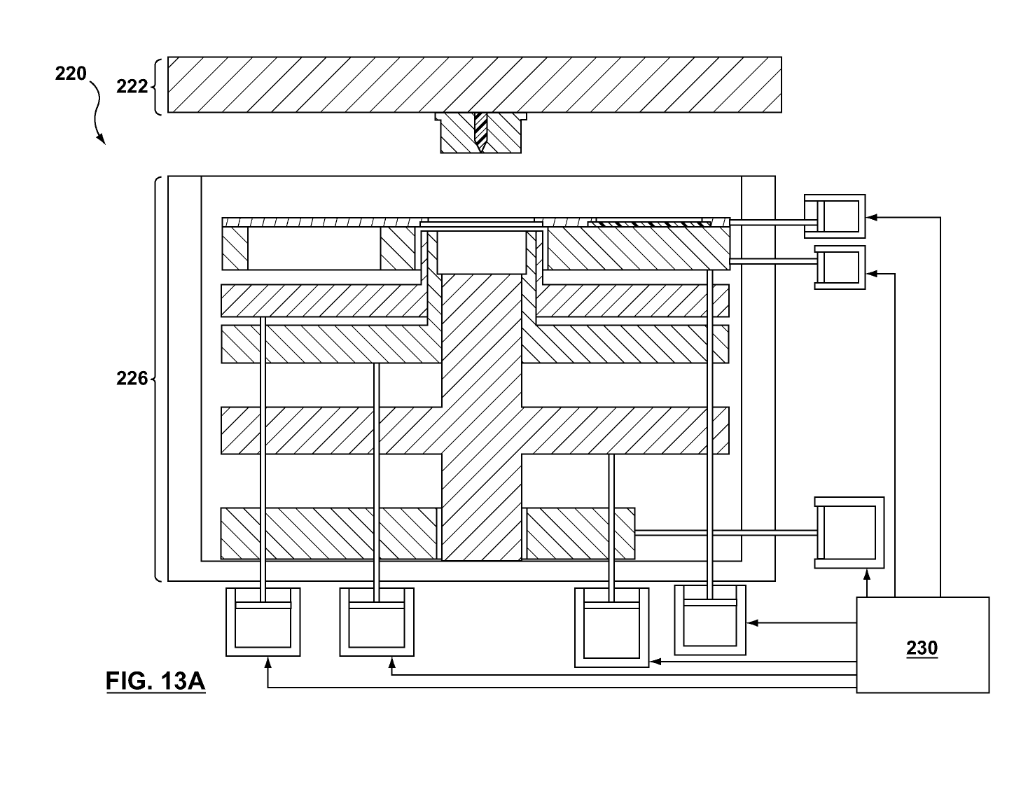

FIG. 13 illustrates a schematic representation of a non-limiting, alternative embodiment of an injection molding system for molding articles, which are container closures in the present example, with incorporated inserts. The illustrated system 200 differs from the embodiment of FIGS. 1-11 in that the inserts are not punched from a ribbon of material but rather take the form of pre-cut slugs or discs, and that the mechanism for disposing the inserts for incorporation into a molded article is accordingly different. The slugs may be of any shape (e.g. disc-shaped, square, or otherwise). The illustrated embodiment also differs from the embodiment of FIGS. 1-11 in that only one of the first and second mold stack portions moves during a molding cycle. The system 200 comprises an injection mold 220 and a controller 230.

The injection mold 220 includes a first mold half 222 and a second mold half 226. The first mold half 222 comprises a first mold shoe 236 and a first mold stack portion 224 associated therewith. The second mold half 226 comprises a second mold shoe 238 and a second mold stack portion 228 associated therewith. The second mold shoe and second mold stack portion 228 are contained within an ejector box 239, which is a housing that contains parts that are used to facilitate ejection of the molded article once injection molding has been completed. The parts notably include plates 279, 281 and 283 comprising the second mold shoe 238. The plates 279, 281 and 283 are associated with a pinching sleeve 227, tubular portion 261 and ejector portion 263, respectively, of the second mold stack portion 228. The second mold half 226 also comprises a shuttle 232 and an in-mold shutter 234, which are also contained within the ejector box 239 in FIG. 13. All of these components will be described in more detail below.

For clarity, most of the illustrated components of FIG. 13, such as the first and second mold halves 222 and 226, are shown in cross-section, while other components, such as the controller 230, are illustrated schematically.

The configuration represented in FIG. 13 is referred to as the mold-closed configuration. In the mold-closed configuration, the mold halves 222 and 226 are substantially adjacent to one another. Through use of the shuttle 232, the mold halves 222 and 226 may remain in the mold-closed configuration while completed (molded) articles with incorporated inserts are ejected from the injection mold 220 to a transfer structure. This may promote similar benefits to those described above with respect to the earlier-described embodiment. In the mold-closed configuration, the first mold half 222 effectively acts as a lid for the ejector box 239.

The mold-closed configuration of FIG. 13 may be contrasted against the mold-open configuration of FIG. 13A, in which the first and second mold halves 222 and 226 are separated from one another (i.e. the “lid” is removed) so as render the first and second mold stack portions 224 and 228 accessible from outside the injection mold 220. As noted above with respect to the embodiment of FIGS. 1-11, the mold-open configuration might for example be used in a start-up phase of operation but need not be used for ejecting molded articles during normal molding operation. The reason is that molded articles may be ejected during normal operation using shuttle 232, as described in more detail below.

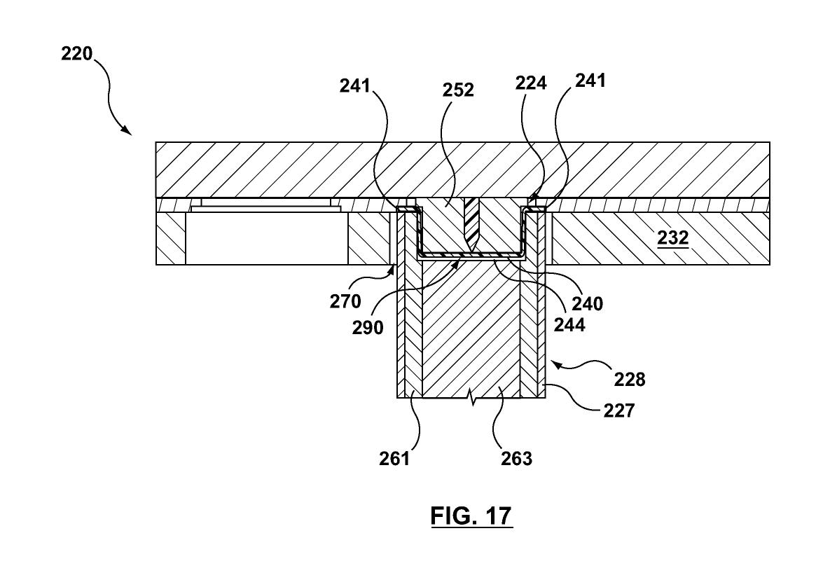

Referring again to FIG. 13, the first and second mold stack portions 224 and 228 are sub-components of the injection mold 220 that move relative to one another to alternately create a molding cavity 244 (as shown in FIG. 17) for the article to be molded and thereafter eject the molded article for transfer from the injection mold 220. The relative movement of the first and second mold stack portions 224 and 228 of FIG. 13 is along the mold-stroke axis X, between a spaced configuration and a molding configuration. In the spaced configuration, the first and second mold stack portions 224 and 228 are in a spaced relation, which is represented in FIG. 13 by the separation denoted Si between them. In the molding configuration, the first and second mold stack portions 224 and 228 cooperate to define a molding cavity 244 therebetween having a generally U-shape in cross section (see FIG. 17). In the illustrated embodiment, only the second mold stack portion 228 moves in relation to the first mold stack portion 224. That is to say, the first mold stack portion 224, and its associated mold shoe 236, remains stationary during molding in this embodiment.

As illustrated in FIG. 13, the first mold stack portion 224 comprises a unitary core 252. The core 252 remains stationary during operation in this embodiment by virtue of being fixedly connected or mounted to the first mold shoe 236, which also remains stationary as indicated above. The core 252 has a nozzle 256 for injecting molding material into the molding cavity 244 (FIG. 17). Situating the nozzle 256 within the core 252 facilitates incorporation of the insert 240 with an exterior surface of the molded article. In alternative embodiments, the nozzle may be situated elsewhere (e.g. in the second mold stack portion) if it is desired to incorporate the insert 240 elsewhere within the molded article (e.g. on an interior surface of the article).

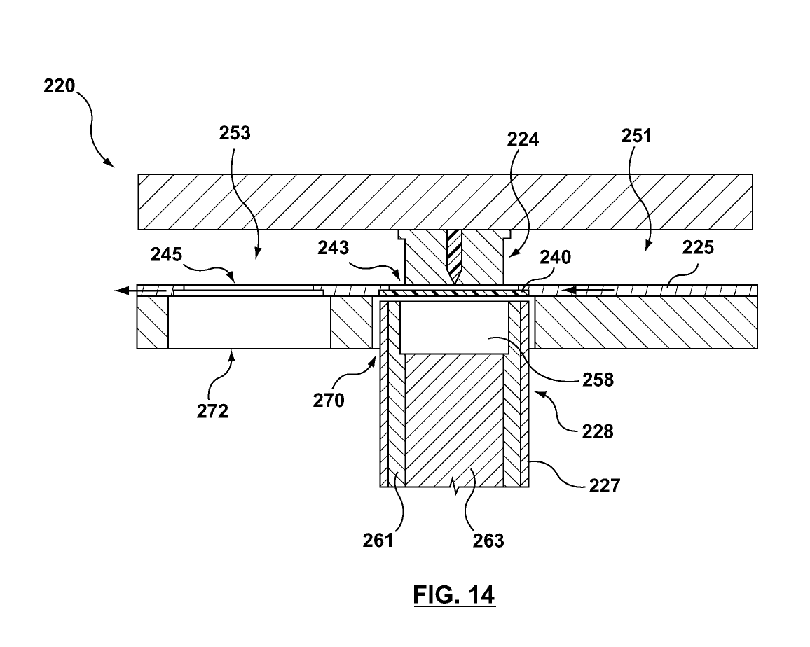

The second mold stack portion 228 of the embodiment shown in FIG. 13 comprises a cylindrical mold insert 257 defining a mold cavity 258 (FIG. 14). Like the second mold stack portion 128 of the earlier described embodiment, the second mold stack portion 228 of the present embodiment comprises a tubular portion 261 that defines the exterior surface of the skirt of the container closure to be molded and a cylindrical portion 263 that defines the exterior surface of the top of the container closure. The tubular and cylindrical portions 261 and 263 collectively define, within the mold insert 257, the mold cavity 258 that defines the exterior surface of the container closure that is to be molded. The cylindrical portion 263 is slidable within the tubular portion 261 to facilitate ejection of a molded article from the cavity 258, as will be described. By virtue of that fact, the cylindrical portion 263 may alternatively be referred to as ejector portion 263.

Unlike the second mold stack portion 128 of the earlier described embodiment, the second mold stack portion 228 of the present embodiment further comprises a surrounding pinching sleeve 227 that is slidable, in the mold-stroke axis X direction, relative to the tubular portion 261 of the mold insert. As will be appreciated, the pinching sleeve will hold (or will at least help to hold) the insert 240 in place as the insert 240 is stretched by way of relative movement between the core 252 and mold cavity 258.

Relative movement of the second mold stack portion 228 along the mold-stroke axis X, in relation to the first mold stack portion 224, is achieved in the present embodiment by way of multiple actuators 276, 277, and 285 under control of controller 230. In particular, the three above-identified components of mold stack portion 228, namely tubular portion 261, ejector portion 263, and pinching sleeve 227, are each mounted or connected to a respective plate 283, 281 and 279 comprising the second mold shoe 238. These plates 283, 281 and 279 are independently movable within the ejector box 239, relative to one another, by respective actuators 285, 276 and 277. The movement of the plates 283, 281 and 279 may be controlled to cause the respective mold stack portion components 261, 263 and 227 to move as desired, e.g. independently or in unison, depending upon the stage of injection molding operation, as described below.

The shuttle 232 is also movable within ejector box 239, in the mold-stroke axis X direction, independently of plates 283, 281 and 279, during injection molding. In the present embodiment, this movement may be driven by a further actuator 287, also under control of controller 230.

The various actuators 287, 285, 276 and 277 may for example be hydraulic actuators, pneumatic actuators, electro-mechanical actuators, or the like, or combinations of these.

In addition to being movable in the mold-stroke axis X direction, the shuttle 232 is also movable along a shuttling axis Y that is generally perpendicular to mold-stroke axis X in the illustrated embodiment. Reciprocating motion of the shuttle 232 along shuttling axis Y in the present embodiment, as will be described subsequently, is facilitated by actuator 268, which may for example be a hydraulic actuator, a pneumatic actuator, an electro-mechanical actuator, or the like, under control of controller 230. To accommodate the movement of the shuttle 232 along the shuttling axis Y a slidable connection may be provided between the shuttle 232 and the actuator 287 that moves the shuttle 232 along the mold-stroke axis X (e.g. T-slot).

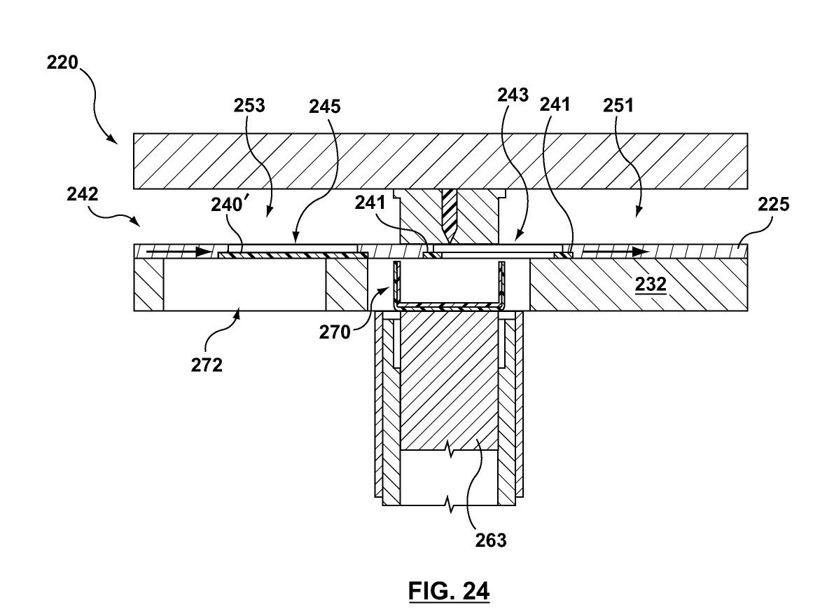

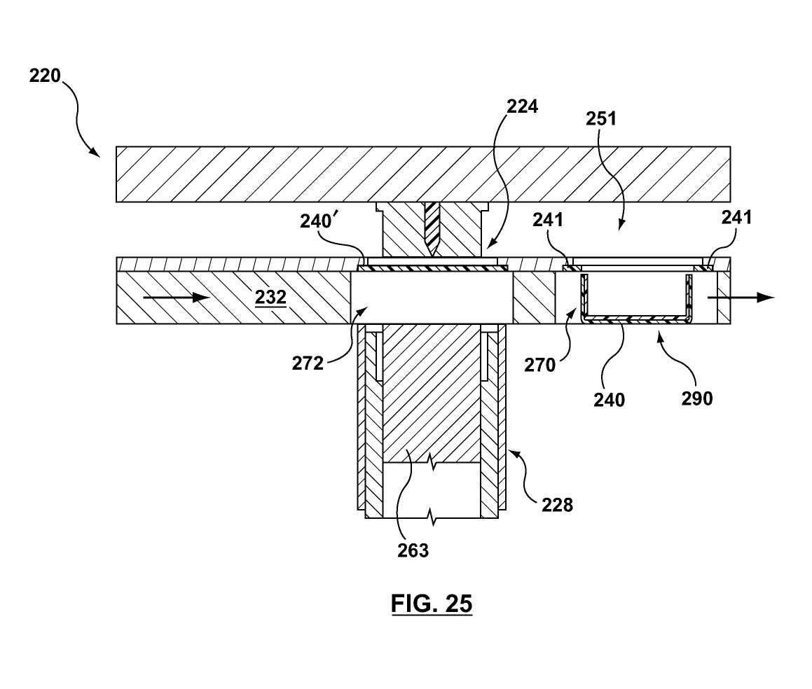

The shuttle 232 has first and second apertures 270 and 272 respectively. In FIG. 13, the first aperture 270 is aligned (vertically in FIG. 13) with the first and second mold stack portions 224 and 228. In a subsequent cycle, the other aperture 272 will become so aligned. This sequence is then repeated in subsequent cycles. During operation of the system 200, the aperture 270 will alternately substantially accommodate: (a) the first and second mold stack portions 224 and 228, when the portions 224 and 228 are in the molding configuration—see e.g. FIG. 17; and (b) the molded article 290 incorporating the insert 240, upon withdrawal of the first and second mold stack portions 224 and 228 from the aperture 270, for shuttling and transfer of the molded article 290 out of the injection mold 220, as shown in FIGS. 24 and 25 for example.

Referring again to FIG. 13, the in-mold shutter 234 facilitates positioning of the second mold stack portion 228 in either the spaced configuration, as shown in FIG. 13 for example, or the molding configuration, as shown in FIG. 17 for example, without requiring the mold halves 222 and 226 to be moved from the mold-closed configuration that is represented, e.g., in FIG. 13. The shutter 234 is reciprocable in a direction that is substantially parallel to the shuttling axis Y, between an open position (as shown in FIG. 13) and a shut position.

In the open position, a shutter aperture 280 within shutter 234 becomes aligned with a lower portion 219 of the second mold stack portion 228, so that the portion 219 can become accommodated within the aperture 280, as shown in FIG. 13 for example. This permits withdrawal of the ejector portion 263 from the shuttle aperture 270 when the shuttle 232 is positioned as shown in FIG. 13. That is, the ejector portion 263 of mold insert 257 is movable in a direction away from the first mold half 222 (i.e. downwardly in FIG. 13), e.g. through actuation by actuator 277 under control of controller 230.

Conversely, in the shut position (not expressly shown), the shutter aperture 280 is laterally offset from the lower portion 219 of the second mold stack portion 228. To permit in-mold shutter 234 to move from the open position to the closed position, the lower portion 219 of the second mold stack portion 228 should be withdrawn from the shutter aperture 280. When the in-mold shutter 234 is in the shut position, the shutter 234 blocks movement of the second mold stack portion 228 in a direction away from the first mold half 222 (i.e. downwardly in FIG. 13). This blocking may for example constitute abutment of the lower portion 219 against the shutter 234. The blocking prevents the upper portion of the second mold stack portion 228, comprising the mold cavity 258, from being withdrawn from within the shuttle aperture 270 during injection molding.

In this way, the shutter 234 facilitates the alternating relative positioning of the first and second mold stack portions 224 and 228 in the spaced configuration and the molding configuration, without requiring the first and second mold halves 222 and 226 to be adjusted from their mold-closed configuration.

Reciprocating movement of the shutter 234 between the open and shut positions may be achieved by way of an actuator 278 (such as, for example, a hydraulic actuator, a pneumatic actuator, an electro-mechanical actuator, or the like), under control of controller 230.

The insert feeder mechanism 242 of the present embodiment comprises a reciprocating slide plate 225 and associated actuator 229. The slide plate 225 comprises a pair of trays 243, 245 in coplanar fixed relation, each tray of the pair for carrying a single disc-shaped insert 240. The pair of trays 243, 245 is reciprocable, along with the slide plate 225, such that, when one of the trays of the pair disposes an insert 240 between the first and second mold stack portions 224 and 228, the other tray is in an outboard position 251 or 253 for insert loading.

Each tray 243, 245 has a peripheral lip 247 that protrudes inwardly above (i.e. on a side of the insert 240 that is opposite from the second mold stack portion 228—see FIG. 13) a peripheral border 241 of the insert 240. Loading of the insert 240 into tray 243 or 245 may be performed from the top or bottom in FIG. 13. In the former case, i.e. when an insert 240 is loaded from the side of the slide plate 225 to which the peripheral lip 247 is closest (i.e. from above in FIG. 13), it may be necessary or helpful to flex the insert 240 slightly during loading so that the lateral extent of the insert 240 can be gently forced through the somewhat smaller lateral extent of tray opening at the peripheral lip 247. This is so that, once the insert 240 has been so loaded, it may resiliently rebound laterally so that its peripheral border 241 is below the inwardly protruding peripheral lip 247 of the tray in FIG. 13. In the latter case, the insert 240 may be loaded from the opposite side the slide plate 225, i.e. from below the peripheral lip 247 in FIG. 13.

The controller 230 is a programmable logic controller or other form of processor that controls operation of the injection molding system 200 as described herein. The controller 230 may send control signals to one or more of actuators 229, 268, 276, 277, 285 or 287 of FIG. 13 to effect movement of the associated components. In some embodiments, operation of the controller 230 may be governed by instructions, which may be loaded from a non-transitory machine-readable medium 231, that, upon execution by the controller 230, cause the controller 230 to control the operation the injection molding system 200 as described herein. The machine-readable medium 231 may be an optical disk or magnetic storage medium for example.

Example operation 1200 of the injection molding system 200 is illustrated in FIG. 12 in conjunction with FIGS. 13 and 14 to 26. It should be appreciated that, in FIGS. 13 and 14 to 26, various component or subcomponents of the injection molding system 200, notably including the ejector box 239 and the various plates 279, 281 and 283 comprising the second mold shoe 238, are omitted for brevity or clarity.

Initially, the injection molding system 200 is configured as shown in FIG. 13, with the first and second mold stack portions 224 and 228 being in the spaced configuration, i.e. in a spaced relation, separated by a space S1.

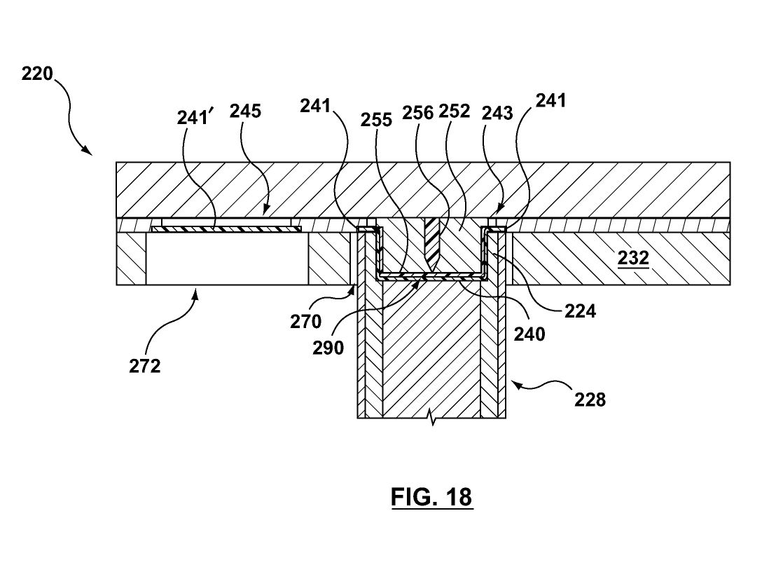

As shown in FIG. 14, an insert 240 is disposed between first mold stack portion 224 and a second mold stack portion 228 (FIG. 12, 1202). This is achieved by translation of the slide plate 225 to move tray 243 from outboard position 251, where insert 240 was loaded onto the tray 243, to the position shown in FIG. 14, between the first and second mold stack portions 224 and 228. This has the effect of simultaneously causing the other tray 245, which had been used to provide an insert in the previous molding cycle (not illustrated), to move from the position shown in FIG. 13 to the outboard position 253, for subsequent loading of a new insert 240′ (e.g. as shown in FIGS. 18-26) for use in a subsequent cycle.

The shuttle 232 is positioned along the shuttling axis Y to cause the first shuttle aperture 270 to align with the first and second mold stack portions 224 and 228 (FIG. 12, 1204). In FIGS. 13 and 14, this alignment is already achieved from the previous molding cycle. The shutter 234 is in the open position of FIG. 13, with the shutter aperture 280 accommodating the end 219 of the second mold stack portion 228.

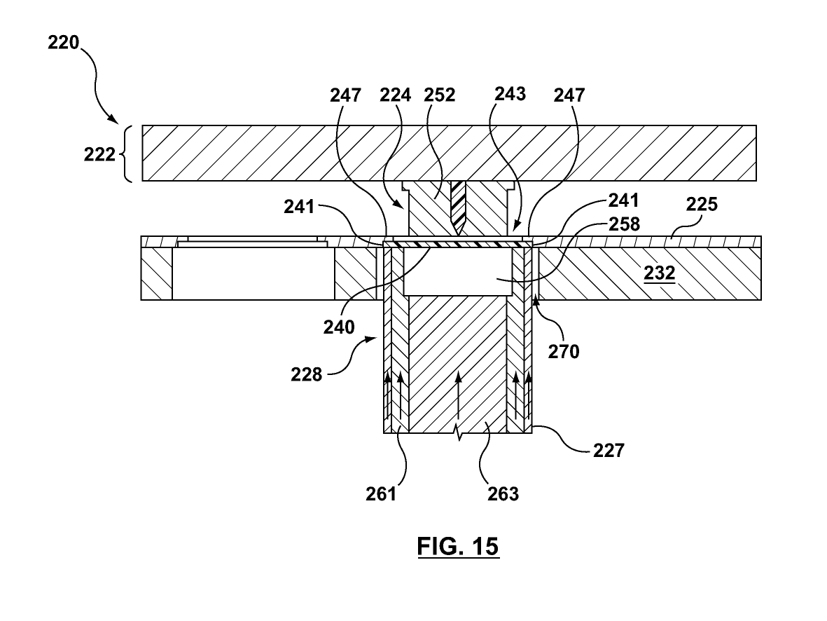

Next, at least one of the first and second mold stack portions 224, 228 is moved towards the other of the first and second mold stack portions 224, 228 into a molding configuration to define a molding cavity 244 therebetween, with the insert 240 enclosed within the molding cavity 244 (as in FIG. 17) and with the first and second mold stack portions 224 and 228 substantially accommodated within the shuttle aperture 270 (FIG. 12, 1206). In the present embodiment, operation 1206 occurs in stages, as shown in FIGS. 15-17.

Referring to FIG. 15, the second mold stack portion 228 is initially advanced through shuttle aperture 270 towards the core 252 of the first mold stack portion 224. In particular, the tubular portion 261, ejector portion 263, and pinching sleeve 227 components comprising mold stack portion 228 are driven in unison (upwardly in FIG. 15) by respective plates 283, 281 and 279, which in turn are driven by respective actuators 285, 276 and 277 (see FIG. 13) in a coordinated manner. The second mold stack portion 228 is so advanced until a peripheral border 241 of the insert 240 becomes pinched between the lip 247 of tray 243 and the upper portion of the pinching sleeve 227 (see FIG. 15).

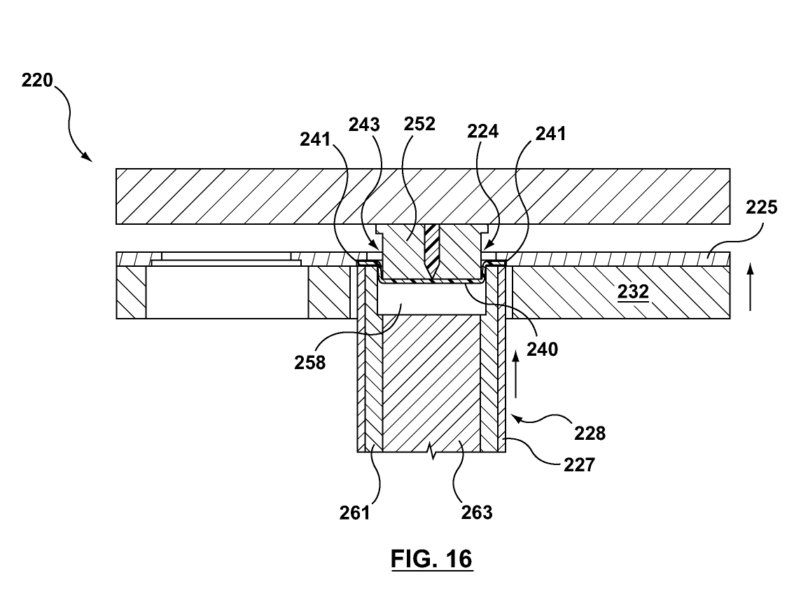

Turning to FIG. 16, with the peripheral border 241 of the insert 240 remaining pinched between the lip 247 of tray 243 and the pinching sleeve 227, the cavity 258 of mold insert 257 is advanced towards the stationary core 252. In particular, the tubular portion 261, ejector portion 263, and pinching sleeve 227 components comprising second mold stack portion 228 continue to move in unison through coordinated actuation of their respective plates 283, 281 and 279 (see FIG. 13), and the shuttle 232 and slide plate 225 now also commence moving, in unison, together with the components 261, 263 and 227 of the second mold stack portion 228.

The insert 240 impacts upon the core 252 and begins to stretch within the cavity 258. Notably, stretching occurs both at the skirt portion of the insert 240 that is depicted vertically in FIG. 16 as well as at the end portion of the insert 240 (the central portion) that is depicted horizontally in FIG. 16, with the degree of stretching occurring on the end portion possibly being less than that on the side (skirt) portion due to the direct contact (and resultant friction) between the insert and the end of core 252.

Referring to FIG. 17, the second mold stack portion 228 advances to a limit and stops there, resulting in the formation of a molding cavity 244 between the first and second mold stack portions 224 and 228. This configuration is referred to as the molding configuration of the first and second mold stack portions 224 and 228. The insert 240, having been stretched about the end and sides of core 252, is substantially enclosed within the molding cavity 244. The cross-sectional shape of the example molding cavity 244 in FIG. 17 is generally U-shaped, consistent with the fact that the article is a closure for a container in this example. The shape of the molding cavity 244 may vary in other embodiments, depending upon the article being molded.

Although not expressly depicted in FIG. 17, at this stage the in-mold shutter 234 (as shown in FIG. 13) is placed in the shut position so as to block movement of the second mold stack portion 228 in a direction away from the first mold stack portion 224 (i.e. downwardly in FIG. 17). This prevents the ejector portion 263 of the second mold stack portion 228 that defines the exterior top of the container closure from being withdrawn away from the core 252 during injection molding via nozzle 256.

Referring to FIG. 18, the peripheral border 241 of the insert 240 is severed. Severing may be achieved using complementary cutting surfaces defined in or on the tubular portion 261 of the mold stack portion 228 and insert tray 243 or a retainer thereof. These complementary cutting surfaces are not expressly depicted in FIG. 18 but may be similar to those shown in FIG. 5 of the earlier described embodiment.

Thereafter, with the mold 220 clamped, molding material 255, such as, for example, melted Polypropylene, is injected into the molding cavity via nozzle 256 of the core 252 of first mold stack portion 224. This results in the molding of the article 290 incorporating the insert 240 (FIG. 12, 1208). In the illustrated example, as with the earlier embodiment, the insert 240 becomes integrally formed with the exterior surface of the article 290, because the molding material is injected from the core 252 that defines the interior surface of the article 290. In alternative embodiments, the injection could be performed differently, e.g. from the mold insert 257 (cavity) side of the molding cavity 244, for example if it is desired for the insert 240 to become integrally formed with the interior surface of the article 290.

At this stage, the shutter 234 (not expressly shown in FIG. 18) is moved, by actuator 278 under control of controller 230, from the shut position, in which withdrawal of the ejector portion 263 of the second mold stack portion 228 away from the core 252 is blocked, to an open position, in which shutter aperture 280 becomes aligned with the lower portion 219 of the second mold stack portion 228 (see FIG. 13). This is in preparation for withdrawal of the second mold stack portion 228 from the molding configuration.

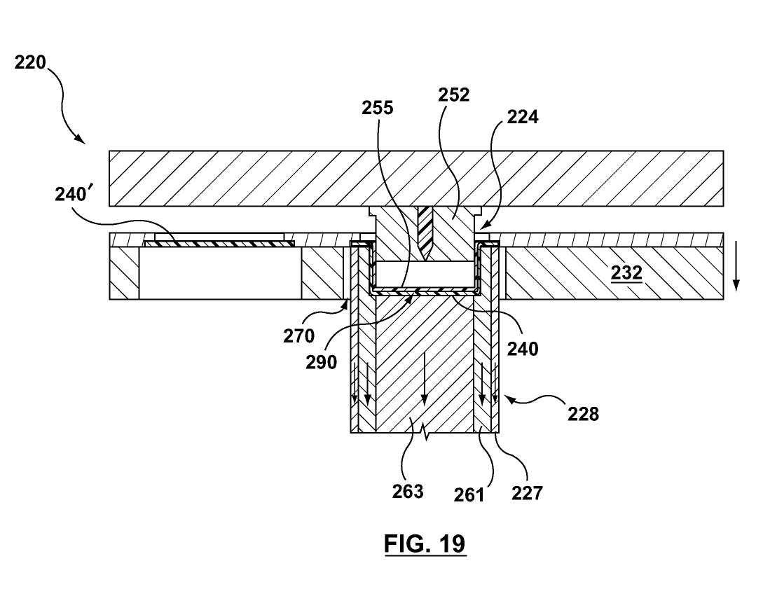

Referring to FIG. 19, the shuttle 232 and second mold stack portion 228 (including the tubular portion 261, ejector portion 263 and pinching sleeve 227) are retracted in unison (downwardly in FIG. 19), so as to withdraw the shuttle aperture 270, as well as the cavity 258 of mold insert 257, from about the core 252. Retraction of the ejector portion 263 is now possible in view of the above-described placement of the shutter 234 into the open position.

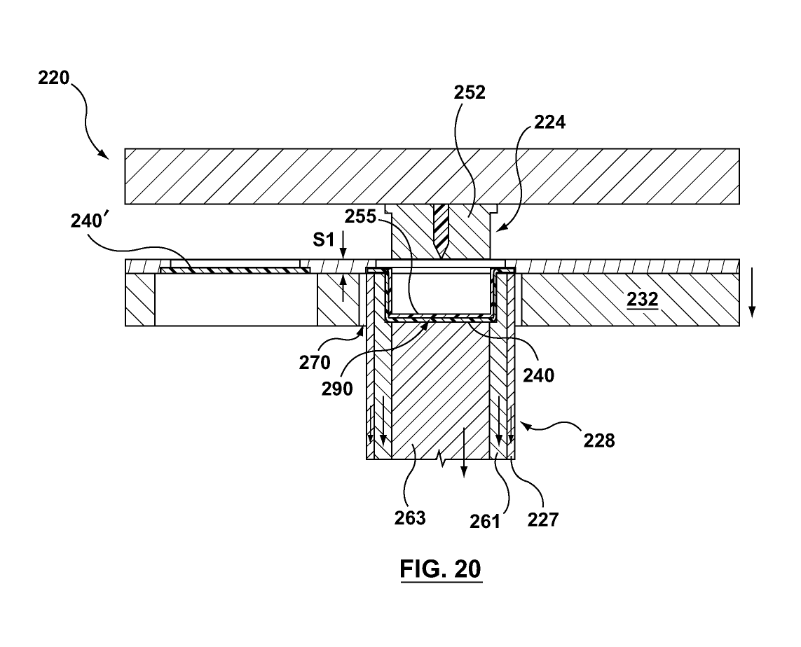

Referring to FIG. 20, continued withdrawal of the second mold stack portion 228 from the core 252 results in separation of the first and second mold stack portions 224 and 228 into the spaced relation, with separation 51 between them, as originally shown in FIG. 13 (FIG. 12, 1210). In the result, the molding cavity 244 is opened.

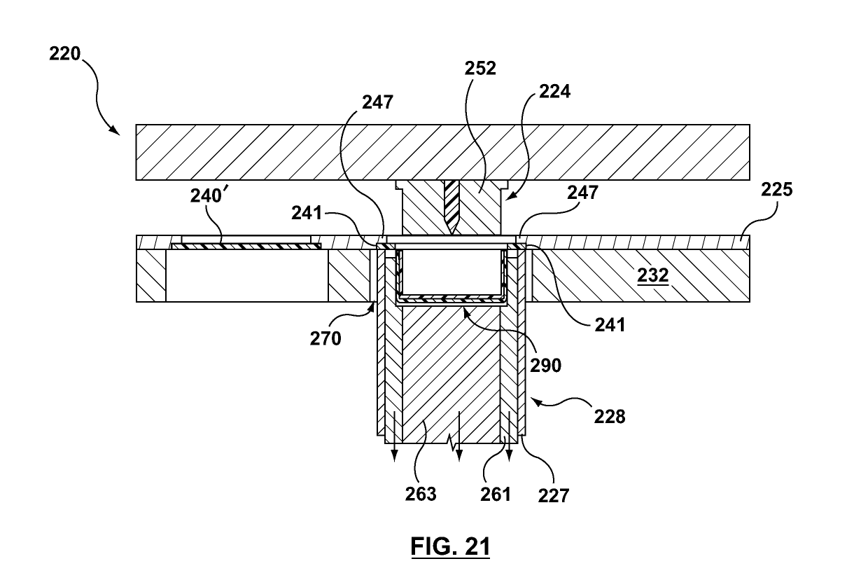

Referring to FIG. 21, at this stage retraction of the shuttle 232 and slide plate 225, as well as the pinching sleeve 227 of the second mold stack portion 228, is ceased, while retraction of the tubular portion 261 and ejector portion 263 of the second mold stack portion 228 continues along mold-stroke axis X. In the result, the portions 261 and 263 commence being withdrawn from within pinching sleeve 227. The severed peripheral border 241 of the insert 240 remains pinched between the lip 247 of tray 245 and the upper portion of the pinching sleeve 227.

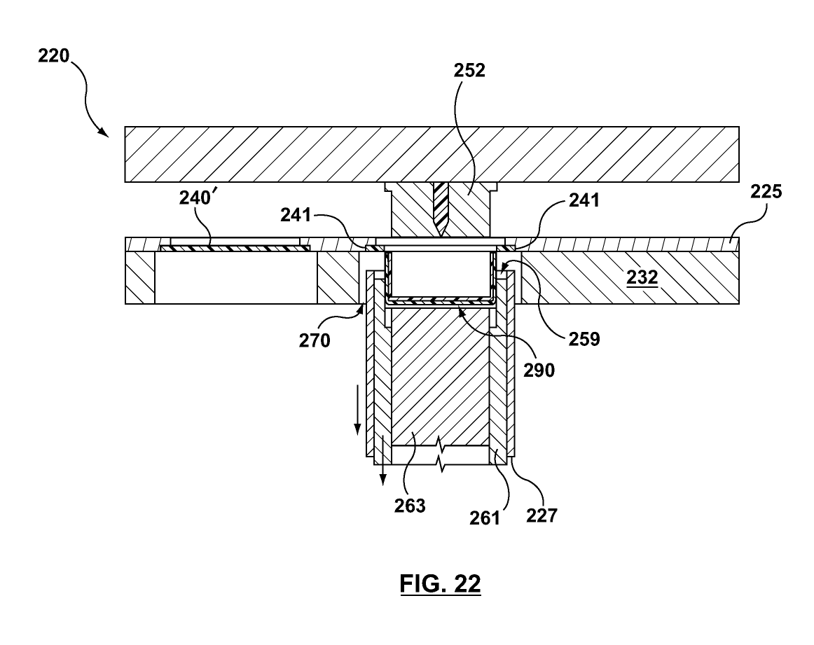

Referring to FIG. 22, retraction of the tubular portion 261 of the second mold stack portion 228 continues, and retraction of the pinching sleeve 227 of the second mold stack portion 228 to commences, along mold-stroke axis X. Meanwhile, retraction of ejector portion 263 of the second mold stack portion 228 is ceased. The continued retraction of the tubular portion 263 about the now stationary ejector portion 261 causes the ejector portion 263 to commence stripping the molded article 290 from the tubular portion 261. That is to say, as the tubular portion 263 retracts about the ejector portion 263, ejection of the molded article 290 incorporating insert 240 from the second mold stack portion 228, within the shuttle aperture 270, is commenced (FIG. 12, 1212). Meanwhile, withdrawal of the pinching sleeve 227 from the now-stationary slide tray 225 releases the severed peripheral border 241 of the insert 240, i.e. causes the severed border 241 to no longer be pinched.

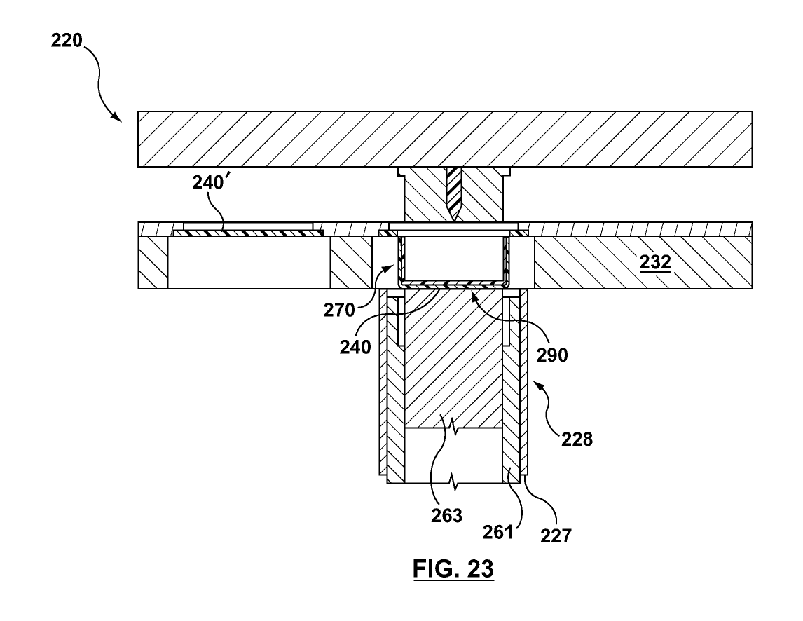

Referring to FIG. 23, the tubular portion 261 and pinching sleeve 227 are completely withdrawn from the shuttle aperture 270. The stationary ejector portion 263, about which the tubular portion 261 and pinching sleeve 227 are withdrawn, serves to fully strip the molded article 290 from the second mold stack portion 228 and thereby eject the molded article 290 and incorporated insert 240 within shuttle aperture 270. The second mold stack portion 228 is thus fully withdrawn from the shuttle aperture 270, leaving the molded article 290 incorporating the insert 240 within the shuttle aperture 270.

Referring to FIG. 24, the insert feeder mechanism 242 translates the slide plate 225 (to the right in FIG. 24) so that tray 245, carrying a newly loaded insert 240′ for use in the subsequent molding cycle, is moved from outboard position 253 towards the first and second mold stack portions 224 and 228, while at the same time the leftover border portion 241 that was cut away from the previous insert 240 is carried, by tray 243, towards the other outboard position 251.

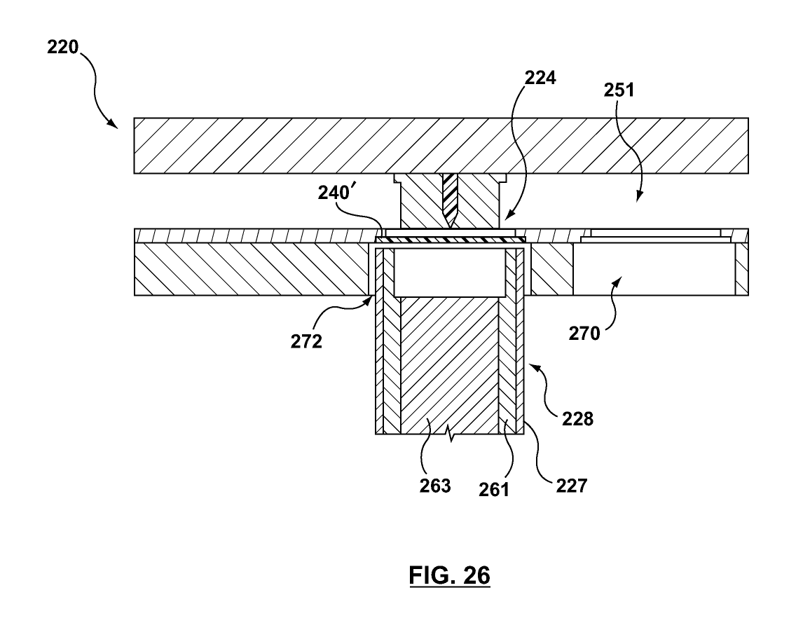

Referring to FIG. 25, the shuttle 232 is then moved by actuator 268 (see FIG. 13) so as to align the first shuttle aperture 270 with a transfer structure (not expressly illustrated) near outboard position 251 for transfer of the molded article 290 incorporating the insert 240 from the injection molding system 200 (FIG. 12, 1214). This results in alignment of the second shuttle aperture 272 with the first and second mold stack portions 224 and 228. The second mold stack portion 228 is then moved by actuators 276, 277 and 285 (see FIG. 13) so that it is substantially accommodated within in the second shuttle aperture 272, in preparation for a subsequent molding cycle, as shown in FIG. 26. Meanwhile, the molded article 290 has been transferred from the first shuttle aperture 270 and out of the injection molding system 200. Operation 1200 is thus concluded.

In an alternative embodiment, the inserts 240, 240′ may not take the form of pre-cut slugs or discs that are loose, but rather may be carried on a ribbon of carrier material (e.g. acetate) using a supply reel and take-up reel similar to what is shown in the embodiment of FIGS. 1-11.

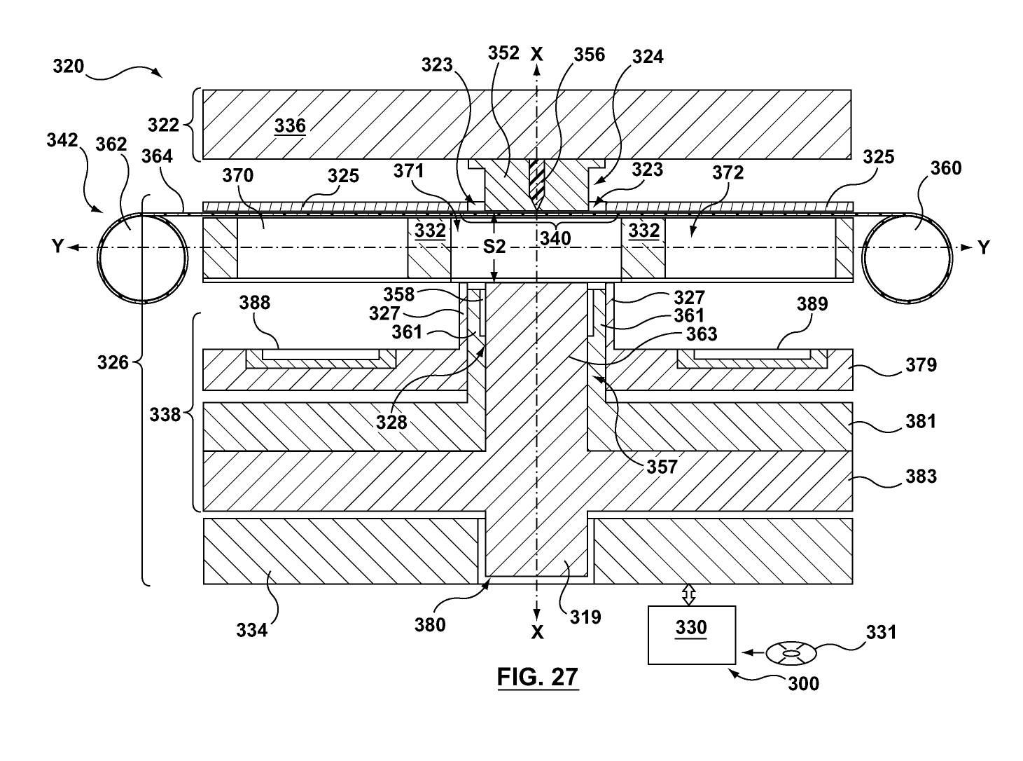

FIG. 27 illustrates a schematic representation of a non-limiting, alternative embodiment of an injection molding system for molding articles, which are container closures in the present example, with incorporated inserts. The illustrated embodiment system 300 differs from system 200 of FIGS. 13-26 in several respects. Firstly, the inserts do not take the form of pre-cut slugs or discs that are loose, but rather are punched from a ribbon of material delivered by a supply reel and take-up reel, similar to the mechanism shown in the embodiment of FIGS. 1-11. Secondly, the system 300 incorporates heating elements for heating the material from which the inserts are punched prior to their incorporation into molded articles. Thirdly, the system 300 is designed to clamp a portion of the insert—in this case, the portion of the insert that will be incorporated into the top of the container closure—during stretching of the insert within the mold cavity prior to molding material injection. As will be appreciated, this clamping may limit the degree to which the clamped (top) portion of the insert stretches during the insert stretching phase of injection molding while allowing a remainder (skirt) portion of the insert to be stretched. This may for example be used to allow stretching of the skirt portion to be performed without stretching, and thereby distorting, graphics and/or text that may form part of (e.g. may be printed on) the clamped portion of the insert. The conventions used in FIG. 27 are the same as those used in FIG. 13, although the various actuators that are used to drive system components, as described below, are omitted. The system 300 comprises an injection mold 320 and a controller 330.

The injection mold 320 includes a first mold half 322 and a second mold half 326. The first mold half 322 comprises a first mold shoe 336 and a first mold stack portion 324 associated therewith. The second mold half 326 comprises a second mold shoe 338 and a second mold stack portion 328 associated therewith. The second mold shoe and second mold stack portion 328 may be contained within an ejector box (not illustrated) which may be similar to what is shown in FIG. 13 for example. The second mold half 326 also comprises a shuttle 332 and an in-mold shutter 334, which may also be also contained within the same ejector box. In addition, the second mold half 322 comprises a set of plates 379, 381 and 383 (collectively comprising the second mold shoe 338) that are used to drive a pinching sleeve 327, a tubular portion 361 and a cylindrical portion 363, respectively, of the second mold stack portion 328. All of these components will be described in more detail below.

FIG. 27 illustrates the mold 320 in the mold-closed configuration, in which the mold halves 322 and 326 are substantially adjacent to one another. Use of the shuttle 332 as described below allows the mold halves 322 and 326 to remain in the mold-closed configuration while completed (molded) articles with incorporated inserts are ejected from the injection mold 320 to a transfer structure (not expressly illustrated). This may again promote similar benefits to those described above with respect to the earlier-described embodiments.

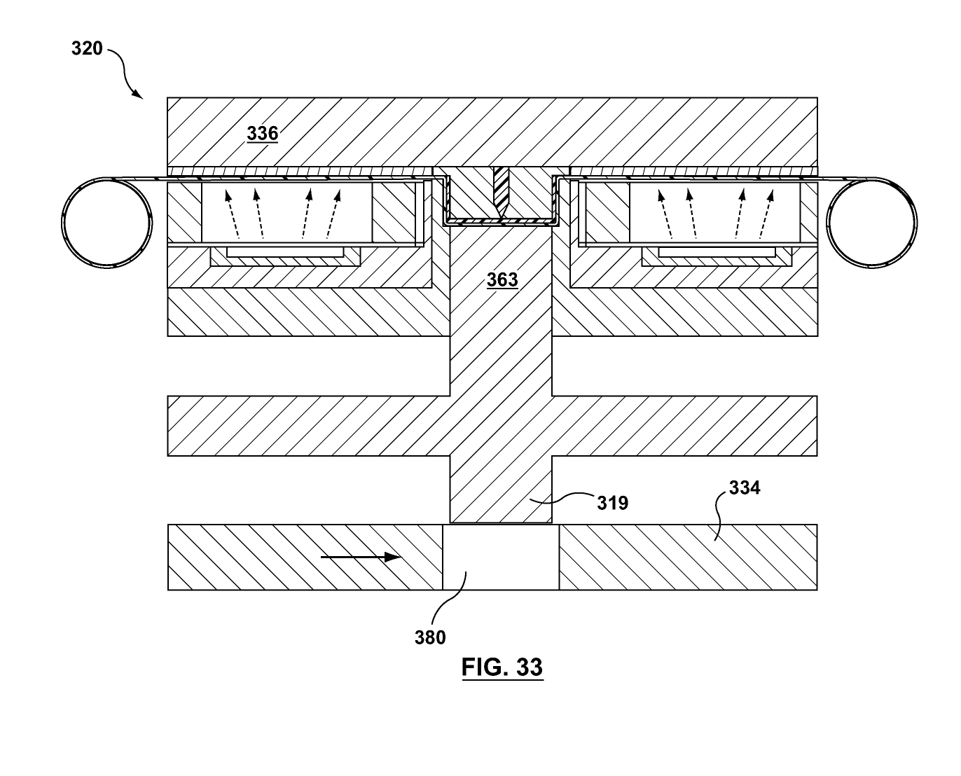

The first and second mold stack portions 324 and 328 are sub-components of the injection mold 320 that move relative to one another to alternately create a molding cavity 344 (e.g. as shown in FIG. 33) in the shape of the article to be molded and thereafter eject the molded article for transfer from the injection mold 320. The relative movement of the first and second mold stack portions 324 and 328 of FIG. 27 is along the mold-stroke axis X, between a spaced configuration and a molding configuration. In the spaced configuration, the first and second mold stack portions 324 and 328 are in a spaced relation, which is represented in FIG. 27 by the separation between them denoted S2. In the molding configuration, the first and second mold stack portions 324 and 328 cooperate to define a molding cavity 344 therebetween having a generally U-shape in cross section (see FIG. 33).

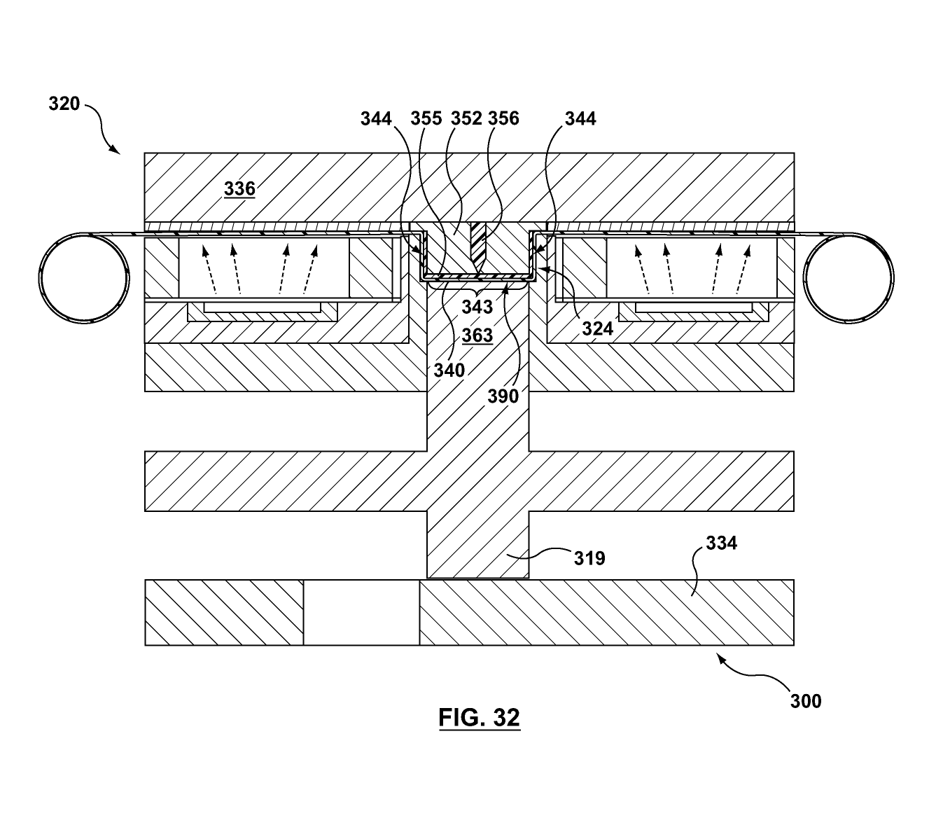

As illustrated in FIG. 27, the first mold stack portion 324 comprises a unitary core 352. The core 352 remains stationary during molding operation in this embodiment by virtue of being fixedly connected or mounted to the first mold shoe 336, which also remains stationary during molding. The core 352 has a nozzle 356 for injecting molding material into the molding cavity 344 (FIG. 32). Situating the nozzle 356 within the core 352 facilitates incorporation of an insert with an exterior surface of the molded article. In alternative embodiments, the nozzle may be situated elsewhere (e.g. in the second mold stack portion 328) if it is desired to incorporate the insert elsewhere within the molded article (e.g. on an interior surface of the article).

The second mold stack portion 328 of the embodiment shown in FIG. 27 comprises a tubular portion 361 that defines the exterior surface of the skirt of the container closure to be molded and a cylindrical portion 363 that defines the exterior surface of the top of the container closure to be molded. When suitably aligned with respect to one another (e.g. as in FIG. 33), the tubular and cylindrical portions 361 and 363 collectively define the mold cavity 358 that defines the exterior surface of the container closure that is to be molded. The cylindrical portion 363 is slidable within the tubular portion 361 to facilitate ejection of a molded article from the cavity 358, as will be described. By virtue of that fact, the cylindrical portion 363 may alternatively be referred to as ejector portion 363. The second mold stack portion 328 of the present embodiment further comprises a surrounding pinching sleeve 327 that is slidable, in the mold-stroke axis X direction, relative to the tubular portion 361. As will be appreciated, the pinching sleeve will hold (or will at least help to hold) an insert in place as the insert is stretched by way of relative movement between the first and second mold stack portions 324 and 328.

Relative movement of the second mold stack portion 328 along the mold-stroke axis X, in relation to the first mold stack portion 324, is achieved in the present embodiment by way of actuators (not expressly illustrated) under control of controller 330. Separate actuators may be used to drive each of three separate plates 383, 381 and 379 that comprise the second mold shoe 338 independently of one another. A further actuator (also not illustrated) may be used for moving shuttle 332, independently of plates 383, 381 and 379, in the mold-stroke axis X direction. These actuators may for example be hydraulic actuators, pneumatic actuators, electro-mechanical actuators, or the like, or combinations of these.

In addition to being movable in the mold-stroke axis X direction, the shuttle 332 is also movable along a shuttling axis Y that is generally perpendicular to mold-stroke axis X in the illustrated embodiment. Reciprocating motion of the shuttle 332 along shuttling axis Y in the present embodiment, as will be described subsequently, may be facilitated by a separate actuator (also not illustrated) under control of controller 330.

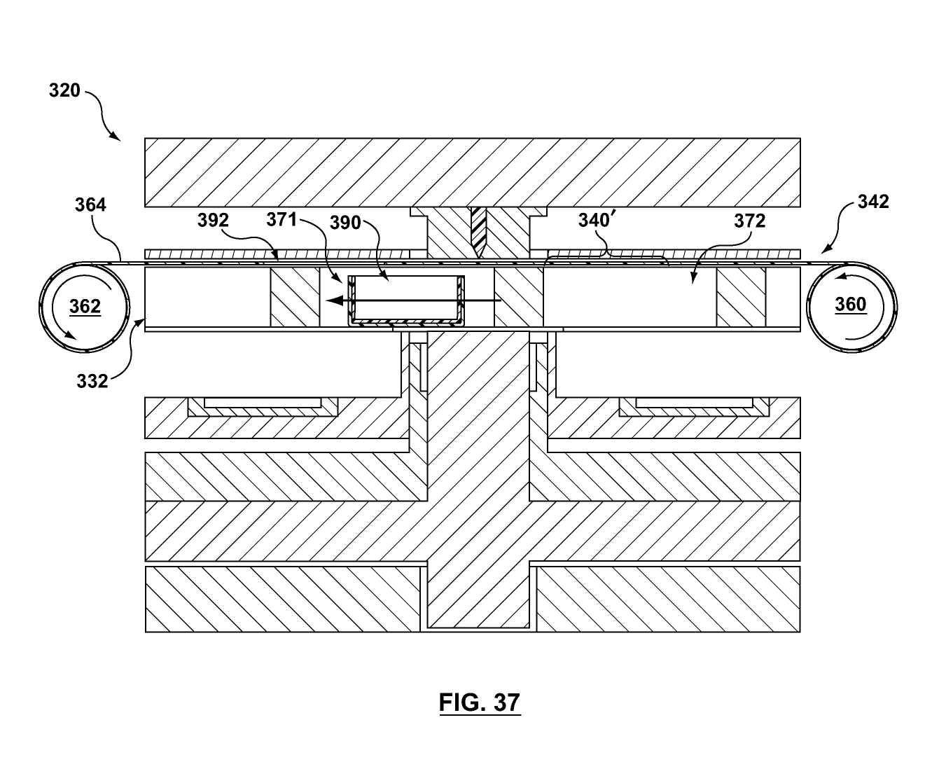

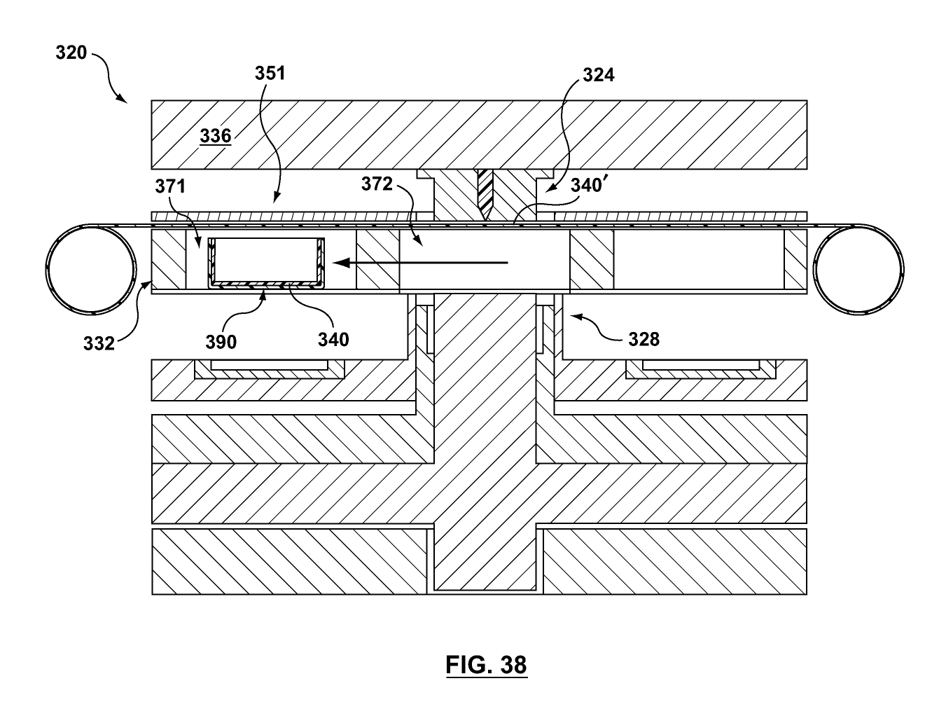

The shuttle 332 has three apertures 370, 371 and 372. In FIG. 27, the middle aperture 371 is aligned (vertically in FIG. 27) with the first and second mold stack portions 324 and 328. In a subsequent cycle, the third aperture 372 will become so aligned. While not shown, the further aperture 372 may be cyclically positioned into alignment with a further mold stack (not shown) for transferring a molded article therefrom. During operation of the system 300, the aperture 371 will alternately substantially accommodate: (a) the first and second mold stack portions 324 and 328, when the portions 324 and 328 are in the molding configuration—see e.g. FIGS. 32-33; and (b) the molded article 390 incorporating the insert 340, upon withdrawal of the first and second mold stack portions 324 and 328 from the aperture 371, for shuttling and transfer of the molded article 390 out of the injection mold 320, as shown in FIGS. 37 and 38 for example.

The side of plate 379 that faces the shuttle 332 has two heating elements 388 and 389 mounted or attached thereto. In FIG. 27, the first heating element 388 is aligned with the first shuttle aperture 370 and the second heating element 389 is aligned with the third shuttle aperture 372. These heating elements will be used to heat inserts prior to their stretching and incorporation into molded articles, as described below. The heating may facilitate stretching of certain insert materials, such as, for example, PVC, Nylon, PETG and EVA. The foregoing materials are described in detail with reference to U.S. Pat. No. 5,232,754 (Waugh; published on Aug. 3, 1993).

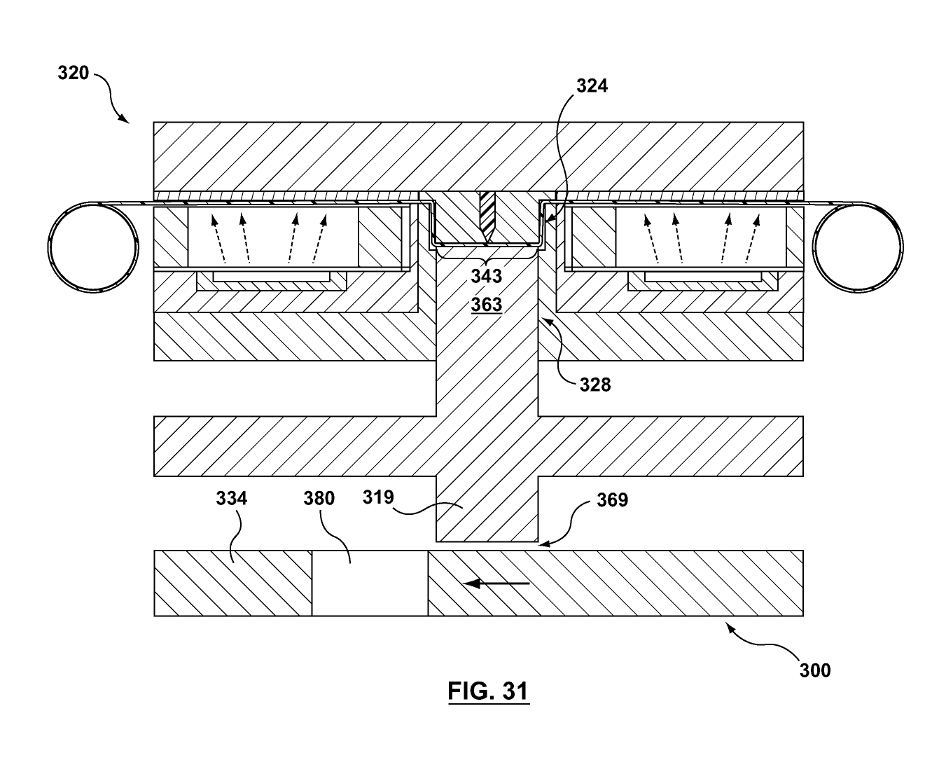

Referring again to FIG. 27, the in-mold shutter 334 (or simply “shutter” 334) facilitates positioning of the ejector portion 363 of the second mold stack portion 328 in either a spaced configuration, as shown in FIG. 27 for example, or a molding configuration, as shown in FIG. 33 for example, without requiring the mold halves 322 and 326 to be moved from the mold-closed configuration that is represented, e.g., in FIG. 27. The shutter 334 is reciprocable in a direction that is substantially parallel to the shuttling axis Y, between an open or “unlocked” position (as shown in FIG. 27) and a shut or “locked” position (as in FIG. 31).

In the open position, a shutter aperture 380 within shutter 334 becomes aligned with a lower end 319 of the second mold stack portion 328 (and in particular, of the ejector portion 363 thereof), so that the end 319 can become accommodated within the aperture 380, as shown in FIG. 27 for example. This permits withdrawal of the opposite end of ejector portion 363 from the shuttle aperture 370 when the shuttle 332 is positioned as shown in FIG. 27. That is, the ejector portion 363 of mold insert 357 is movable in a direction away from the first mold half 322 (i.e. downwardly in FIG. 27), e.g. through actuation by an actuator (not shown) under control of controller 330.

Conversely, in the shut or “locked” position, the shutter aperture 380 is laterally offset from the lower end 319 of the second mold stack portion 328, as shown in FIGS. 31 and 32 for example. Movement of the shutter 334 from the open position to the closed position is performed with the lower end 319 of the second mold stack portion 328 being withdrawn from the shutter aperture 380.

When the in-mold shutter 334 is in the shut position, the shutter 334 blocks movement of the second mold stack portion 328 in a direction away from the first mold half 322 (i.e. downwardly in FIG. 27). As in the earlier-described embodiments, this blocking may for example entail abutment of a lower portion of the second mold stack portion against the shutter. The blocking prevents the opposite end of ejector portion 363 from being withdrawn from within the shuttle aperture 370 during injection molding.

In this way, the shutter 334 facilitates the alternating relative positioning of the first and second mold stack portions 324 and 328 in the spaced configuration and the molding configuration, without requiring the first and second mold halves 322 and 326 to be adjusted from their mold-closed configuration.

Reciprocating movement of the shutter 334 between the open and shut positions may be achieved by way of an actuator (not illustrated), such as, for example, a hydraulic actuator, a pneumatic actuator, an electro-mechanical actuator, or the like, under control of controller 330.

The insert feeder mechanism 342 of the present embodiment is similar to that of the first described embodiment of the present disclosure. It comprises a slide plate 325, a supply reel 360 and a take-up reel 362. The reels 360 and 362 are operable to advance a ribbon 364 comprising the insert 340 between the first and second mold stack portions 324 and 328. In particular, the mechanism 342 turns the reels 360 and 362 to dispose a portion of the ribbon 364, which portion will comprise the insert 340, between an opening 323 in the slide plate 325 and the shuttle aperture that is currently aligned with the first and second mold stack portions 324 and 328. The insert may then be severed (e.g. punched) from the ribbon 364 and introduced into the molding cavity 358, for incorporation into the molded article, in the manner described below. When the first and second mold stack portions 324 and 328 are separated into spaced relation S2 for ejection of molded article, the mechanism 342 advances the ribbon 364 to align a new insert 340′ between the first and second mold stack portion 324 and 328 for use in the subsequent molding cycle, with a cutout portion of ribbon 364 from the severing of the previous insert 340 being conveyed towards the take-up reel 362. The insert feeder mechanism is controlled by controller 330.

The controller 330 is a programmable logic controller or other form of processor that controls operation of the injection molding system 300 as described herein. The controller 330 may send control signals to one or more actuators to effect movement of the associated components. In some embodiments, operation of the controller 330 may be governed by instructions, which may be loaded from a non-transitory machine-readable medium 331, that, upon execution by the controller 330, cause the controller 330 to control the operation the injection molding system 300 as described herein. The machine-readable medium 331 may be an optical disk or magnetic storage medium for example.

Example operation 1200 of the injection molding system 300 is illustrated in FIG. 12 in conjunction with FIGS. 27-38. It should be appreciated that, in FIGS. 27-38, certain component or subcomponents of the injection molding system 300 are omitted for brevity or clarity.

Initially, the injection molding system 300 is configured as shown in FIG. 27, with the first and second mold stack portions 324 and 328 being in the spaced configuration, i.e. in a spaced relation, separated by a space S2. An insert 340 is disposed between first mold stack portion 324 and second mold stack portion 328 (FIG. 12, 1202). Disposing of the insert 340 may be achieved by sending a suitable control signal to the supply reel 360 and/or take-up reel 362 to cause the insert 340 to be advanced to a position between the first and second mold stack portions 324 and 328 and stopped there. It will be appreciated that the insert 340 may be integrally formed with ribbon 364.

The shuttle 332 is positioned along the shuttling axis Y to cause the shuttle aperture 371 to align with the first and second mold stack portions 324 and 328 (FIG. 12, 1204). In FIG. 27, this alignment is already achieved from the previous molding cycle. The shutter 334 is in the open position, with the shutter aperture 380 accommodating the end 319 of the ejector portion 363 of the second mold stack portion 328.

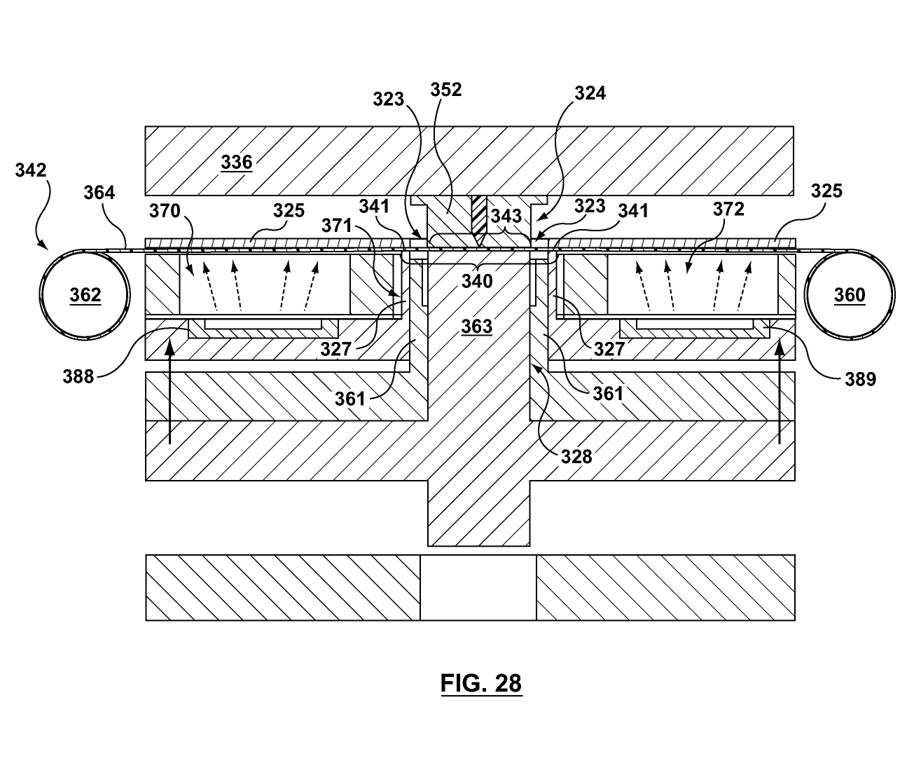

Next, at least one of the first and second mold stack portions 324, 328 is moved towards the other of the first and second mold stack portions 324, 328 into a molding configuration to define a molding cavity 344 therebetween, with the insert 340 enclosed within the molding cavity 344 (as in FIG. 33) and with the first and second mold stack portions 324 and 328 substantially accommodated within the shuttle aperture 370 (FIG. 12, 1206). In the present embodiment, operation 1206 occurs in stages, as shown in FIGS. 28-32.

Referring to FIG. 28, the second mold stack portion 328 is initially advanced through shuttle aperture 371 towards the core 352 of the first mold stack portion 324. In particular, the tubular portion 361, ejector portion 363, and pinching sleeve 327 components comprising mold stack portion 328 are moved in unison (upwardly in FIG. 28) through coordinated actuation of respective plates 383, 381 and 379. The second mold stack portion 328 is so advanced until a central portion 343 of the insert 340 is clamped between the core 352 and the ejector portion 363 of the second mold stack portion 328, and a peripheral border 341 of the insert 340 is clamped between the pinching sleeve 327 and the slide plate 325 immediately surrounding the opening 323.

Meanwhile, heating elements 388 and 389, which may be infrared heating elements for example, are activated and begin to heat the portions of the ribbon 364 that are aligned with shuttle apertures 370 and 372. Note that the portion of the ribbon 364 that will constitute insert 340 was heated by heating element 389 prior being conveyed from shuttle aperture 372 to shuttle aperture 371, while the portion of the ribbon 364 that will constitute the next insert 340′ is now being heated through aperture 372 by heating element 389. The portion of the ribbon 364 that is aligned with shuttle 372 will be aligned within a further mold stack (not shown) in the next molding cycle.

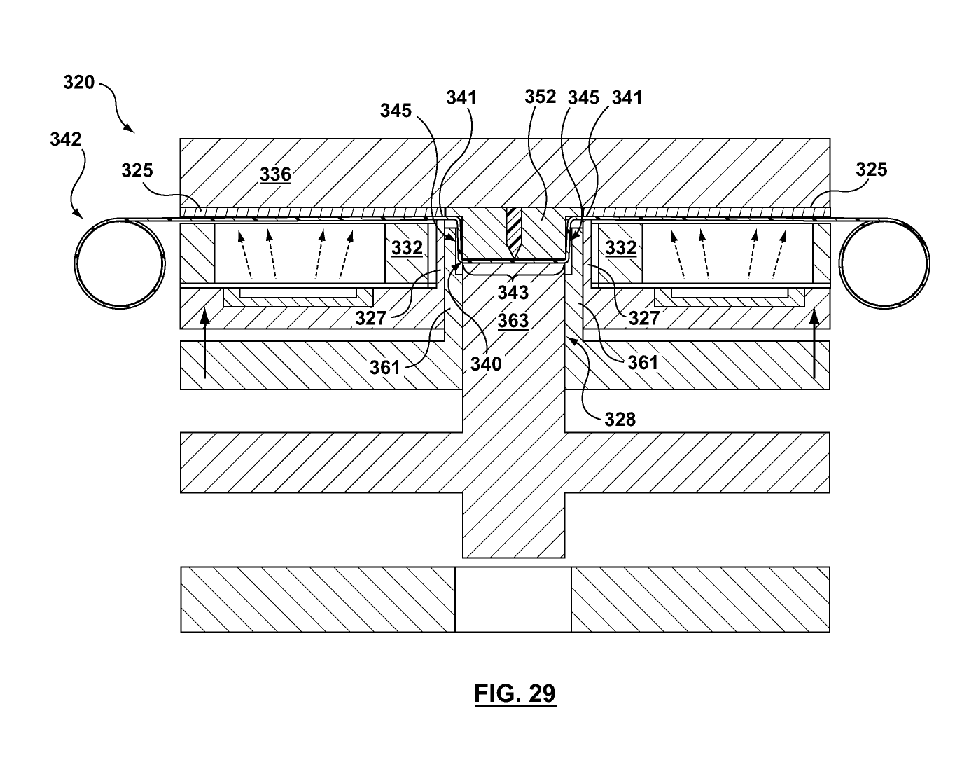

Turning to FIG. 29, once the central portion 343 of the insert 340 becomes clamped between core 352 and the ejector portion 363, movement of the ejector portion 363 ceases. Meanwhile, advancement of the tubular portion 361 and pinching sleeve 327 of the second mold stack portion 328 toward the first mold shoe 336 continues, and shuttle 332, insert feeder mechanism 342 and slide plate 325 now also commence moving, in unison with the components 361, 363 and 327 of the second mold stack portion 328.

Because the peripheral portion 341 of the insert 340 that is clamped between the pinching sleeve 327 and the slide plate 325 immediately surrounding the opening 323 is being moved towards the first mold shoe 336 while the central portion 343 of the insert 340 is now stationary, stretching of a skirt portion 345 of the insert 340 commences. The central portion 343 of the insert remain unstretched due to its being clamped between core 352 and ejector portion 363. This may advantageously limit distortion of any graphics and/or text that may form part of that central portion 343 in some embodiments. Such distortion could be considered undesirable as it may interfere with viewing of the graphics and/or reading of the text by a consumer for example. Stretching continues until the slide plate 325 contacts the first mold shoe 336 (as in FIG. 29), and which point movement of the slide plate 325, insert feeder mechanism 342, shuttle 332 and pinching sleeve 327 ceases.

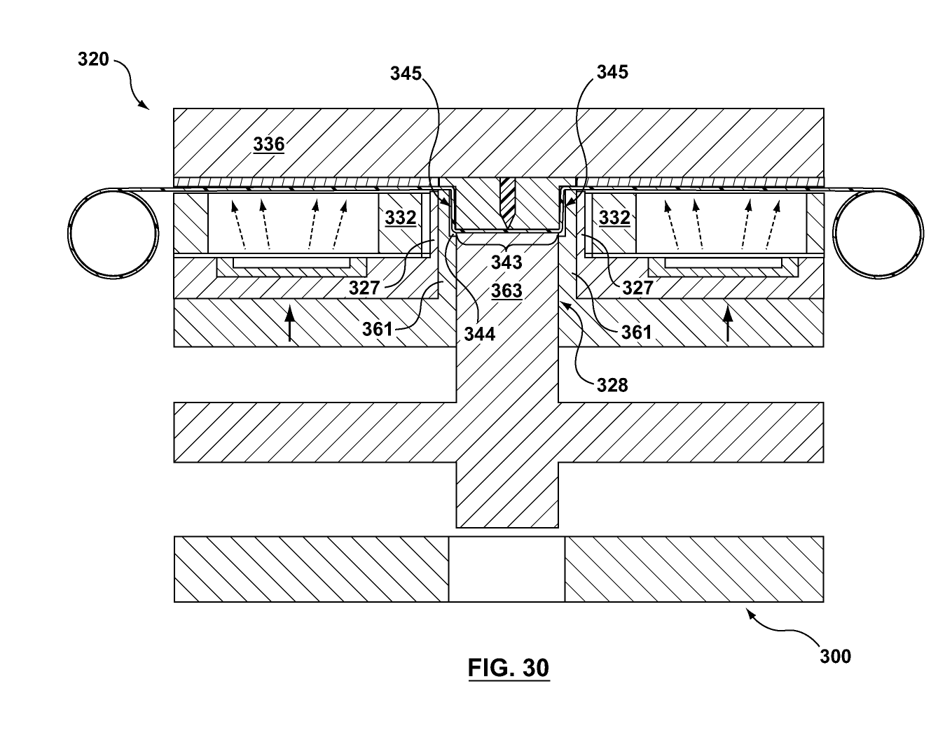

Referring to FIG. 30, the tubular portion 361 of the mold stack portion continues advancing until it reaches a limit in which the top of the tubular portion 361 aligns with the top of the pinching sleeve 327. The insert 340, whose skirt portion 345 has been stretched around sides of core 352, is now substantially enclosed within an almost fully formed molding cavity 344. The reason that the molding cavity 344 is said to almost fully formed is because the ejector portion 363 continues to clamp the central portion 343 of the insert 340 against the core 352, such that there is presently no room between the core 352 and the ejector portion 363 to receive molding material. This will be remedied by a slight retraction of the ejector portion 363 before injection molding, as described below.

Still referring to FIG. 30, the peripheral border 341 of the insert 340 is severed. Severing may be achieved using complementary cutting surfaces defined in or on the tubular portion 361 of the mold stack portion 328 and the slide tray 325. These complementary cutting surfaces are not expressly depicted in FIG. 30 but may be similar to those shown in FIG. 5 of the earlier described embodiment.

Referring to FIG. 31, at this stage the in-mold shutter 334 is placed in the shut or “locked” position with a view to blocking movement of the ejector portion 363 of the second mold stack portion 328 in a direction away from the first mold stack portion 324 (i.e. downwardly in FIG. 31) during subsequent injection molding. This may be referred to as “locking the mold.” In the embodiment illustrated in FIG. 31, locking involves translating the shuttle aperture 380 to the left. A small gap 369 between the lower end 319 of the ejector portion 363 and the shutter 334 is attributable to the fact that the slight retraction of the ejector portion 363, referenced above, has not yet occurred.

Referring to FIG. 32, the ejector portion 363 of the second mold stack portion 328 is retracted slightly away from mold shoe 336 until the lower end 319 abuts the shutter 334. As a result, the opposite end of the ejector portion 363 ceases clamping the central portion 343 of the insert 340 against the core 352. The released insert 340 accordingly has an unstretched portion 343 and a stretched skirt portion 345. The slight retraction of the ejector portion 363 completes the formation of the molding cavity 344 within which the insert 340 now resides. The cross-sectional shape of the example molding cavity 344 in FIG. 32 is generally U-shaped, consistent with the fact that the article is a closure for a container in this example. The shape of the molding cavity 344 may vary in other embodiments, depending upon the article being molded.

Thereafter, with the mold 320 clamped, molding material 355, such as, for example, melted Polypropylene, is injected into the molding cavity 344 via nozzle 356 of the core 352 of first mold stack portion 324. This results in the molding of the article 390 incorporating the insert 340 (FIG. 12, 1208). In the illustrated example, the insert 340 becomes integrally formed with the exterior surface of the article 390, because the molding material is injected from the core 352 that defines the interior surface of the article 390. This may vary in alternative embodiments.

Referring to FIG. 33, at this stage the in-mold shutter 334 is placed in the open position. This may be referred to as “unlocking the mold.” In the illustrated embodiment of FIG. 33, unlocking involves translating the shuttle aperture 380 to the right until it is aligned with the lower end 319 of the ejector portion 363. This is in preparation for withdrawal of the second mold stack portion 328, and in particular, of the ejector portion 363, from the molding configuration.

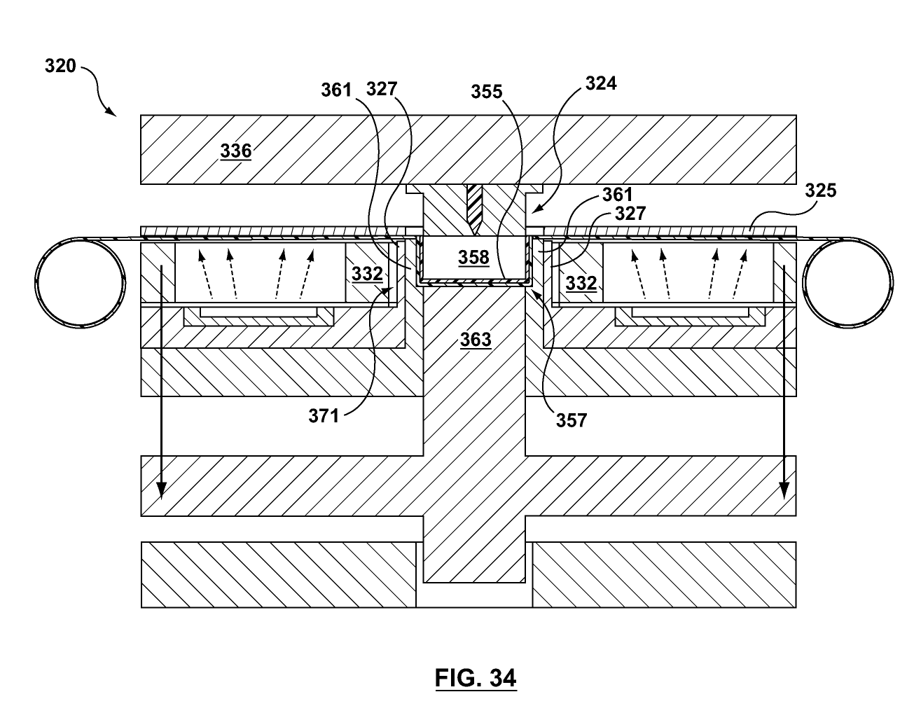

Referring to FIG. 34, the slide plate 325, shuttle 332 and second mold stack portion 328 (including the tubular portion 361, ejector portion 363 and pinching sleeve 327) are retracted in unison (downwardly in FIG. 34), so as to withdraw the shuttle aperture 371, as well as the cavity 358 of mold insert 357, from about the core 352. Retraction of the ejector portion 363 is possible in view of the above-described placement of the shutter 334 into the open position.

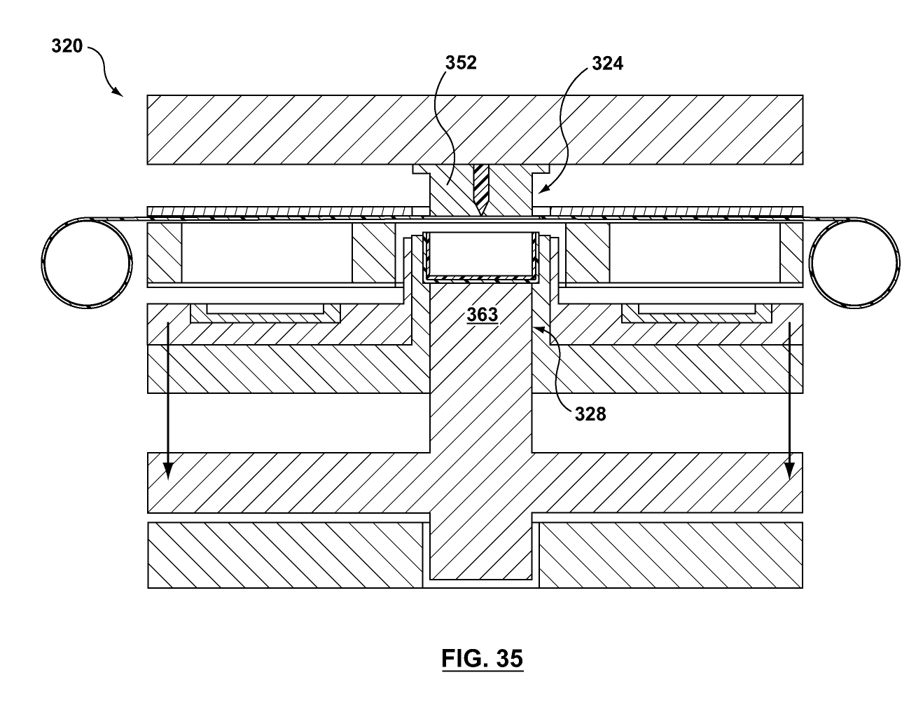

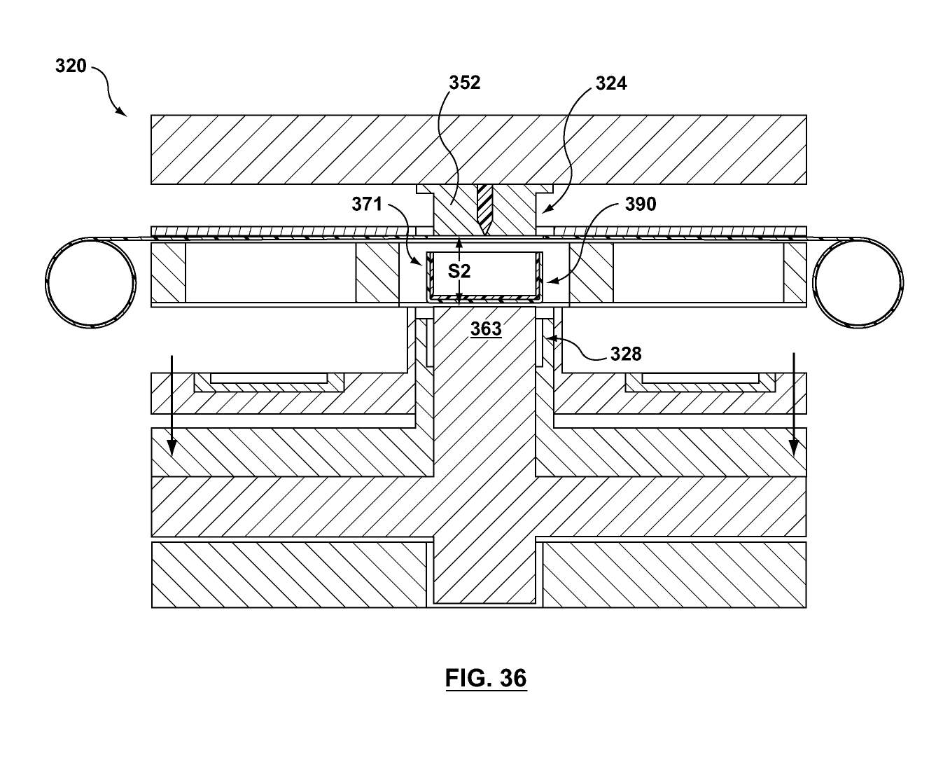

Referring to FIGS. 35 and 36, continued withdrawal of the second mold stack portion 328 from the core 352 results in separation of the first and second mold stack portions 324 and 328 into the spaced relation, with separation S2 between them (see FIG. 38), as originally shown in FIG. 27 (FIG. 12, 1210). In the result, the molding cavity 344 is opened.

More specifically, in FIG. 35, retraction of the shuttle 332 and slide plate 325, as well as the pinching sleeve 327 of the second mold stack portion 328, is ceased, while retraction of the tubular portion 361 and ejector portion 363 of the second mold stack portion 328 continues along mold-stroke axis X. In the result, withdrawal of the portions 361 and 363 from within pinching sleeve 327 is commenced.

Referring to FIG. 36, retraction of the tubular portion 361 and of the pinching sleeve 327 of the second mold stack portion 328 continues along mold-stroke axis X. Meanwhile, retraction of ejector portion 363 of the second mold stack portion 328 is ceased. The retraction of the tubular portion 363 about the now stationary ejector portion 361 causes the ejector portion 363 to strip the molded article 390 from the tubular portion 361, i.e. eject the article 390 incorporating insert 340 from the second mold stack portion 328, within the shuttle aperture 371 (FIG. 12, 1212). The second mold stack portion 328 is thus fully withdrawn from the shuttle aperture 371, leaving the molded article 390 incorporating the insert 340 within the shuttle aperture 371.

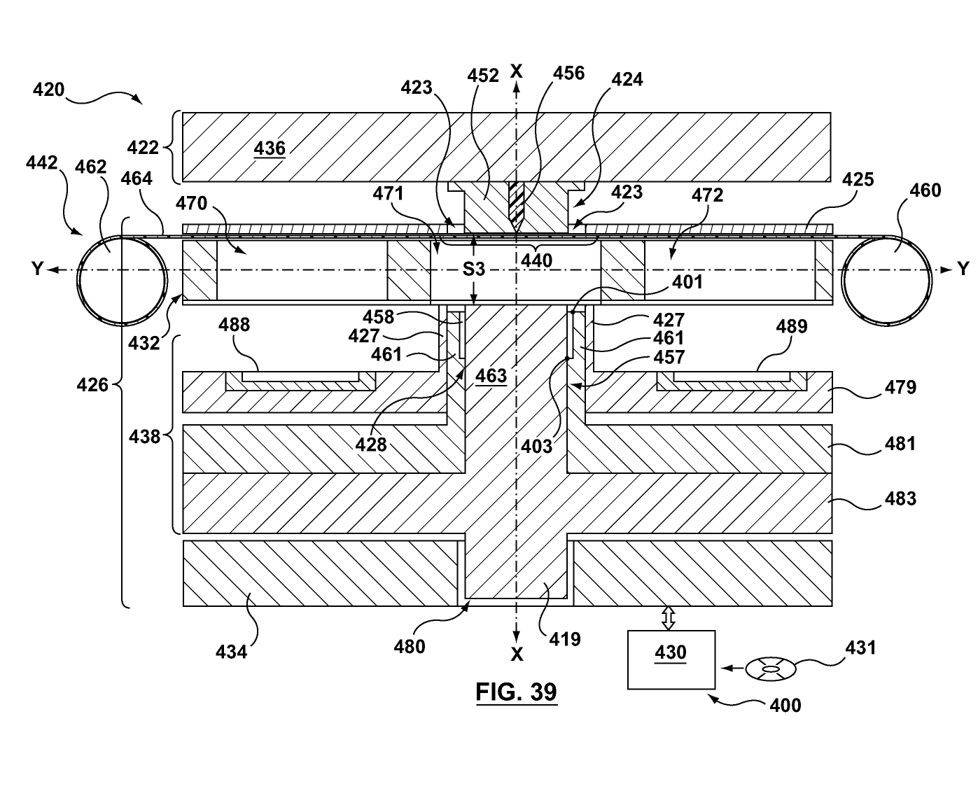

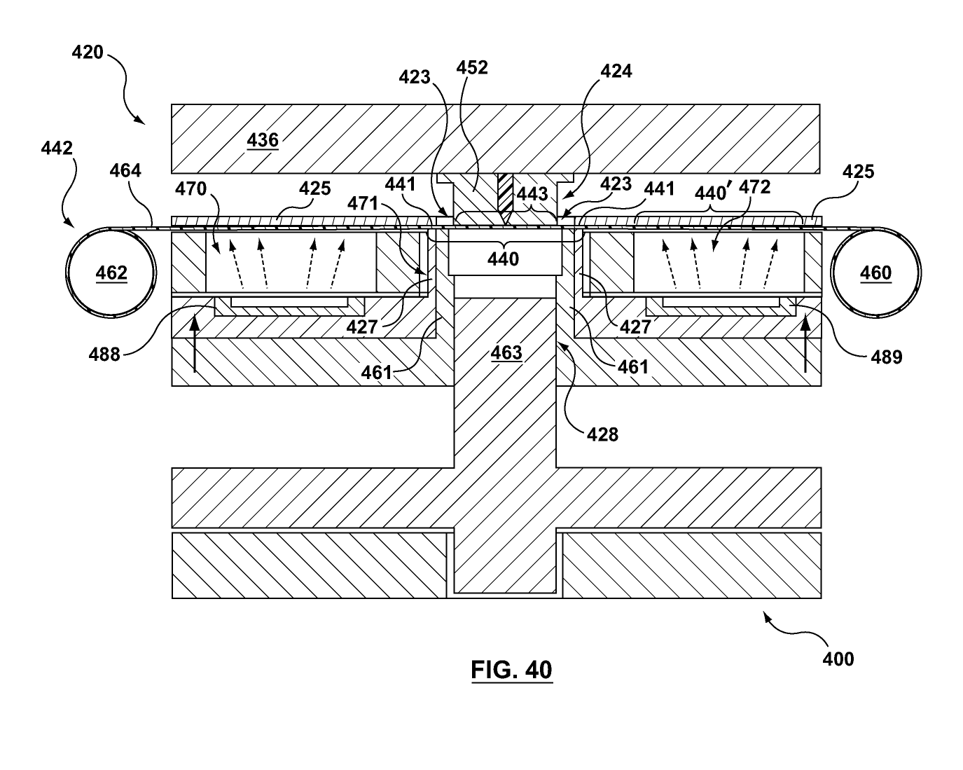

Referring to FIGS. 37 and 38, the insert feeder mechanism 342 advances the ribbon 364 to provide a new insert 340′ (FIG. 40) for use in the subsequent molding cycle, while at the same time causing cutout 392 (FIG. 39), which resulted from the punching of the previous insert 340 from ribbon 364, to be conveyed towards the take-up reel 362. The shuttle 332 is also moved so as to align the shuttle aperture 371 with a transfer structure (not expressly illustrated) near an outboard position 351 for transfer of the molded article 390 incorporating the insert 340 from the injection molding system 300 (FIG. 12, 1214), i.e. to the left in FIGS. 37 and 40. This results in alignment of the third shuttle aperture 372 with the first and second mold stack portions 324 and 328, in preparation for a subsequent molding cycle. The molded article 390 will be transferred from the first shuttle aperture 371 and out of the injection molding system 200. Operation 1200 is thus concluded.

FIG. 39 illustrates a schematic representation of a non-limiting, alternative embodiment of an injection molding system for molding articles, which are container closures in the present example, with incorporated inserts. The illustrated embodiment system 400 differs from system 300 of FIGS. 27-38 primarily in that stretching of the insert is not performed solely using the clamping approach described above, but rather is initially performed using pressurized gas and followed by the clamping approach. Moreover, the stretching of the insert is that is performed in this embodiment is substantially uniform over the entire insert rather than being limited to a skirt portion for example. The conventions used in FIG. 39 are the same as those used in FIG. 27. The system 400 comprises an injection mold 420 and a controller 430.

The injection mold 420 includes a first mold half 422 and a second mold half 426. The first mold half 422 comprises a first mold shoe 436 and a first mold stack portion 424 associated therewith. The second mold half 426 comprises a second mold shoe 438 and a second mold stack portion 428 associated therewith. The second mold shoe and second mold stack portion 428 may be contained within an ejector box (not illustrated) which may be similar to what is shown in FIG. 13 for example. The second mold half 426 also comprises a shuttle 432 and an in-mold shutter 434, which may also be also contained within the same ejector box. In addition, the second mold half 422 comprises a set of plates 479, 481 and 483 (collectively comprising the second mold shoe 438) that are used to drive a pinching sleeve 427, a tubular portion 461 and a cylindrical portion 463, respectively, of the second mold stack portion 428.

FIG. 39 illustrates the mold 420 in the mold-closed configuration, in which the mold halves 422 and 426 are substantially adjacent to one another. Use of the shuttle 432 as described below allows the mold halves 422 and 426 to remain in the mold-closed configuration while completed (molded) articles with incorporated inserts are ejected from the injection mold 420 to a transfer structure (not expressly illustrated). This may again promote similar benefits to those described above with respect to the earlier-described embodiments.

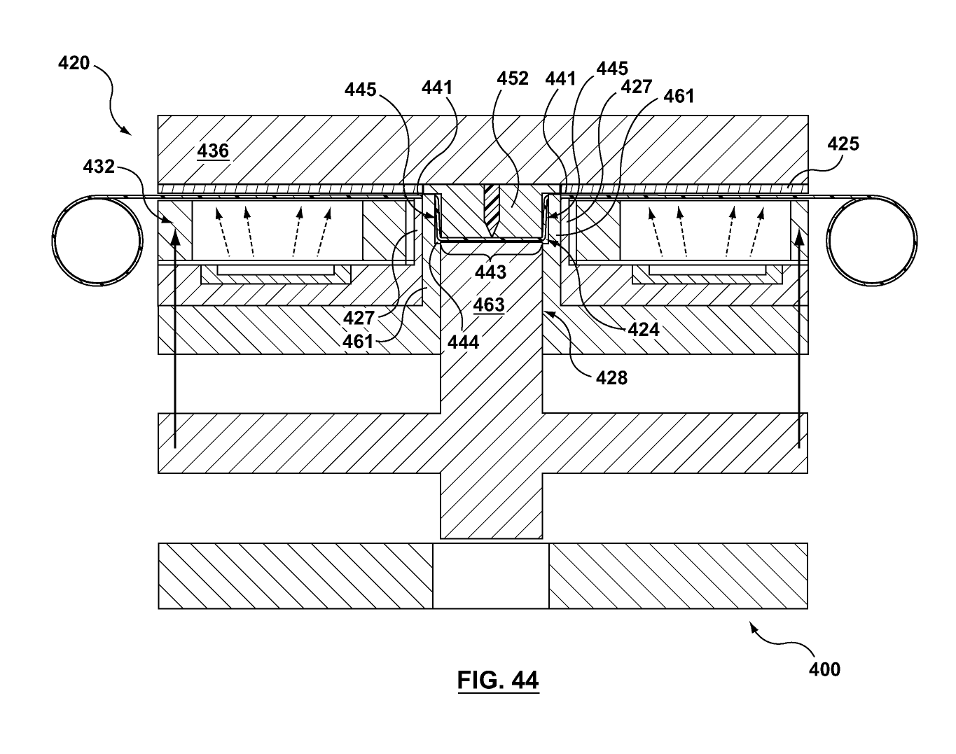

The first and second mold stack portions 424 and 428 are sub-components of the injection mold 420 that move relative to one another to alternately create a molding cavity 444 (e.g. as shown in FIG. 44) in the shape of the article to be molded and thereafter eject the molded article for transfer from the injection mold 420. The relative movement of the first and second mold stack portions 424 and 428 of FIG. 39 is along the mold-stroke axis X, between a spaced configuration and a molding configuration. In the spaced configuration, the first and second mold stack portions 424 and 428 are in a spaced relation, which is represented in FIG. 39 by the separation between them denoted S3. In the molding configuration, the first and second mold stack portions 424 and 428 cooperate to define a molding cavity 444 therebetween having a generally U-shape in cross section (see FIG. 44).

As illustrated in FIG. 39, the first mold stack portion 424 comprises a unitary core 452. The core 452 remains stationary during molding operation in this embodiment by virtue of being fixedly connected or mounted to the first mold shoe 436, which also remains stationary during molding. The core 452 has a nozzle 456 for injecting molding material into the molding cavity 444 (FIG. 44). Situating the nozzle 456 within the core 452 facilitates incorporation of an insert with an exterior surface of the molded article. In alternative embodiments, the nozzle may be situated elsewhere (e.g. in the second mold stack portion 428) if it is desired to incorporate the insert elsewhere within the molded article (e.g. on an interior surface of the article).

The second mold stack portion 428 of the embodiment shown in FIG. 39 comprises a tubular portion 461 that defines the exterior surface of the skirt of the container closure to be molded and a cylindrical portion 463 that defines the exterior surface of the top of the container closure to be molded. When suitably aligned with respect to one another (e.g. as in FIG. 44), the tubular and cylindrical portions 461 and 463 collectively define the mold cavity 458 that defines the exterior surface of the container closure that is to be molded. Unlike the tubular portion 361 of the previous embodiment, the tubular portion 461 of the present embodiment comprises a blowing orifice 401 for introducing pressurized gas into the mold cavity 458 and a vacuum orifice 403 for evacuating gas from the mold cavity 458.

The cylindrical portion 463 is slidable within the tubular portion 461 to facilitate ejection of a molded article from the cavity 458, as will be described. By virtue of that fact, the cylindrical portion 463 may alternatively be referred to as ejector portion 463. The second mold stack portion 428 of the present embodiment further comprises a surrounding pinching sleeve 427 that is slidable, in the mold-stroke axis X direction, relative to the tubular portion 461. As will be appreciated, the pinching sleeve will hold (or will at least help to hold) an insert in place as the insert is stretched by way of relative movement between the first and second mold stack portions 424 and 428.

Relative movement of the second mold stack portion 428 along the mold-stroke axis X, in relation to the first mold stack portion 424, is achieved in the present embodiment by way of actuators (not expressly illustrated) under control of controller 430. Separate actuators may be used to drive each of three separate plates 483, 481 and 479 that comprise the second mold shoe 438 independently of one another. A further actuator (also not illustrated) may be used for moving shuttle 432, independently of plates 483, 481 and 479, in the mold-stroke axis X direction. These actuators may for example be hydraulic actuators, pneumatic actuators, electro-mechanical actuators, or the like, or combinations of these.

In addition to being movable in the mold-stroke axis X direction, the shuttle 432 is also movable along a shuttling axis Y that is generally perpendicular to mold-stroke axis X in the illustrated embodiment. Reciprocating motion of the shuttle 432 along shuttling axis Y in the present embodiment, as will be described subsequently, may be facilitated by a separate actuator (also not illustrated) under control of controller 430.

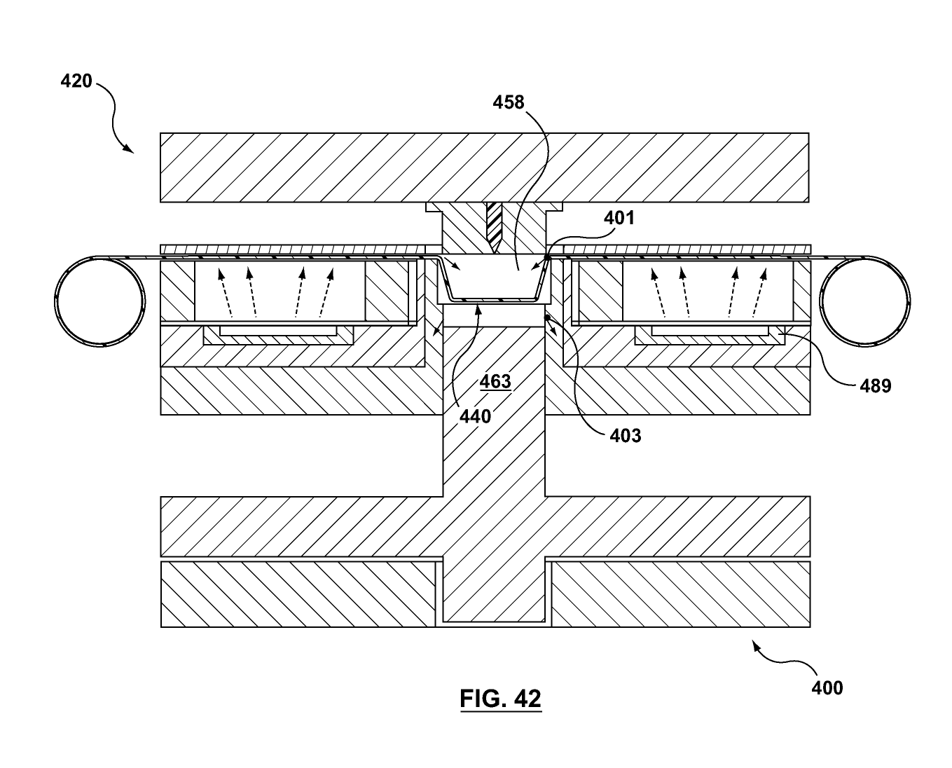

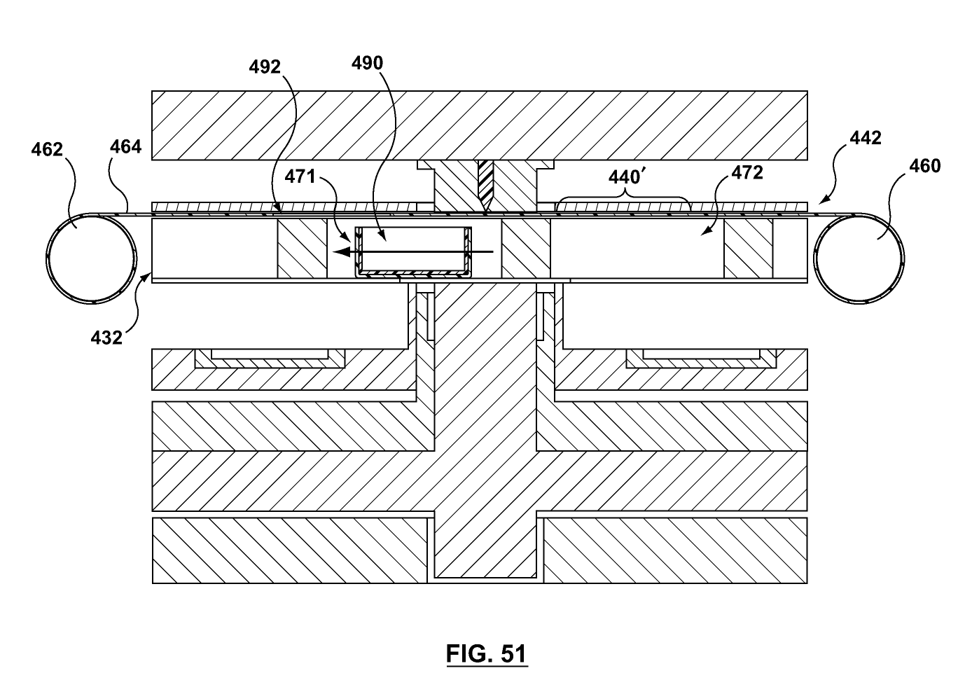

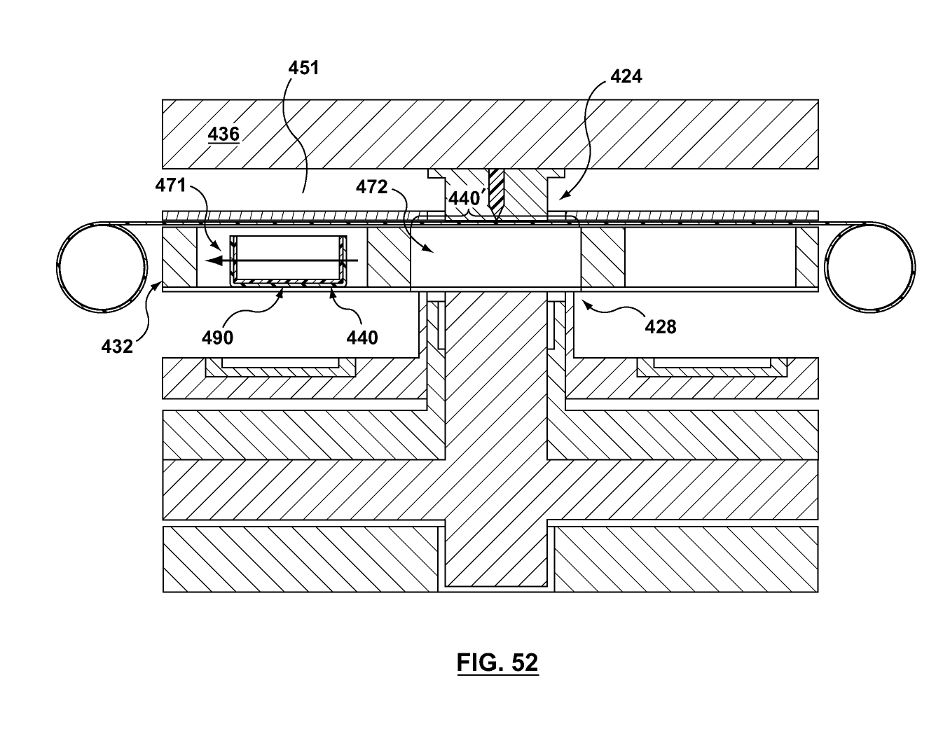

The shuttle 432 has three apertures 470, 471 and 472. In FIG. 40, the middle aperture 471 is aligned (vertically in FIG. 40) with the first and second mold stack portions 424 and 428. In a subsequent cycle, the third aperture 472 will become so aligned (see FIG. 52). During operation of the system 400, the aperture 471 will alternately substantially accommodate: (a) the first and second mold stack portions 424 and 428, when the portions 424 and 428 are in the molding configuration—see e.g. FIGS. 40-49; and (b) the molded article 490 incorporating the insert 440, upon withdrawal of the first and second mold stack portions 424 and 428 from the aperture 471, for shuttling and transfer of the molded article 490 out of the injection mold 420, as shown in FIGS. 51 and 52 for example.

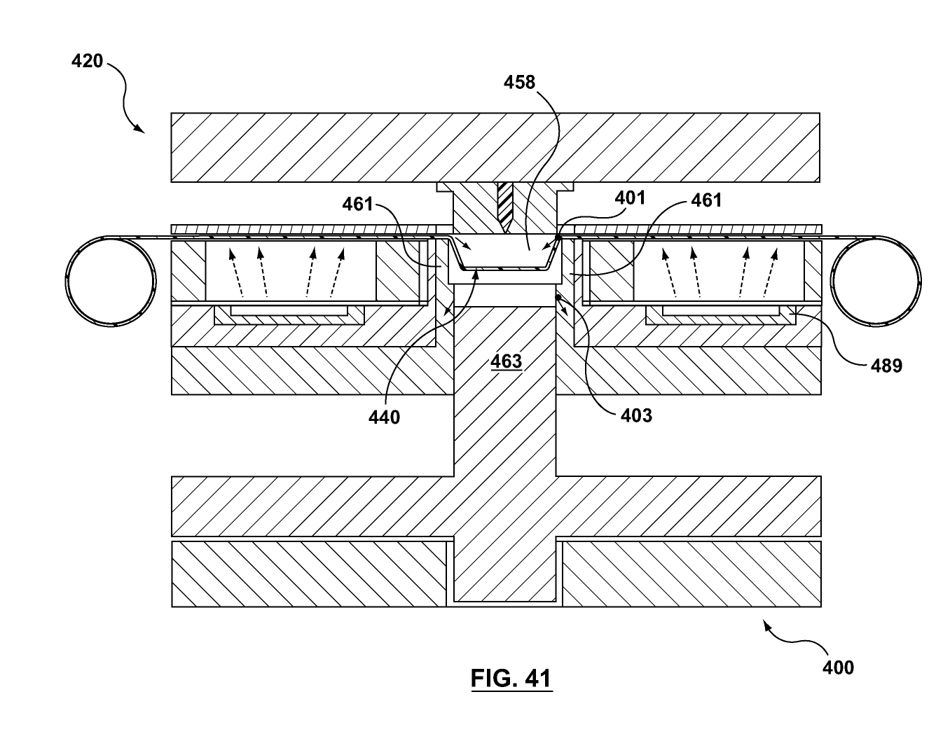

The side of plate 479 that faces the shuttle 432 has two heating elements 488 and 489 mounted or attached thereto. In FIGS. 40 and 41, the first heating element 488 is aligned with the first shuttle aperture 470 and the second heating element 489 is aligned with the third shuttle aperture 472. These heating elements will be used to heat inserts prior to their stretching and incorporation into molded articles, as described below. The heating may facilitate the stretching of certain insert materials.

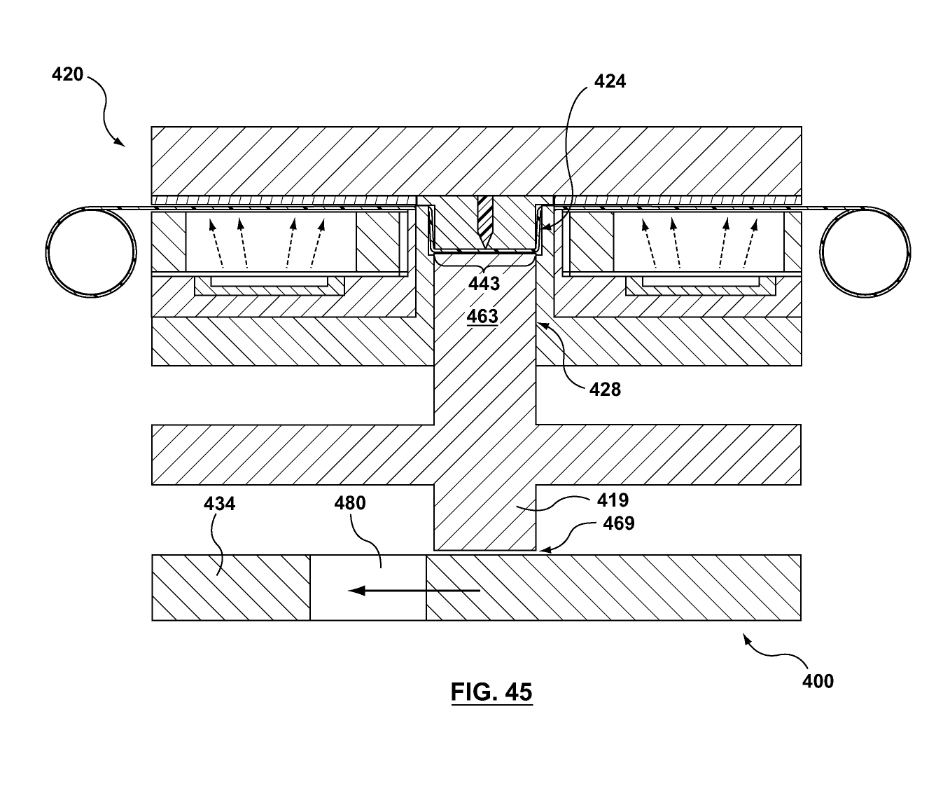

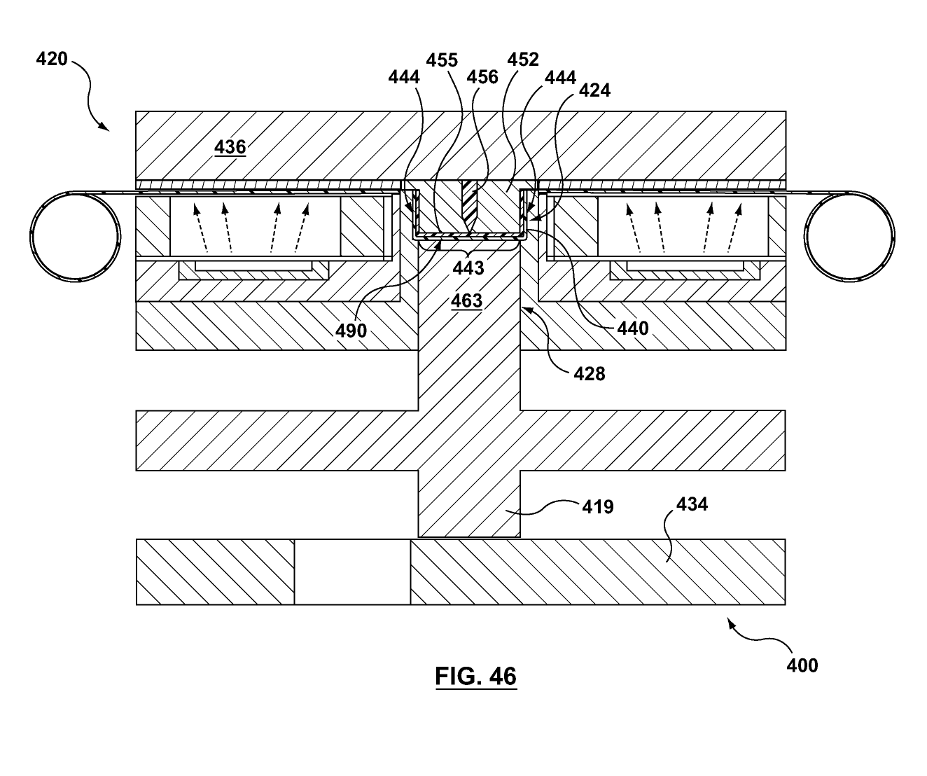

Referring again to FIG. 41, the in-mold shutter 434 (or simply “shutter” 434) facilitates positioning of the ejector portion 463 of the second mold stack portion 428 in either a spaced configuration, as shown in FIG. 39 for example, or a molding configuration, as shown in FIG. 46 for example, without requiring the mold halves 422 and 426 to be moved from the mold-closed configuration that is represented, e.g., in FIG. 41. The shutter 334 is reciprocable in a direction that is substantially parallel to the shuttling axis Y, between an open or “unlocked” position (as shown in FIG. 41) and a shut or “locked” position (as in FIGS. 45-46).

In the open position, a shutter aperture 480 within shutter 434 becomes aligned with a lower end 419 of the second mold stack portion 428 (and in particular, of the ejector portion 463 thereof), so that the end 419 can become accommodated within the aperture 480, as shown in FIG. 39 for example.

Conversely, in the shut or “locked” position, the shutter aperture 480 is laterally offset from the lower end 419 of the second mold stack portion 428, as shown in FIGS. 45 to 46 for example. When the in-mold shutter 434 is in the shut position, the shutter 434 blocks movement of the second mold stack portion 428 in a direction away from the first mold half 422 (i.e. downwardly in FIG. 46).

In this way, the shutter 434 facilitates the alternating relative positioning of the first and second mold stack portions 424 and 428 in the spaced configuration and the molding configuration, without requiring the first and second mold halves 422 and 426 to be adjusted from their mold-closed configuration.

Reciprocating movement of the shutter 434 between the open and shut positions may be achieved by way of an actuator (not illustrated), such as, for example, a hydraulic actuator, a pneumatic actuator, an electro-mechanical actuator, or the like, under control of controller 430.

The insert feeder mechanism 442 comprises a slide plate 425, a supply reel 460 and a take-up reel 462. The reels 460 and 462 are operable to advance a ribbon 464 comprising the insert 440 between the first and second mold stack portions 424 and 428. In particular, the mechanism 442 turns the reels 460 and 462 to dispose a portion of the ribbon 464, which portion will comprise the insert 440, between an opening 423 in the slide plate 425 and the shuttle aperture that is currently aligned with the first and second mold stack portions 424 and 428. The insert may then be severed (e.g. punched) from the ribbon 464 and introduced into the molding cavity 458, for incorporation into the molded article, in the manner described below. When the first and second mold stack portions 424 and 428 are separated into spaced relation S3 for ejection of molded article, the mechanism 442 advances the ribbon 464 to align a new insert 440′ between the first and second mold stack portion 424 and 428 for use in the subsequent molding cycle, with a cutout portion of ribbon 464 from the severing of the previous insert 440 being conveyed towards the take-up reel 462. The insert feeder mechanism is controlled by controller 430.

The controller 430 is a programmable logic controller or other form of processor that controls operation of the injection molding system 400 as described herein. The controller 430 may send control signals to one or more actuators to effect movement of the associated components. In some embodiments, operation of the controller 430 may be governed by instructions, which may be loaded from a non-transitory machine-readable medium 431, that, upon execution by the controller 430, cause the controller 430 to control the operation the injection molding system 400 as described herein. The machine-readable medium 431 may be an optical disk or magnetic storage medium for example.

Example operation 1200 of the injection molding system 400 is illustrated in FIG. 12 in conjunction with FIGS. 39-52. It should be appreciated that, in FIGS. 39-52, certain component or subcomponents of the injection molding system 400 are omitted for brevity or clarity.

Initially, the injection molding system 400 is configured as shown in FIG. 39, with the first and second mold stack portions 424 and 428 being in the spaced configuration, i.e. in a spaced relation, separated by a space S3. An insert 440 is disposed between first mold stack portion 424 and second mold stack portion 428 (FIG. 12, 1202). Disposing of the insert 440 may be achieved by sending a suitable control signal to the supply reel 460 and/or take-up reel 462 to cause the insert 440 to be advanced to a position between the first and second mold stack portions 424 and 428 and stopped there. It will be appreciated that the insert 440 may be integrally formed with ribbon 464.

The shuttle 432 is positioned along the shuttling axis Y to cause the shuttle aperture 471 to align with the first and second mold stack portions 424 and 428 (FIG. 12, 1204). In FIG. 40, this alignment is already achieved from the previous molding cycle. The shutter 434 is in the open position, with the shutter aperture 480 accommodating the end 419 of the ejector portion 463 of the second mold stack portion 428.

Next, at least one of the first and second mold stack portions 424, 428 is moved towards the other of the first and second mold stack portions 424, 428 into a molding configuration to define a molding cavity 444 therebetween, with the insert 440 enclosed within the molding cavity 444 (as in FIG. 46) and with the first and second mold stack portions 424 and 428 substantially accommodated within the shuttle aperture 470 (FIG. 12, 1206). In the present embodiment, operation 1206 occurs in stages, as shown in FIGS. 41-46.

Referring to FIG. 40, the second mold stack portion 428 is initially advanced through shuttle aperture 471 towards the core 452 of the first mold stack portion 424. In particular, the tubular portion 461, ejector portion 463, and pinching sleeve 427 components comprising mold stack portion 428 are moved in unison (upwardly in FIG. 44) through coordinated actuation of respective plates 483, 481 and 479. The second mold stack portion 428 is so advanced until a central portion 443 of the insert 440 is clamped between the core 452 and the ejector portion 463 of the second mold stack portion 428, and a peripheral border 441 of the insert 440 is clamped between the pinching sleeve 427 and the slide plate 425 immediately surrounding the opening 423.

Meanwhile, heating elements 488 and 489, which may be infrared heating elements for example, are activated and begin to heat the portions of the ribbon 464 that are aligned with shuttle apertures 470 and 472. Note that the portion of the ribbon 464 that will constitute insert 440 was heated by heating element 489 prior being conveyed from shuttle aperture 472 to shuttle aperture 471, while the portion of the ribbon 464 that will constitute the next insert 440′ is now being heated through aperture 472 by heating element 489.

Referring to FIG. 41, at this stage a pressurized gas, such as air, is blown into the mold cavity 458 through blowing orifice 401. Alternatively, or in conjunction, gas is evacuated from mold cavity 458 via vacuum orifice 403. This causes the insert 440 to inflate or stretch, substantially uniformly, towards the ejector portion 463. Stretching may be facilitated when the insert 440 is in a heated state, which may be by virtue of the insert 440 having earlier been heated by heating element 489. This stretching continues in FIG. 44.

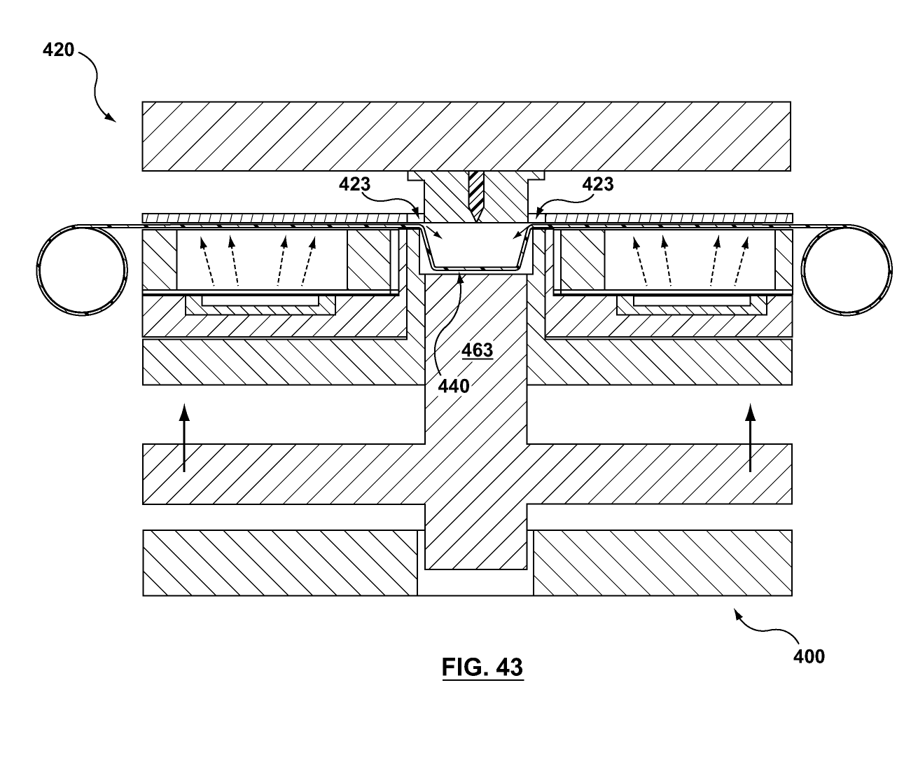

Turning to FIG. 43, the ejector portion 463 begins moving towards the stretched insert 440.

Subsequent molding operation, as illustrated in FIGS. 44-52, is similar to the operation of the previous embodiment as illustrated in FIGS. 30-38.

In particular, referring to FIG. 44, the second mold stack portion 428 (including tubular portion 461, ejector portion 463, and pinching sleeve 427) is advanced towards mold shoe 436 until a central portion 443 of the insert 440 is clamped between the core 452 and the ejector portion 463 of the second mold stack portion 428, and a peripheral border 441 of the insert 440 is clamped between the pinching sleeve 427 and the slide plate 425 immediately surrounding the core 452.

The insert 440, whose skirt portion 445 has been stretched around sides of core 452, is now substantially enclosed within an almost fully formed molding cavity 444. The reason that the molding cavity 444 is said to almost fully formed is because the ejector portion 463 continues to clamp the central portion 443 of the insert 440 against the core 452, such that there is presently no room between the core 452 and the ejector portion 463 to receive molding material.

Still referring to FIG. 46, the peripheral border 441 of the insert 440 is severed. Severing may be achieved using complementary cutting surfaces defined in or on the tubular portion 461 of the mold stack portion 428 and the slide tray 425. These complementary cutting surfaces are not expressly depicted in FIG. 44 but may be similar to those shown in FIG. 5 of the earlier described embodiment.

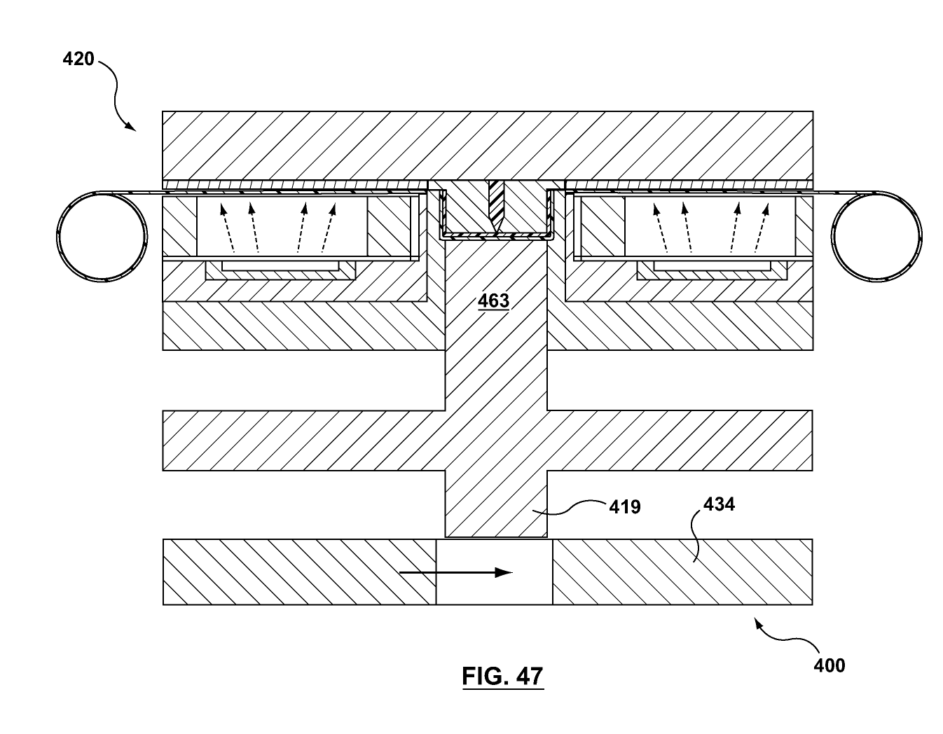

Referring to FIG. 45, at this stage the in-mold shutter 434 is placed in the shut or “locked” position with a view to blocking movement of the ejector portion 463 of the second mold stack portion 428 in a direction away from the first mold stack portion 424 (i.e. downwardly in FIG. 47) during subsequent injection molding. This may be referred to as “locking the mold.” A small gap 469 exists between the lower end 419 of the ejector portion 463 and the shutter 434 pending a slight retraction of the ejector portion 463.

In FIG. 46, the ejector portion 463 of the second mold stack portion 428 is retracted slightly away from mold shoe 436 until the lower end 419 abuts the shutter 434. As a result, the opposite end of the ejector portion 463 ceases clamping the central portion 443 of the insert 440 against the core 452. The released insert 440 accordingly has an unstretched portion 443 and a stretched skirt portion 445. The slight retraction of the ejector portion 463 completes the formation of the molding cavity 444 within which the insert 440 now resides. The cross-sectional shape of the example molding cavity 444 in FIG. 46 is generally U-shaped, consistent with the fact that the article is a closure for a container in this example. The shape of the molding cavity 444 may vary in other embodiments, depending upon the article being molded.

Referring to FIG. 46, with the mold 420 clamped, molding material 455, such as, for example, melted Polypropylene, is injected into the molding cavity 444 via nozzle 456 of the core 452 of first mold stack portion 424. This results in the molding of the article 490 incorporating the insert 440 (FIG. 12, 1208). In the illustrated example, the insert 440 becomes integrally formed with the exterior surface of the article 490, because the molding material is injected from the core 452 that defines the interior surface of the article 490. This may vary in alternative embodiments.

FIG. 47 illustrates an “unclamping” stage of operation, similar to that described above with respect to FIG. 34. At this stage the in-mold shutter 434 is placed in the open position. This may be referred to as “unlocking the mold.”

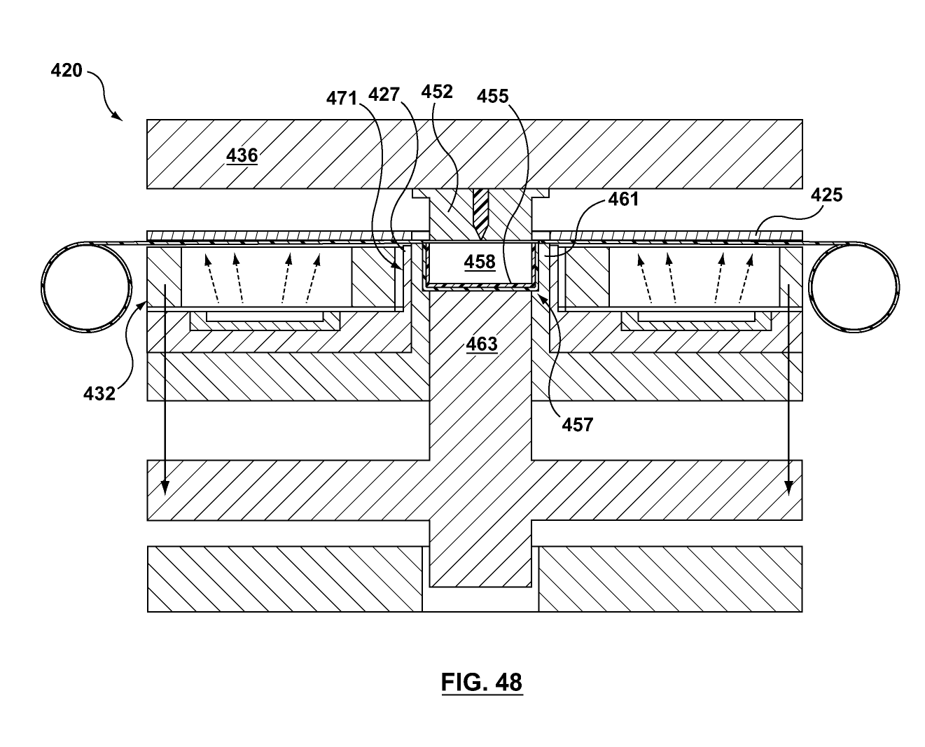

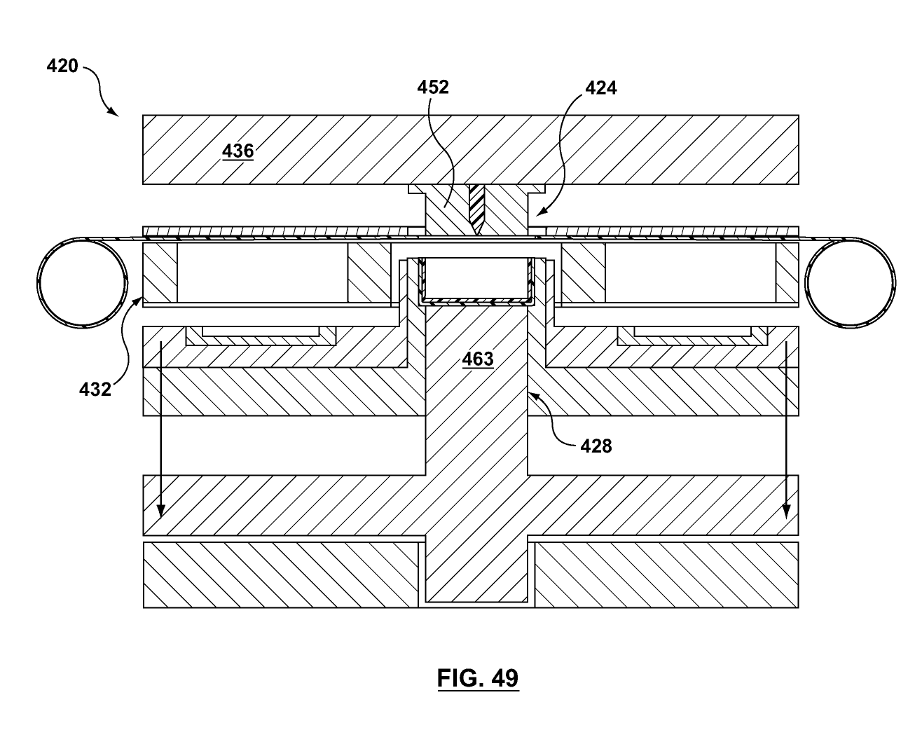

Referring to FIGS. 48-49, the slide plate 425, shuttle 432 and second mold stack portion 428 (including the tubular portion 461, ejector portion 463 and pinching sleeve 427) are retracted in unison (downwardly in FIG. 52), so as to withdraw the shuttle aperture 471, as well as the cavity 458 of mold insert 457, from about the core 452.

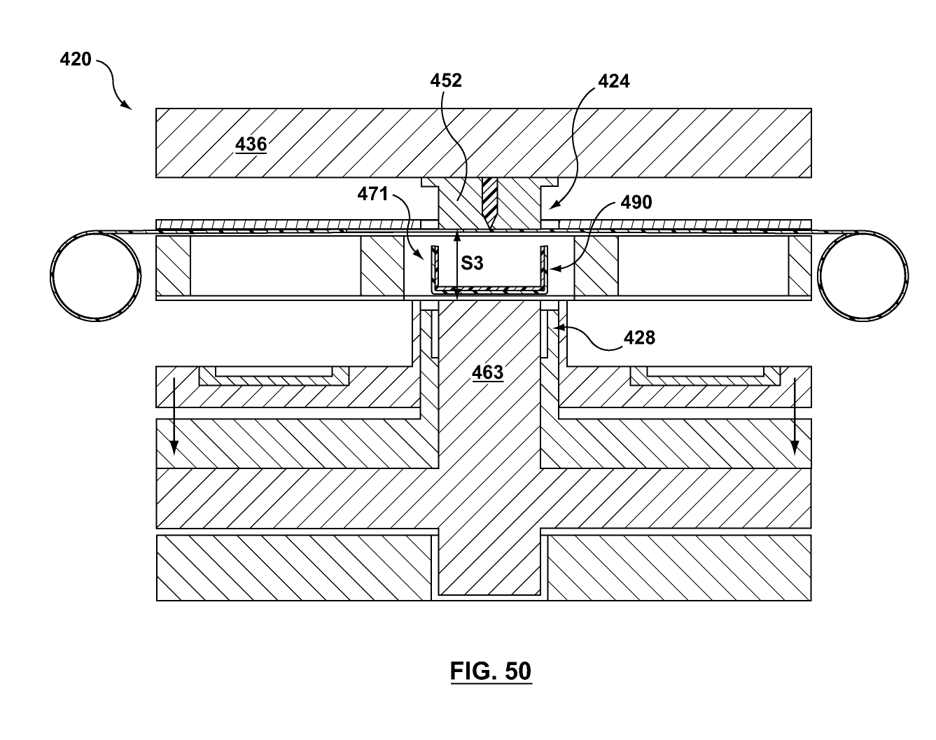

Referring to FIG. 50, continued withdrawal of the second mold stack portion 428 from the core 452 results in separation of the first and second mold stack portions 424 and 428 into the spaced relation, with separation S3 between them, as originally shown in FIG. 39 (FIG. 12, 1210). In the result, the molding cavity 444 is opened.

More specifically, in FIG. 49, retraction of the shuttle 432 and slide plate 425, as well as the pinching sleeve 427 of the second mold stack portion 428, is ceased, while retraction of the tubular portion 461 and ejector portion 463 of the second mold stack portion 428 continues along mold-stroke axis X. In the result, withdrawal of the portions 461 and 463 from within pinching sleeve 427 is commenced.

Referring to FIG. 50, retraction of the tubular portion 461 and of the pinching sleeve 427 of the second mold stack portion 428 continues along mold-stroke axis X. Meanwhile, retraction of ejector portion 463 of the second mold stack portion 428 is ceased. The retraction of the tubular portion 463 about the now stationary ejector portion 461 causes the ejector portion 463 to strip the molded article 490 from the tubular portion 461, i.e. eject the article 490 incorporating insert 440 from the second mold stack portion 428, within the shuttle aperture 471 (FIG. 12, 1212). The second mold stack portion 428 is thus fully withdrawn from the shuttle aperture 471, leaving the molded article 490 incorporating the insert 440 within the shuttle aperture 471.

Referring to FIGS. 50, 51 and 52, the insert feeder mechanism 442 advances the ribbon 464 to provide a new insert 440′ (FIG. 40) for use in the subsequent molding cycle, while at the same time causing cutout 492 (FIG. 49), which resulted from the punching of the previous insert 440 from ribbon 464, to be conveyed towards the take-up reel 462. The shuttle 432 is also moved so as to align the shuttle aperture 471 with a transfer structure (not expressly illustrated) near an outboard position 451 for transfer of the molded article 490 incorporating the insert 440 from the injection molding system 400 (FIG. 12, 1214), i.e. to the left in FIGS. 51 and 52. This results in alignment of the third shuttle aperture 472 with the first and second mold stack portions 424 and 428, in preparation for a subsequent molding cycle. The molded article 490 will be transferred from the first shuttle aperture 471 and out of the injection molding system 200. Operation 1200 is thus concluded.

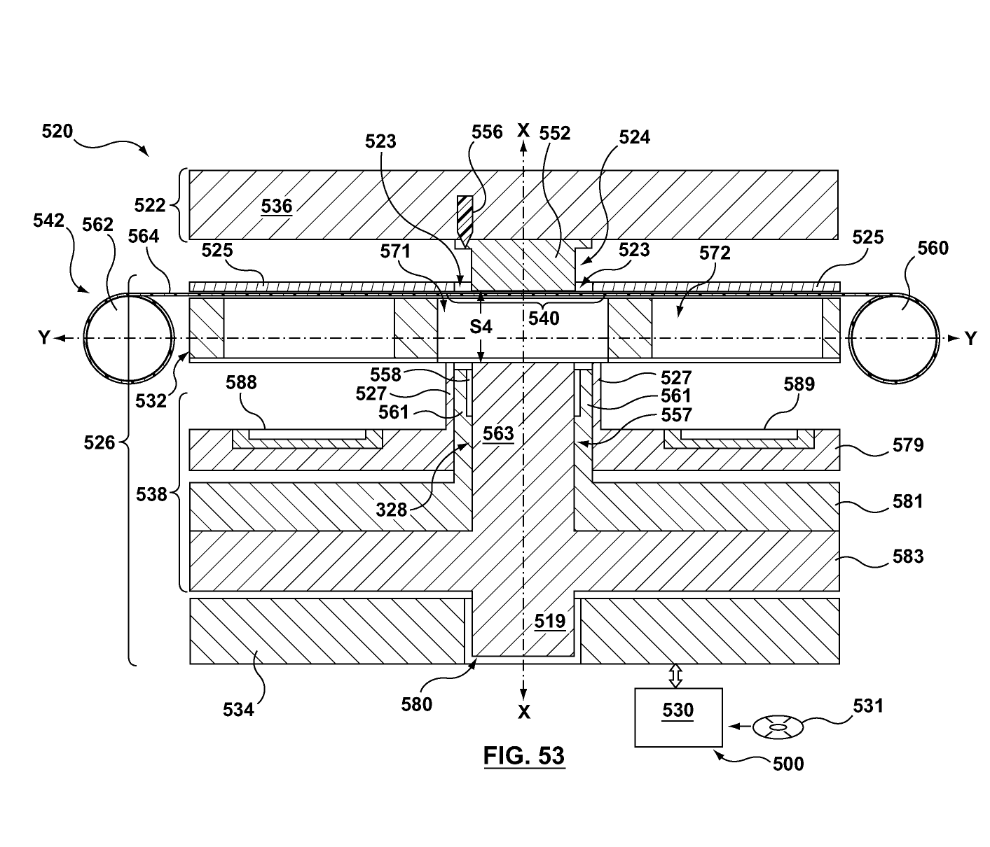

FIG. 53 illustrates a schematic representation of a non-limiting, alternative embodiment of an injection molding system for molding articles with incorporated inserts. The illustrated embodiment system 500 differs from system 300 of FIGS. 27-38 in that the injection molding material is not injected so as to incorporate substantially the entirety of the insert of the ultimately molded article. Rather, the injection molding material is injected so as to form only a tamper evident band (TEB) portion of the molded article. The TEB may be formed along a distal edge of a skirt portion of the molded article, with the remainder of the molded article consisting solely of the insert material. As a result, it may be desirable to use an insert material that is sufficiently rigid to be able to support its own weight and/or the weight of the molded article after the article has been formed. For example, the insert material may be, for example, PVC, Nylon, PETG and EVA. The conventions used in FIG. 53, are the same as those used in FIG. 27. The system 500 comprises an injection mold 520 and a controller 530.

The injection mold 520 includes a first mold half 522 and a second mold half 526. The first mold half 522 comprises a first mold shoe 536 and a first mold stack portion 524 associated therewith. The second mold half 526 comprises a second mold shoe 538 and a second mold stack portion 528 associated therewith. The second mold shoe and second mold stack portion 528 may be contained within an ejector box (not illustrated) which may be similar to what is shown in FIG. 13 for example. The second mold half 526 also comprises a shuttle 532 and an in-mold shutter 534, which may also be also contained within the same ejector box. In addition, the second mold half 522 comprises a set of plates 579, 581 and 583 (collectively comprising the second mold shoe 538) that are used to drive a pinching sleeve 527, a tubular portion 561 and a cylindrical portion 563, respectively, of the second mold stack portion 528.

FIG. 53 illustrates the mold 520 in the mold-closed configuration, in which the mold halves 522 and 526 are substantially adjacent to one another. Use of the shuttle 532 as described below allows the mold halves 522 and 526 to remain in the mold-closed configuration while completed (molded) articles with incorporated inserts are ejected from the injection mold 520 to a transfer structure (not expressly illustrated). This may again promote similar benefits to those described above with respect to the earlier-described embodiments.

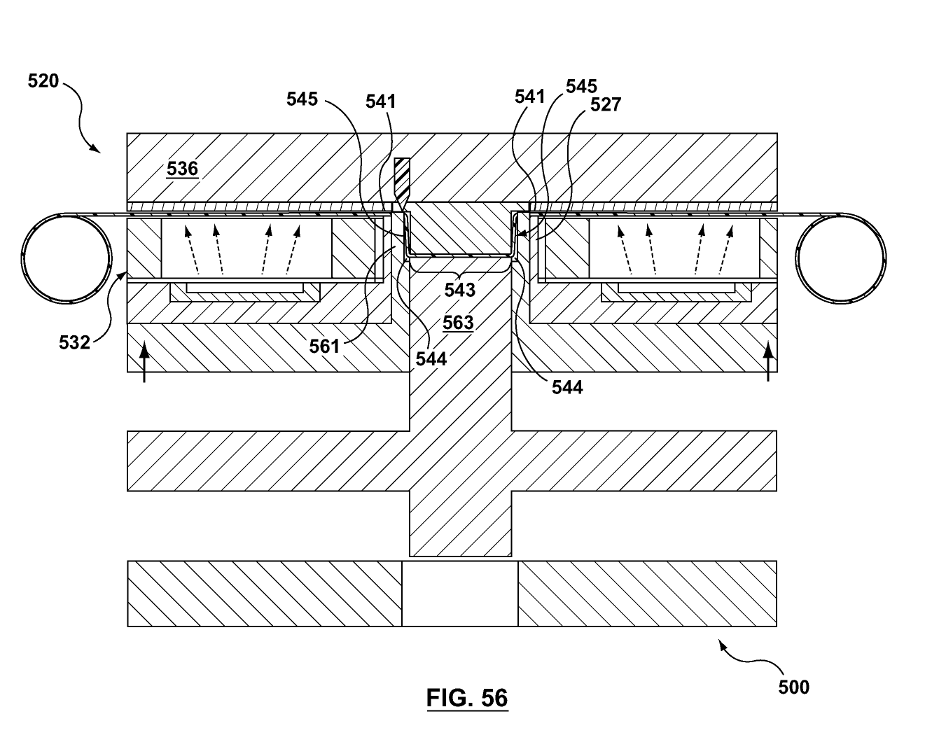

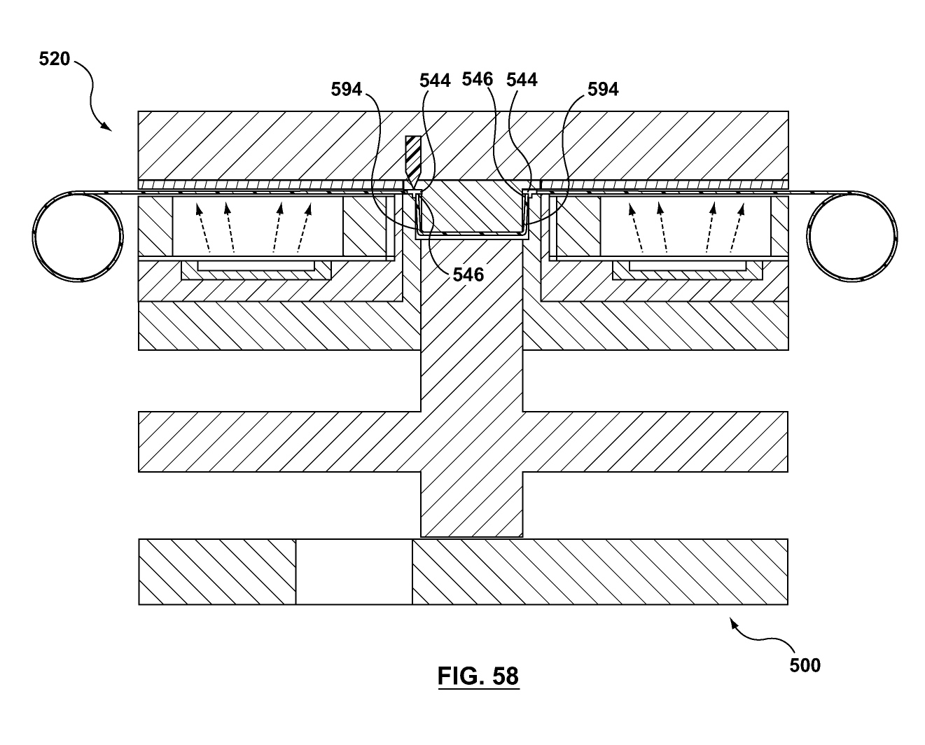

The first and second mold stack portions 524 and 528 are sub-components of the injection mold 520 that move relative to one another to alternately create a molding cavity 544 (e.g. as shown in FIG. 56) in the shape of the article to be molded and thereafter eject the molded article for transfer from the injection mold 520. The relative movement of the first and second mold stack portions 524 and 528 of FIG. 53 is along the mold-stroke axis X, between a spaced configuration and a molding configuration. In the spaced configuration, the first and second mold stack portions 524 and 528 are in a spaced relation, which is represented in FIG. 53 by the separation between them denoted S4. In the molding configuration, the first and second mold stack portions 524 and 528 cooperate to define a molding cavity 594 therebetween having a generally U-shape in cross section (see FIG. 58). Moreover, unlike the mold 320 described above, the first and second mold stack portions 524 and 528 further cooperate to define another molding cavity 544 defining a tamper evident band. The latter molding cavity 544 is generally ring shaped and has a flange (the flange 546 depending downwardly in FIG. 58) that facilitates attachment of the tamper evident band to the insert.

As illustrated in FIG. 53, the first mold stack portion 524 comprises a unitary core 552. The core 552 remains stationary during molding operation in this embodiment by virtue of being fixedly connected or mounted to the first mold shoe 536, which also remains stationary during molding. The core 552 has a nozzle 556 for injecting molding material into the molding cavity 544 (FIG. 56). The nozzle is offset from center because the molding material that is injected will form a tamper evident band along the circumference of the article rather than the entirety of the article.

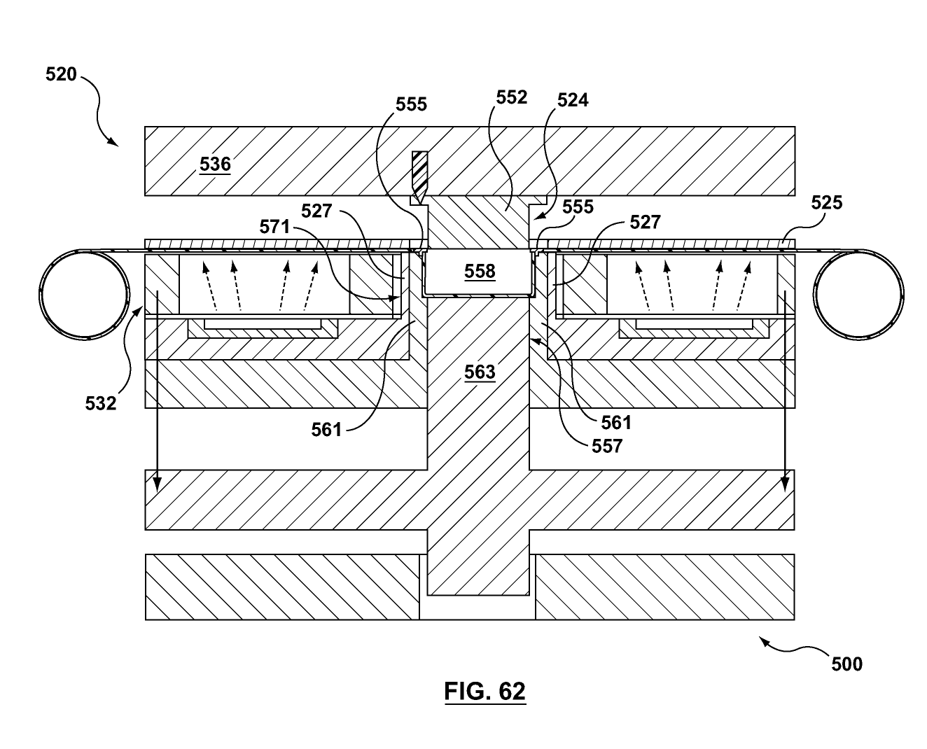

The second mold stack portion 528 of the embodiment shown in FIG. 53 comprises a tubular portion 561 that defines the exterior surface of the skirt of the article and a cylindrical portion 563 that defines the exterior surface of the top of the article. When suitably aligned with respect to one another (e.g. as in FIG. 62), the tubular and cylindrical portions 561 and 563 collectively define the mold cavity 558 that defines the exterior surface of the container closure that is to be molded. The cylindrical portion 563 is slidable within the tubular portion 561 to facilitate ejection of a molded article from the cavity 558, as will be described. By virtue of that fact, the cylindrical portion 563 may alternatively be referred to as ejector portion 563. The second mold stack portion 528 of the present embodiment further comprises a surrounding pinching sleeve 527 that is slidable, in the mold-stroke axis X direction, relative to the tubular portion 561. As will be appreciated, the pinching sleeve will hold (or will at least help to hold) an insert in place as the insert is stretched by way of relative movement between the first and second mold stack portions 524 and 528.

Relative movement of the second mold stack portion 528 along the mold-stroke axis X, in relation to the first mold stack portion 524, is achieved in the present embodiment by way of actuators (not expressly illustrated) under control of controller 530. Separate actuators may be used to drive each of three separate plates 583, 581 and 579 that comprise the second mold shoe 538 independently of one another. A further actuator (also not illustrated) may be used for moving shuttle 532, independently of plates 583, 581 and 579, in the mold-stroke axis X direction. These actuators may for example be hydraulic actuators, pneumatic actuators, electro-mechanical actuators, or the like, or combinations of these.

In addition to being movable in the mold-stroke axis X direction, the shuttle 532 is also movable along a shuttling axis Y that is generally perpendicular to mold-stroke axis X in the illustrated embodiment. The motion of the shuttle 532 along shuttling axis Y in the present embodiment, as will be described subsequently, may be facilitated by a separate actuator (also not illustrated) under control of controller 530.

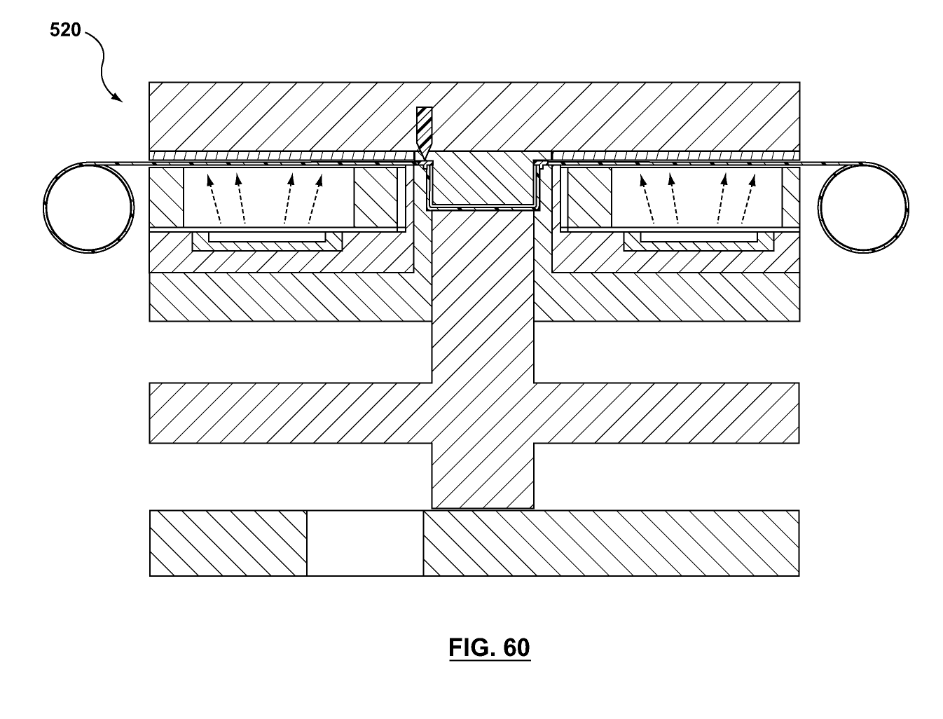

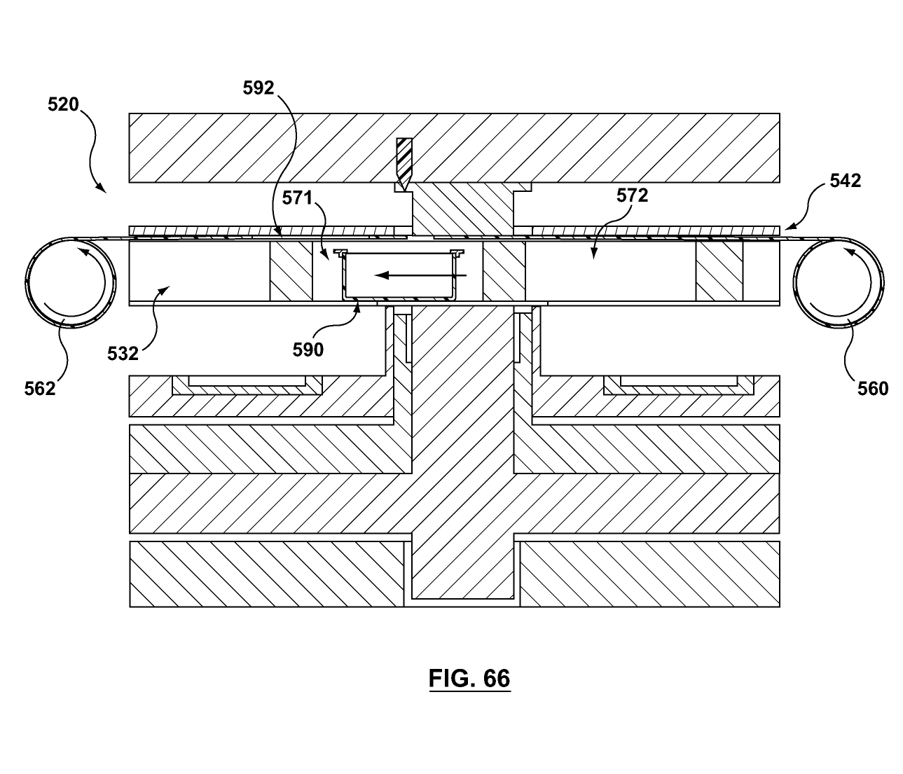

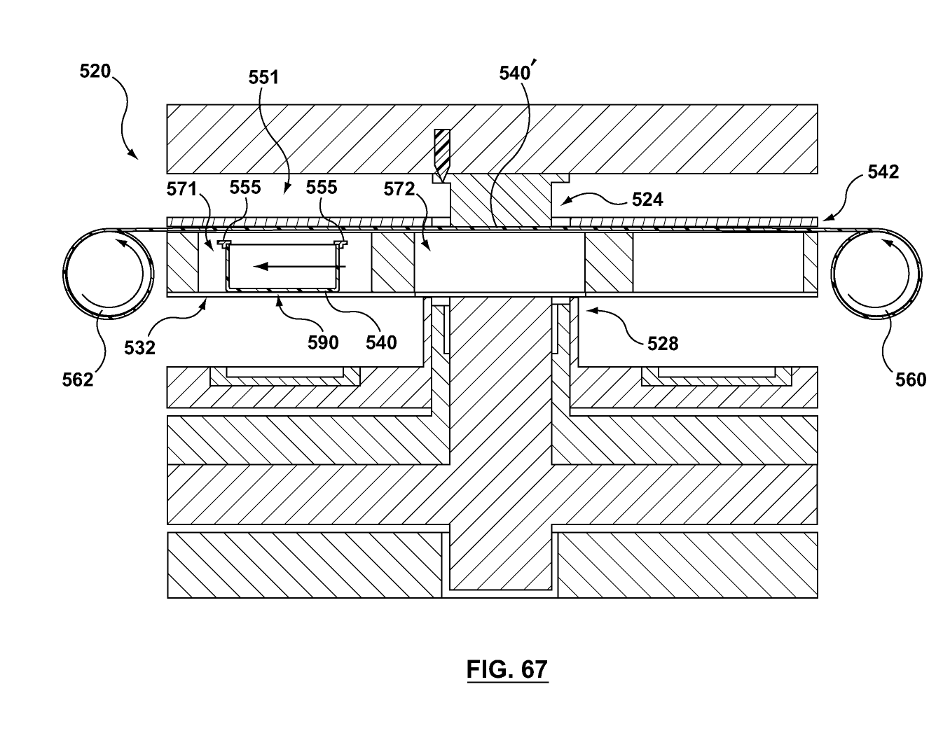

The shuttle 532 has three apertures 570, 571 and 572. In FIG. 53, the middle aperture 571 is aligned with the first and second mold stack portions 524 and 528. In a subsequent cycle, the third aperture 572 will become so aligned. During operation of the system 500, the aperture 571 will alternately substantially accommodate: (a) the first and second mold stack portions 524 and 528, when the portions 524 and 528 are in the molding configuration—see e.g. FIGS. 58 and 60; and (b) the molded article 590 incorporating the insert 540, upon withdrawal of the first and second mold stack portions 524 and 528 from the aperture 571, for shuttling and transfer of the molded article 590 out of the injection mold 520, as shown in FIGS. 66 and 67 for example.

The side of plate 579 that faces the shuttle 532 has two heating elements 588 and 589 mounted or attached thereto. In FIG. 53, the first heating element 588 is aligned with the first shuttle aperture 570 and the second heating element 589 is aligned with the third shuttle aperture 572. These heating elements will be used to heat inserts prior to their stretching and formation into molded articles, as described below.

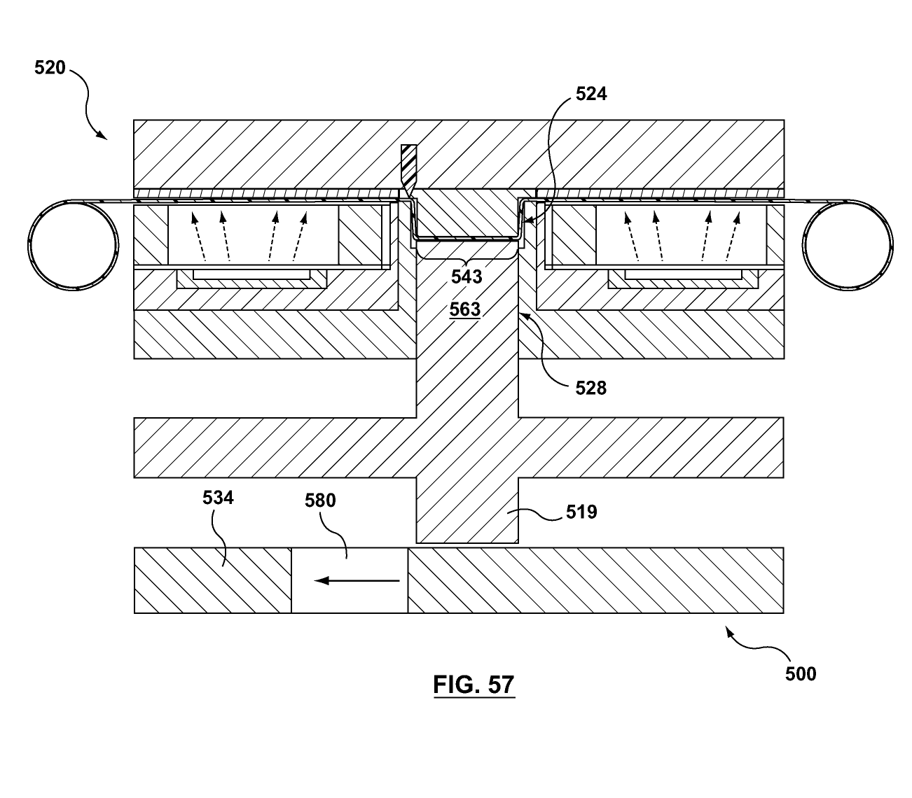

Referring again to FIG. 53, the in-mold shutter 534 (or simply “shutter” 534) facilitates positioning of the ejector portion 563 of the second mold stack portion 528 in either a spaced configuration, as shown in FIG. 53 for example, or a molding configuration, as shown in FIG. 57 for example, without requiring the mold halves 522 and 526 to be moved from the mold-closed configuration that is represented, e.g., in FIG. 57. The shutter 534 is reciprocable in a direction that is substantially parallel to the shuttling axis Y, between an open or “unlocked” position (as shown in FIG. 53) and a shut or “locked” position (as in FIGS. 57-60). These are analogous to the same position of shuttle 335 of system 300, described above.

Reciprocating movement of the shutter 534 between the open and shut positions may be achieved by way of an actuator (not illustrated), such as, for example, a hydraulic actuator, a pneumatic actuator, an electro-mechanical actuator, or the like, under control of controller 530.

The insert feeder mechanism 542 of the present embodiment is similar to the insert feeder mechanism 342 of system 300, described above. It comprises a slide plate 525, a supply reel 560 and a take-up reel 562. The reels 560 and 562 are operable to advance a ribbon 564 comprising the insert 540 between the first and second mold stack portions 524 and 528. In particular, the mechanism 542 turns the reels 560 and 562 to dispose a portion of the ribbon 564, which portion will comprise the insert 540, between an opening 523 in the slide plate 525 and the shuttle aperture that is currently aligned with the first and second mold stack portions 524 and 528. The insert may then be severed (e.g. punched) from the ribbon 564 and introduced into the molding cavity 558, for incorporation into the molded article, in the manner described below. When the first and second mold stack portions 524 and 528 are separated into spaced relation S4 for ejection of molded article, the mechanism 542 advances the ribbon 564 to align a new insert 540′ between the first and second mold stack portion 524 and 528 for use in the subsequent molding cycle, with a cutout portion of ribbon 564 from the severing of the previous insert 540 being conveyed towards the take-up reel 562. The insert feeder mechanism is controlled by controller 530.

The controller 530 is a programmable logic controller or other form of processor that controls operation of the injection molding system 500 as described herein. The controller 530 may send control signals to one or more actuators to effect movement of the associated components. In some embodiments, operation of the controller 530 may be governed by instructions, which may be loaded from a non-transitory machine-readable medium 531, that, upon execution by the controller 530, cause the controller 530 to control the operation the injection molding system 500 as described herein. The machine-readable medium 531 may be an optical disk or magnetic storage medium for example.

Example operation 1200 of the injection molding system 500 is illustrated in FIG. 12 in conjunction with FIGS. 53-67. It should be appreciated that, in FIGS. 53-67, certain component or subcomponents of the injection molding system 500 are omitted for brevity or clarity.

Initially, the injection molding system 500 is configured as shown in FIG. 53, with the first and second mold stack portions 524 and 528 being in the spaced configuration, i.e. in a spaced relation, separated by a space S4. An insert 540 is disposed between first mold stack portion 524 and second mold stack portion 528 (FIG. 12, 1202). Disposing of the insert 540 may be achieved by sending a suitable control signal to the supply reel 560 and/or take-up reel 562 to cause the insert 540 to be advanced to a position between the first and second mold stack portions 524 and 528 and stopped there. It will be appreciated that the insert 540 may be integrally formed with ribbon 564.

The shuttle 532 is positioned along the shuttling axis Y to cause the shuttle aperture 571 to align with the first and second mold stack portions 524 and 528 (FIG. 12, 1204). In FIG. 53, this alignment is already achieved from the previous molding cycle. The shutter 534 is in the open position, with the shutter aperture 580 accommodating the end 519 of the ejector portion 563 of the second mold stack portion 528.

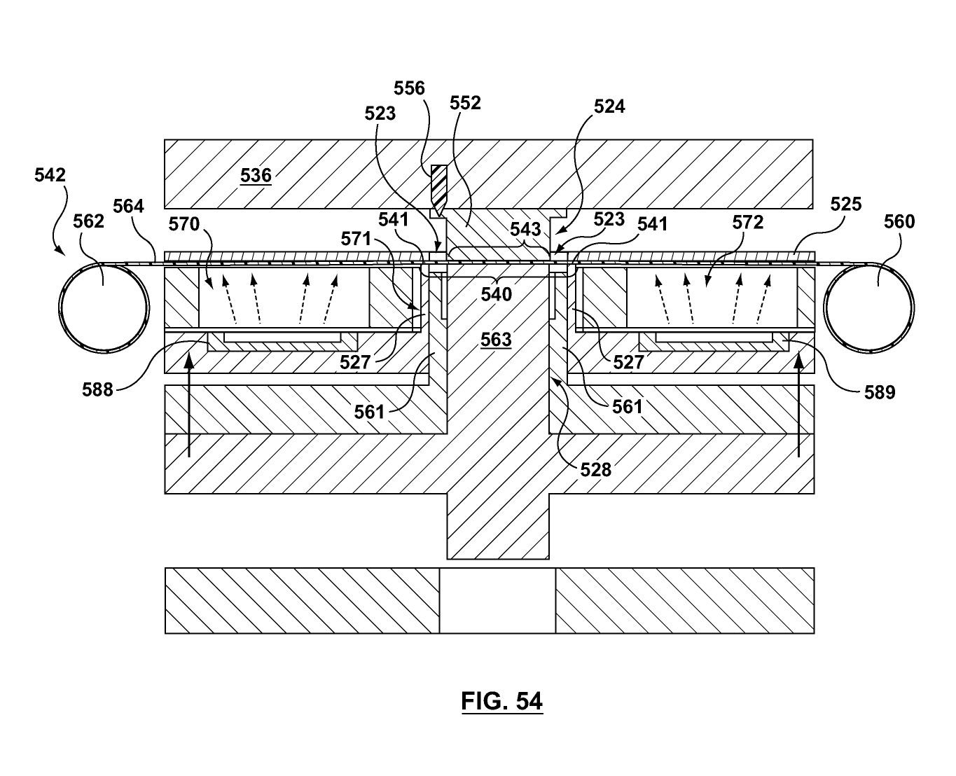

Next, at least one of the first and second mold stack portions 524, 528 is moved towards the other of the first and second mold stack portions 524, 528 into a molding configuration to define a molding cavity 594 therebetween, with the insert 540 partially enclosed within the molding cavity 594 (as in FIG. 58—the edge of the insert 540 is within the circumferential cavity 594) and with the first and second mold stack portions 524 and 528 substantially accommodated within the shuttle aperture 570 (FIG. 12, 1206). A molding cavity 544 is also defined, but does not receive molding material in the present embodiment. Operation 1206 occurs in stages, as shown in FIGS. 54-59.

Referring to FIG. 54, the second mold stack portion 528 is initially advanced through shuttle aperture 571 towards the core 552 of the first mold stack portion 524. In particular, the tubular portion 561, ejector portion 563, and pinching sleeve 527 components comprising mold stack portion 528 are moved in unison through coordinated actuation of respective plates 583, 581 and 579. The second mold stack portion 528 is so advanced until a central portion 543 of the insert 540 is clamped between the core 552 and the ejector portion 563 of the second mold stack portion 528, and a peripheral border 541 of the insert 540 is clamped between the pinching sleeve 527 and the slide plate 525 immediately surrounding the opening 523.

Meanwhile, heating elements 588 and 589, which may be infrared heating elements for example, are activated and begin to heat the portions of the ribbon 564 that are aligned with shuttle apertures 570 and 572. Note that the portion of the ribbon 564 that will constitute insert 540 was heated by heating element 589 prior being conveyed from shuttle aperture 572 to shuttle aperture 571, while the portion of the ribbon 564 that will constitute the next insert 540′ is now being heated through aperture 572 by heating element 589.

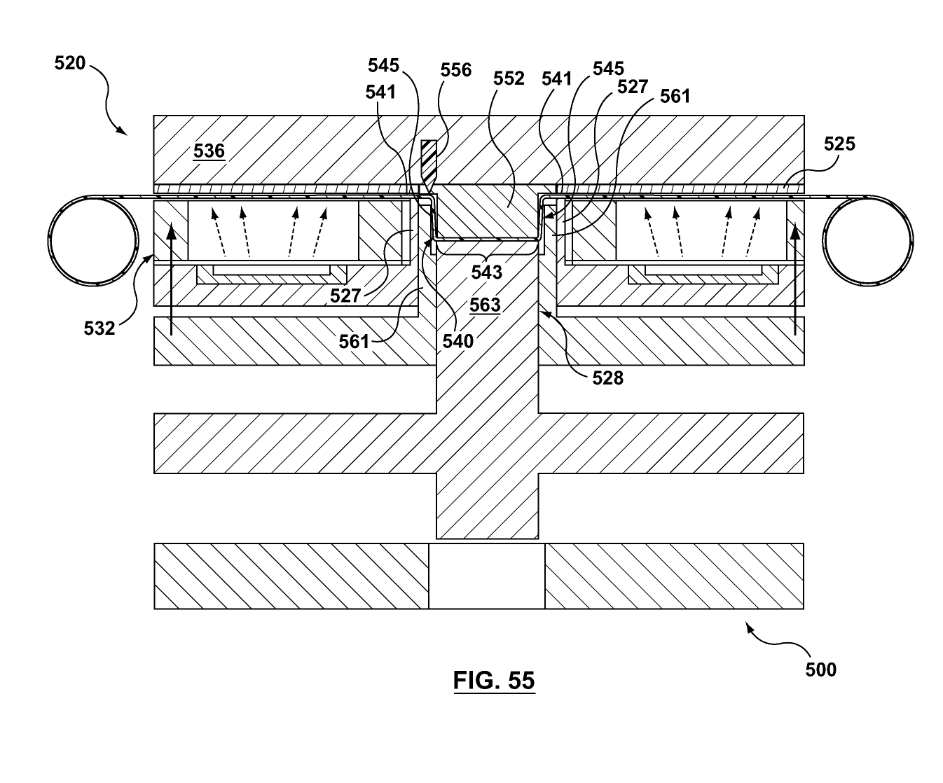

Turning to FIG. 55, once the central portion 543 of the insert 540 becomes clamped between core 552 and the ejector portion 563, movement of the ejector portion 563 ceases. Meanwhile, advancement of the tubular portion 561 and pinching sleeve 527 of the second mold stack portion 528 toward the first mold shoe 536 continues, and shuttle 532, insert feeder mechanism 542 and slide plate 525 now also commence moving, in unison with the components 561, 563 and 527 of the second mold stack portion 528.

Because the peripheral portion 541 of the insert 540 that is clamped between the pinching sleeve 527 and the slide plate 525 immediately surrounding the opening 523 is being moved towards the first mold shoe 536 while the central portion 543 of the insert 540 is now stationary, stretching of a skirt portion 545 of the insert 540 commences. The central portion 543 of the insert remain unstretched due to its being clamped between core 552 and ejector portion 563. This may advantageously limit distortion of any graphics and/or text that may form part of that central portion 543 in some embodiments. Such distortion could be considered undesirable as it may interfere with viewing of the graphics and/or reading of the text by a consumer for example. Stretching continues until the slide plate 525 contacts the first mold shoe 536 (as in FIG. 55), and which point movement of the slide plate 525, insert feeder mechanism 542, shuttle 532 and pinching sleeve 527 ceases.

Referring to FIG. 56, the tubular portion 561 of the mold stack portion continues advancing until it reaches a limit in which the top of the tubular portion 561 aligns with the top of the pinching sleeve 527. A skirt portion 545 of the insert 540 is thereby stretched around sides of core 552.

Still referring to FIG. 56, the peripheral border 541 of the insert 540 is severed. Severing may be achieved using complementary cutting surfaces defined in or on the tubular portion 561 of the mold stack portion 528 and the slide tray 525. These complementary cutting surfaces are not expressly depicted in FIG. 56 but may be similar to those shown in FIG. 5 of the earlier described embodiment. The severing may be performed so as to permit the severed edge of the insert to overlap with the depending flange 546.

Referring to FIG. 57, at this stage the in-mold shutter 534 is placed in the shut or “locked” position with a view to blocking movement of the ejector portion 563 of the second mold stack portion 528 in a direction away from the first mold stack portion 524 (i.e. downwardly in FIG. 60) during subsequent injection molding.

FIG. 58 illustrates a “clamp up” stage of operation, which is analogous to that illustrated in FIG. 32.

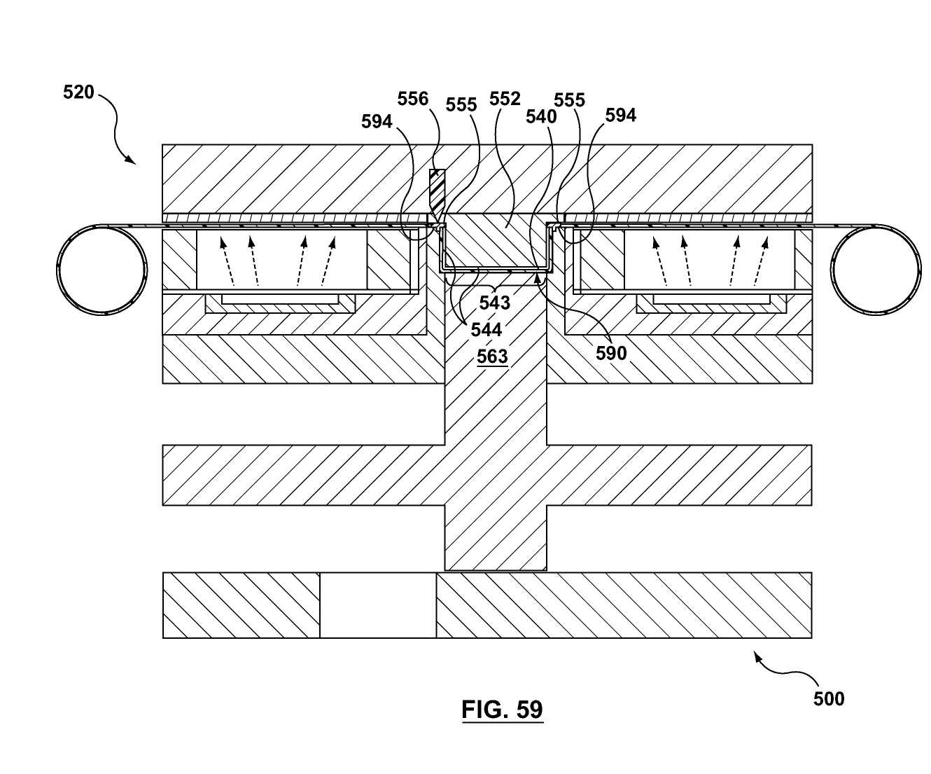

Referring to FIG. 59, the ejector portion 563 of the second mold stack portion 528 is retracted slightly away from mold shoe 536 until the lower end 519 abuts the shutter 534. As a result, the opposite end of the ejector portion 563 ceases clamping the central portion 543 of the insert 540 against the core 552. The released insert 540 accordingly has an unstretched portion 543 and a stretched skirt portion 545.

Thereafter, with the mold 520 clamped, molding material 555, such as, for example, melted Polypropylene, is injected into the molding cavity 594 via nozzle 556 of the core 552 of first mold stack portion 524. This results in the molding of the article 590 incorporating the insert 540 (FIG. 12, 1208). In the illustrated example, the insert 540 is incorporated into the article by way of a joining of the TEB flange 546 with the severed edge of the insert 540. Thus, it should be appreciated that, at least in this embodiment, incorporation of the insert into the molded article does not require the entire insert to become integrally formed with the molding material. In contrast, other embodiments may warrant a more complete integral formation of the insert with the molding material.

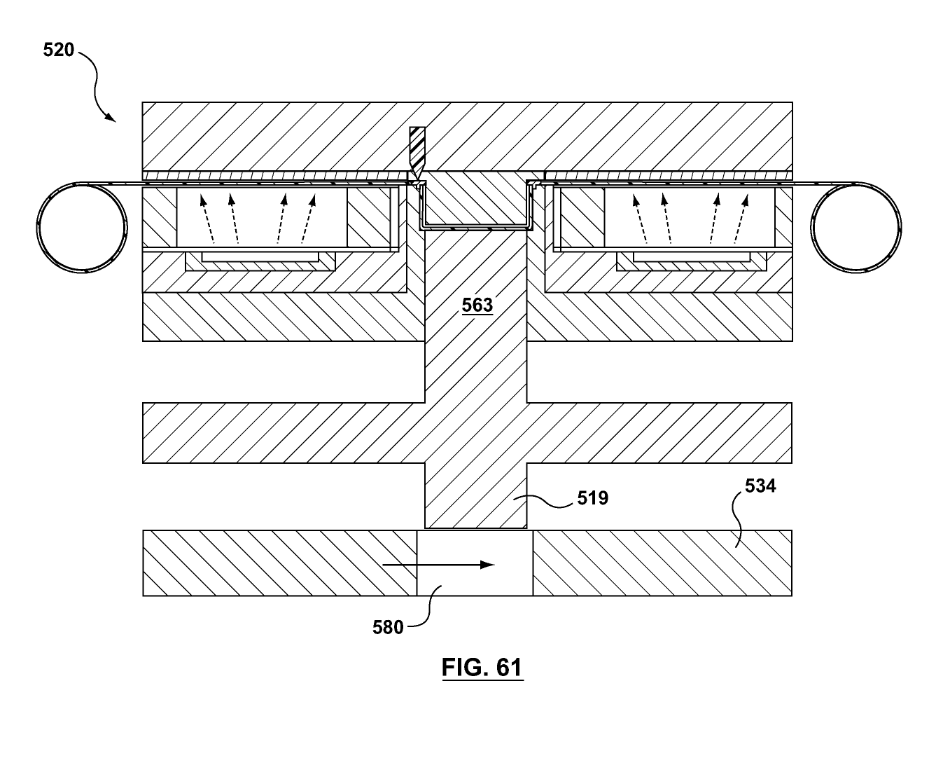

FIG. 61 illustrates an “unclamping” stage of operation, at this stage the in-mold shutter 534 is placed in the open position.

Referring to FIG. 62, the slide plate 525, shuttle 532 and second mold stack portion 528 (including the tubular portion 561, ejector portion 563 and pinching sleeve 527) are retracted in unison (downwardly in FIG. 56), so as to withdraw the shuttle aperture 571, as well as the cavity 558 of mold insert 557, from about the core 552.

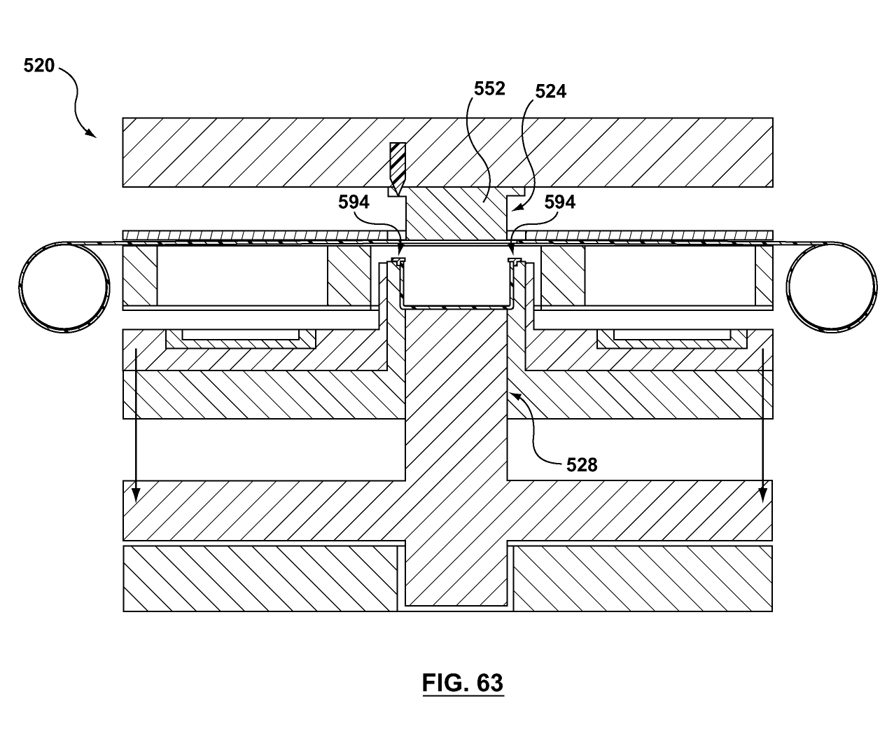

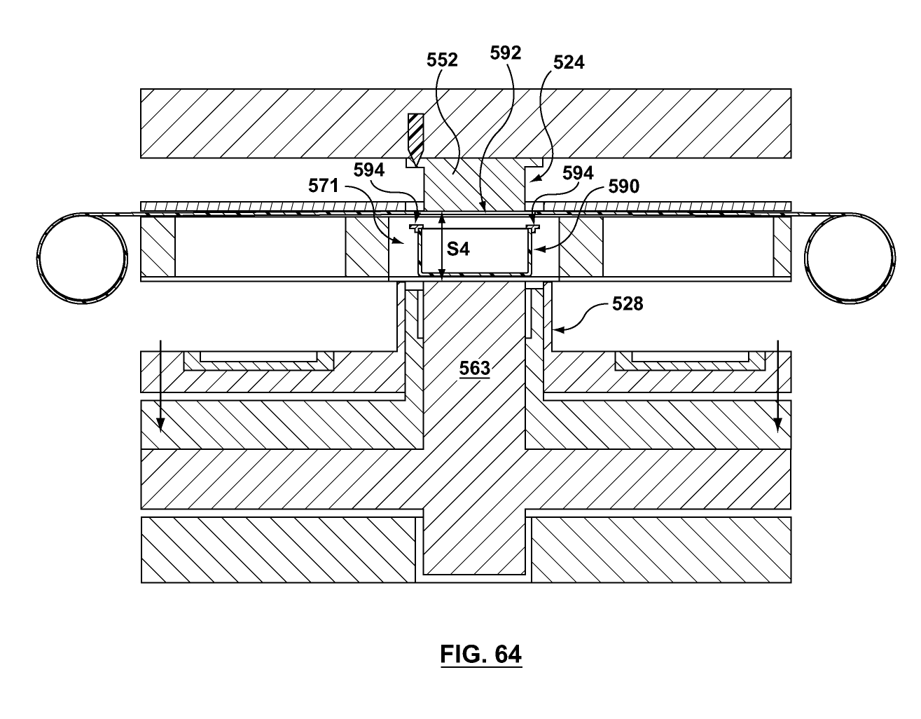

Referring to FIGS. 63 and 64, continued retraction of the second mold stack portion 528 from the core 552 results in separation of the first and second mold stack portions 524 and 528 into the spaced relation, with separation S4 between them (see FIG. 58), as originally shown in FIG. 53 (FIG. 12, 1210). In the result, the molding cavity 594 is opened.

More specifically, in FIG. 63, retraction of the shuttle 532 and slide plate 525, as well as the pinching sleeve 527 of the second mold stack portion 528, is ceased, while retraction of the tubular portion 561 and ejector portion 563 of the second mold stack portion 528 continues along mold-stroke axis X. In the result, withdrawal of the portions 561 and 563 from within pinching sleeve 527 is commenced.

Referring to FIG. 64, retraction of the tubular portion 561 and of the pinching sleeve 527 of the second mold stack portion 528 continues along mold-stroke axis X. Meanwhile, retraction of ejector portion 563 of the second mold stack portion 528 is ceased. The retraction of the tubular portion 563 about the now stationary ejector portion 561 causes the ejector portion 563 to strip the molded article 590 from the tubular portion 561, i.e. eject the article 590 incorporating insert 540 from the second mold stack portion 528, within the shuttle aperture 571 (FIG. 12, 1212). The second mold stack portion 528 is thus fully withdrawn from the shuttle aperture 571, leaving the molded article 590 incorporating the insert 540 within the shuttle aperture 571.

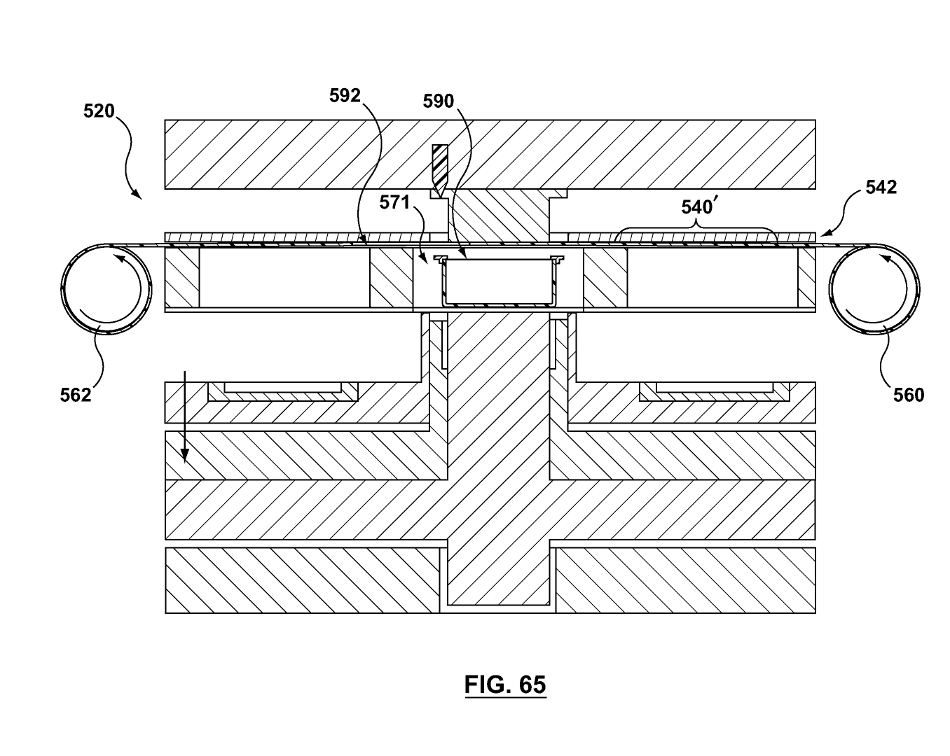

Referring to FIGS. 65-67, the insert feeder mechanism 542 advances the ribbon 564 to provide a new insert 540′ (FIG. 65) for use in the subsequent molding cycle, while at the same time causing cutout 592, which resulted from the punching of the previous insert 540 from ribbon 564, to be conveyed towards the take-up reel 562. The shuttle 532 is also moved in FIGS. 66 and 67 so as to align the shuttle aperture 571 with a transfer structure (not expressly illustrated) near an outboard position 551 for transfer of the molded article 590 incorporating the insert 540 from the injection molding system 500 (FIG. 12, 1214), i.e. to the left in FIGS. 66 and 67. This results in alignment of the third shuttle aperture 572 with the first and second mold stack portions 524 and 528, in preparation for a subsequent molding cycle. Operation 1200 is thus concluded.

Various alternative embodiments are possible.

It is not absolutely required for an insert to wholly cover exterior or interior surface of a molded article. While coverage of an entirety of an article surface may be advantageous, e.g., when the insert is a barrier film or foil, for such purpose as reducing a likelihood of oxidation of container contents for example, for some applications coverage of less than 100% may be adequate.

It is not required for the shuttle 132, 232, 332 to be slideable in all embodiments. For example, an alternative shuttle may be rotatable for example. The same is true for in-mold shutter 134, 234 or 334.

It is not required for a mold insert 157, 257, 357 to be cylindrical. The mold insert may have alternative shapes in alternative embodiments. Moreover, the “cylindrical portion” of the second mold stack portion 128, 228, 328, 428 or 528 need not actually be cylindrical. The shape of that portion may depend upon nature of article being molded. For example, if the article has a non-circular cross-section, then the “cylindrical portion” may similarly have a non-circular cross-section (e.g. it may be polygonal, such as square or rectangular, or may have another shape that is not necessarily regular or symmetrical).

It is not necessarily required to stretch inserts as or before they are placed in a mold cavity for injection molding.

It will be appreciated that actuation the various movable components of the embodiments of FIGS. 27-38, 39-52 and 53-67 may be performed in a similar manner to what is illustrated and described for the embodiment of FIGS. 13-26, and vice-versa.

With respect to the embodiments illustrated in FIGS. 13-26, 27-38, 39-52 and 53-67, it is possible that a further mold shutter device, similar to shutter 234, 334, 434 or 534, respectively, may be provided for locking each of the tubular portion 261, 361, 461 or 561 and pinching sleeve 227, 327, 427 or 527, respectively, much in the way that the ejector portion 263, 363, 463 and 563, respectively, is locked/unlocked.

It is noted that the foregoing has outlined some of the more pertinent non-limiting embodiments. It will be clear to those skilled in the art that modifications to the disclosed non-embodiment(s) can be effected without departing from the spirit and scope thereof. As such, the described non-limiting embodiment(s) ought to be considered to be merely illustrative of some of the more prominent features and applications. Other beneficial results can be realized by applying the non-limiting embodiments in a different manner or modifying them in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications.

What is claimed is:

1. A method (1200) of molding a molded article (190, 290, 390, 490, 590) in a mold (120, 220, 320, 420, 520), comprising:
disposing (1202) an insert (140, 240, 340, 440, 540) between a first mold stack portion (124, 224, 324, 424, 524) and a second mold stack portion (128, 228, 328, 428, 528), the first and second mold stack portions being in a spaced relation (S, S1, S2, S3, S4);
positioning (1204) a shuttle (132, 232, 332, 432, 532) to align a shuttle aperture (170, 270, 371, 471, 571) defined in the shuttle with the first and second mold stack portions;
advancing (1206) at least one of the first and second mold stack portions towards the other of the first and second mold stack portions into a molding configuration to define a molding cavity (144, 244, 344, 444, 594) therebetween with the insert at least partially enclosed within the molding cavity, the first and second mold stack portions, when in the molding configuration, being substantially accommodated within the shuttle aperture;
injecting (1208) molding material (155, 255, 355, 455, 555) into the molding cavity through the first or second mold stack portion to mold the molded article incorporating the insert;
separating (1210) the first and second mold stack portions into the spaced relation to open the molding cavity;
ejecting (1212), within the shuttle aperture, from the first or second mold stack portion, the molded article incorporating the insert; and
moving (1214) the shuttle to align the shuttle aperture with a transfer structure for transfer of the molded article incorporating the insert.

2. The method of claim 1 wherein the first and second mold stack portions are contained within, and are connected to, first and second mold halves (122, 222, 322, 422, 522 and 126, 226, 326, 426, 526) respectively, the first and second mold halves having a mold-closed configuration in which the mold halves are substantially adjacent to one another and an mold-open configuration in which the mold halves are separated from one another so as render the first and second mold stack portions accessible from outside the mold, and further comprising using an in-mold shutter (134, 234, 334, 434, 534) for alternately positioning the first and second mold stack portions in the spaced relation and the molding configuration with the first and second mold halves remaining in the mold-closed configuration.

3. The method of claim 1 wherein the ejecting comprises withdrawing the first or second mold stack portion from the shuttle aperture without removing the molded article incorporating the insert from the shuttle aperture.

4. The method of claim 1 wherein said shuttle aperture is a first shuttle aperture, wherein the shuttle further comprises a second shuttle aperture (172, 272, 372, 472, 572), and wherein said moving of the shuttle results in the second shuttle aperture becoming aligned with the first and second mold stack portions.

5. The method of claim 1 wherein the first mold stack portion comprises a core (152, 252, 352, 452, 552) and wherein the advancing of the one mold stack portion towards the other of the first and second mold stack portions stretches the insert over the core.

6. The method of claim 1 further comprising clamping a portion (343, 443, 543) of the insert against one of the first and second mold stack portions so that the advancing of the one mold stack portion towards the other of the first and second mold stack portions stretches an unclamped portion (345, 445, 545) of the insert without stretching the clamped portion of the insert.

7. The method of claim 1 wherein the insert has a peripheral border (141), wherein the first mold stack portion comprises an inner core (152) slideably received within an outer core (150), wherein the second mold stack portion comprises a mold insert (157) defining a cavity (158), and wherein the advancing of the one mold stack portion towards the other of the first and second mold stack portions comprises:
advancing one of the mold insert and the outer core towards the other of the mold insert and the outer core until the peripheral border of the insert becomes pinched between the outer core and the periphery of the mold insert; and
with the peripheral border of the insert pinched between the outer core and the periphery of the mold insert, sliding the inner core, within the outer core, towards the cavity of the mold insert to stretch the insert into the cavity of the mold insert.

8. The method of claim 7 further comprising severing the insert from the peripheral border using a cutting edge (165) defined between mating faces of the first and second mold stack portions.

9. The method of claim 1 wherein the first mold stack portion comprises a core (152, 252, 352, 452, 552) and wherein the injecting of the molding material is through the core.

10. The method of claim 1 wherein the insert comprises one or more of:
a barrier material impermeable to oxygen;
a barrier material containing a reagent for scavenging oxygen;
a label; and
a circuit.

11. The method of claim 1 wherein the insert comprises a sheet material and wherein the disposing of the insert comprises advancing a ribbon (164, 364, 464, 564) comprising the sheet material from a supply reel (160, 360, 460, 560) towards a take-up reel (162, 362, 462, 562).

12. The method of claim 1 wherein the disposing of the insert comprises advancing a ribbon (164, 364, 464, 564) of carrier material with the insert carried thereon from a supply reel (160, 360, 460, 560) towards a take-up reel (162, 362, 462, 562).

13. The method of claim 1 wherein said insert comprises a disc and wherein the disposing of the insert between the first and second mold stack portions comprising moving a tray (243, 245) supporting a periphery of the disc between the first and second mold stack portions.

14. The method of claim 1 wherein the molding cavity (594) is shaped so as to define a tamper evident band along an edge of the insert (590).

15. An injection mold (120, 220, 320, 420, 520), comprising:
a first mold stack portion (124, 224, 324, 424, 524) and a second mold stack portion (128, 228, 328, 428, 528), at least one of the first and second mold stack portions being movable relative to the other along a mold-stroke axis (X), between:
a spaced configuration in which the first and second mold stack portions are in a spaced relation (S, S1, S2, S3, S4); and
a molding configuration in which the first and second mold stack portions define a molding cavity (144, 244, 344, 444, 594) therebetween;
a mechanism (142, 242, 342, 442, 542) for disposing an insert (140, 240, 340, 440, 540) between the first and second mold stack portions when in the spaced configuration, so that the insert will become at least partially enclosed within the molding cavity when the first and second mold stack portions attain the molding configuration;
a shuttle (132, 232, 332, 432, 532) movable along a shuttling axis (Y) that is generally perpendicular to the mold-stroke axis, the shuttle comprising a shuttle aperture (170, 270, 371, 471, 571) that alternately substantially accommodates:
the first and second mold stack portions, in the molding configuration, with the insert enclosed within the molding cavity; and
the molded article incorporating the insert, upon withdrawal of the first and second mold stack portions from the shuttle aperture.

16. The injection mold of claim 15 further comprising first and second mold halves (122, 222, 322, 422, 522 and 126, 226, 326, 426, 526) containing the first and second mold stack portions respectively, the first and second mold halves having a mold-closed configuration in which the mold halves are substantially adjacent to one another and an mold-open configuration in which the mold halves are separated from one another so as render the first and second mold stack portions accessible from outside the injection mold, and further comprising an in-mold shutter (134, 234, 334, 434, 435) configured to facilitate alternate relative positioning of the first and second mold stack portions in the molding configuration and the spaced configuration with the first and second mold halves remaining in the mold-closed configuration.

17. The injection mold of claim 15 wherein the shuttle aperture is a first shuttle aperture, wherein the shuttle further comprises a second shuttle aperture (172, 272, 372, 472, 572) that alternately substantially accommodates, out of sequence with the first shuttle aperture:
the first and second mold stack portions, in the molding configuration, with a new insert (140′, 240′, 340′, 440′, 540′) enclosed within the molding cavity; and
another molded article incorporating the new insert, upon withdrawal of the first and second mold stack portions from the second shuttle aperture.

18. The injection mold of claim 15 wherein the mechanism for disposing an insert between the first and second mold stack portions comprises a supply reel (160, 260, 360, 460, 560) and a take-up reel (162, 262, 362, 462, 562) for advancing a ribbon (164, 264, 364, 464, 564) comprising the insert between the first and second mold stack portions.

19. The injection mold of claim 15 wherein the insert is a disc and wherein the mechanism for disposing an insert between the first and second mold stack portions comprises a pair of trays (243, 245) in coplanar fixed relation, each tray of the pair for carrying a single disc, the pair of trays being movable such that, when one of the trays of the pair disposes a disc between the first and second mold stack portions, the other tray is in an outboard position (251, 253) for disc loading.

20. The injection mold of claim 15 wherein the first mold stack portion comprises a core (152, 252, 352, 452, 552) configured to stretch the insert upon movement of one of the first and second mold stack portions towards the other of the first and second mold stack portions.

21. The injection mold of claim 20 further comprising a pinching sleeve operable to pinch a periphery of the insert prior to the stretching of the insert.

22. The injection mold of claim 15 further comprising an orifice in one of the first and second mold stack portions, the orifice either for introducing a pressurized gas on one side of the insert or for creating a vacuum on the other side of the insert, the gas or vacuum for stretching the insert prior to incorporation of the insert into the molded article.

23. The injection mold of claim 15 wherein the second mold stack portion comprises:
a tubular portion (361, 461, 561); and
an ejector portion (363, 463, 563) slidable within the tubular portion, the ejector portion being adapted to:
clamp a portion (343, 443, 543) of the insert against the first mold stack portion to limit stretching of the clamped portion during stretching of an unclamped portion (345, 445, 545) of the insert prior to injection molding of the molded article; and
eject the molded article incorporating the insert from the tubular portion.

24. The injection mold of claim 23 wherein the molded article is a container closure, wherein the clamped portion is a central portion of the insert to be incorporated into a top of the container closure, and wherein the unclamped portion is a skirt portion of the insert to be incorporated into a skirt portion of the container closure.

25. A non-transitory machine-readable medium (131, 231, 331, 431, 531) storing instructions that, upon execution by a controller (130, 230, 330, 430, 530), cause the controller to operate an injection molding system (100, 200, 300, 400, 500) to mold an article (190, 290, 390, 490, 590) incorporating an insert (140, 240, 340, 440, 540) by:
disposing (1202) the insert between a first mold stack portion of the injection molding system and a second mold stack portion of the injection molding system, the first and second mold stack portions being in a spaced relation;
positioning (1204) a shuttle of the injection molding system to align a shuttle aperture defined in the shuttle with the first and second mold stack portions;
advancing (1206) at least one of the first and second mold stack portions towards the other of the first and second mold stack portions into a molding configuration to define a molding cavity therebetween with the insert at least partially enclosed within the molding cavity, the first and second mold stack portions, when in the molding configuration, being substantially accommodated within the shuttle aperture;
injecting (1208) molding material into the molding cavity through the first or second mold stack portion to mold the molded article incorporating the insert;
separating (1210) the first and second mold stack portions into the spaced relation to open the molding cavity;
ejecting (1212), within the shuttle aperture, from the first or second mold stack portion, the molded article incorporating the insert; and
moving (1214) the shuttle to align the shuttle aperture with a transfer structure for transfer of the molded article incorporating the insert.
